(19) United States
(12) Patent Application Publication
(10) Pub. No.: US 2025/0217006 A1
(43) Pub. Date: Jul. 3, 2025

(54) IRRIGATION CONTROL SYSTEMS AND USER INTERFACES

(71) Applicant: Rain Bird Corporation, Azusa, CA (US)

(72) Inventors: Bret A. Ramsey, Auburn, CA (US); Jeremy Meyers, Tucson, AZ (US); José Orlando Miranda Álvarez, Hermosillo (MX); José Arturo Cerón Camacho, Zapopan (MX)

(21) Appl. No.: 18/946,782

(22) Filed: Nov. 13, 2024

Related U.S. Application Data
(60) Provisional application No. 63/548,379, filed on Nov. 13, 2023.

(51) Int. Cl. G06F 3/04817; A01G 25/16; G06F 3/0482; G06F 3/04845; G06F 3/0486; G06F 40/169; G06T 11/20; G06T 11/40

(52) U.S. Cl. CPC G06F 3/04817; A01G 25/16; G06F 3/0482; G06F 3/04845; G06F 3/0486; G06F 40/169; G06T 11/203; G06T 11/40; G06T 2200/24

(57) ABSTRACT

Systems, user interfaces, and methods related to irrigation control systems are provided herein. In some embodiments, an irrigation control system includes an irrigation management application which, when executed by an electronic device, causes a user interface to be displayed to a user. The user interface includes features that permit a user to do one or more of configure, monitor, program, control, adjust various components and/or operations of the irrigation management system.

### CROSS-REFERENCE TO RELATED APPLICATIONS

This application claims the benefit of U.S. Provisional Application No. 63/548,379, filed Nov. 13, 2023, which is incorporated herein by reference in its entirety.

### TECHNICAL FIELD

This disclosure relates generally to irrigation control and, in particular, to irrigation control systems with user interfaces for monitoring and controlling irrigation.

### BACKGROUND

In a typical irrigation control system, a computer executing irrigation control software and/or a dedicated electronic irrigation controller store and execute irrigation schedules that control watering components in a landscape to apply watering. In large-scale irrigation systems that may be employed, for example, on golf courses, there is a very large number of valves or stations, each of which has to be individually controlled (e.g., opened or closed to control water flow to sprinklers) and monitored. Central irrigation control software is often complex and requires the user to undergo specialized training, which is complex, time-consuming, and often not easy to understand, such that a limited number of users are able to properly operate the central irrigation control software.

### BRIEF DESCRIPTION OF DRAWINGS

Disclosed herein are embodiments of systems, methods, user interfaces, and controls relating to monitoring and/or controlling an irrigation system. This description includes drawings, wherein:

FIG. 1 illustrates a diagram of an exemplary irrigation control system in accordance with some embodiments;

FIG. 2 illustrates a diagram of another exemplary irrigation control system in accordance with some embodiments;

FIG. 3 illustrates a feature of another exemplary irrigation control system in accordance with some embodiments;

FIG. 4 is a functional block diagram of an exemplary computing device in accordance with some embodiments;

FIG. 5 is a functional block diagram of an exemplary server device in accordance with some embodiments;

FIG. 6 is a functional block diagram of an exemplary mobile device in accordance with some embodiments;

FIG. 7 illustrates an exemplary user interface in accordance with some embodiments that displays a map of an irrigation area with station icons indicating a physical location of irrigation stations in the irrigation area, and also displays a multi-station selector feature;

FIG. 8 illustrates an exemplary user interface in accordance with some embodiments that displays a map of an irrigation area and an interactive control menu that allows a user to apply a control selection to the irrigation stations in the irrigation area;

FIG. 9 illustrates an exemplary user interface in accordance with some embodiments that displays a map of an irrigation area and an interactive control menu with a diagnostic test icon that allows a user to run a diagnostics check on user-selected irrigation stations;

FIG. 10A illustrates an exemplary portion of a user interface on a computer in accordance with some embodiments that displays a diagnostic test window that is displayed prior to the diagnostic test being run on a selected group of irrigation stations;

FIG. 10B illustrates an exemplary portion of a user interface on a computer in accordance with some embodiments that displays another diagnostic test window that indicates the results of a diagnostic test that was run on the selected group of irrigation stations;

FIG. 11A illustrates an exemplary portion of a user interface similar to that shown in FIG. 10A but on a mobile device in accordance with some embodiments that displays a diagnostic test window that is displayed prior to the diagnostic test being run on a selected group of irrigation stations;

FIG. 11B illustrates an exemplary portion of a user interface similar to that shown in FIG. 11A accordance with some embodiments that displays a diagnostic test window that indicates the results of a diagnostic test that was run on a selected group of irrigation stations;

FIG. 12 illustrates an exemplary user interface in accordance with some embodiments that displays a custom layers editor feature that permits a user to import vector files and/or image files to create new map layers;

FIG. 13 illustrates an exemplary user interface in accordance with some embodiments that displays a layer import tool that permits a user to import vector files and/or image files to create new map layers;

FIG. 14 illustrates an exemplary user interface in accordance with some embodiments that displays a file preview window generated by the layer import tool that permits a user to preview what an import of a vector or image file would look like on a map;

FIG. 15 illustrates an exemplary user interface in accordance with some embodiments that displays the layer import tool with a listing of vector files that are selected by the user to be imported into the map;

FIG. 16 illustrates an exemplary user interface in accordance with some embodiments that displays the layer import tool providing a warning that one of the vector files is associated with an error;

FIG. 17 illustrates an exemplary user interface in accordance with some embodiments that displays the layer import tool with a file attributes menu that permits the user to select a coordinate system of the map;

FIG. 18 illustrates an exemplary user interface in accordance with some embodiments that displays the layer import tool with a listing of vector and/or image files that have been successfully imported onto the map;

FIG. 19 illustrates an exemplary user interface in accordance with some embodiments that displays a custom layers editor feature and objects associated with one of the vector files imported into the map being visible on the map;

FIG. 20 illustrates an exemplary user interface in accordance with some embodiments that displays the layer import tool listing an image file selected by the user to be imported into the map;

FIG. 21 illustrates an exemplary user interface in accordance with some embodiments that displays an attribute editor tool of the layer import tool that permits a user to adjust the attributes of an image file being imported into the map;

FIG. 22 illustrates an exemplary user interface in accordance with some embodiments that includes a menu and permits a user to add layers to the map by dragging objects onto the map;

FIG. 23 illustrates an exemplary user interface in accordance with some embodiments that permits a user to add a note to a location on a map that does not include a specific irrigation system feature;

FIG. 24 illustrates an exemplary user interface in accordance with some embodiments that displays an exemplary add note feature that permits a user to add a note to the map;

FIG. 25 illustrates an exemplary user interface in accordance with some embodiments that displays a map with a note added to a location on a map that does not include a specific irrigation system feature;

FIG. 26 illustrates an exemplary user interface in accordance with some embodiments that permits a user to add a note to a location on a map that includes a specific irrigation system feature such as a station icon associated with an irrigation station;

FIG. 27 illustrates an exemplary user interface in accordance with some embodiments that displays a map with a note added to a station icon associated with an irrigation station displayed on the map;

FIG. 28A illustrates an exemplary user interface in accordance with some embodiments that permits a user to add a note to a location on a map that includes a specific irrigation area element such as Hole 1 of a golf course;

FIG. 28B illustrates an exemplary user interface in accordance with some embodiments that displays a map with a note added to Hole 1 of the golf course displayed on the map;

FIG. 29A illustrates an exemplary user interface in accordance with some embodiments that displays a map with a tree type menu that permits the user to apply control actions to holes of a golf course displayed on the map;

FIG. 29B illustrates an exemplary user interface in accordance with some embodiments that displays a map with a sub-menu of the tree type menu shown in FIG. 29A that permits the user to add a note to a hole (e.g., Hole 1) of the golf course displayed on the map via the tree-type menu;

FIG. 29C illustrates an exemplary user interface in accordance with some embodiments that displays a map with a sub-menu of the tree type menu shown in FIG. 29A that permits the user to add a note to an area (e.g., Greens of Hole 1) of the golf course displayed on the map via the tree-type menu;

FIG. 30 illustrates an exemplary user interface in accordance with some embodiments that displays an exemplary add note feature that visually identifies with a badge a user adding a note to the map;

FIG. 31 illustrates an exemplary user interface in accordance with some embodiments that includes a menu generated as an overlay over the map in response to a user interacting with a specific station icon associated with an irrigation station and permits the user to select a control selection in a control panel;

FIG. 32 illustrate an exemplary user interface in accordance with some embodiments that displays an add note feature, with various components and options of the add note feature being visible to and selectable by the user while the user is creating a note;

FIG. 33 illustrate an exemplary user interface in accordance with some embodiments that displays an add note feature, with various components and options of the add note feature being visible to and selectable by the user while the user is creating a note;

FIG. 34 illustrate an exemplary user interface in accordance with some embodiments that displays an add note feature, with various components and options of the add note feature being visible to and selectable by a user while the user is creating a note responsive to another note;

FIG. 35 illustrate an exemplary user interface in accordance with some embodiments that displays an add note feature, with various components and options of the add note feature being visible to and selectable by a user while the user is creating a note responsive to another note;

FIG. 36 shows an exemplary user interface in accordance with some embodiments that displays a map of an irrigation area and an interactive menu that lists the notes added by users to the map;

FIG. 37 shows an exemplary user interface in accordance with some embodiments that includes an interactive menu that permits the user to filter and/or sort the notes added by users to the map;

FIG. 38 shows an exemplary user interface in accordance with some embodiments that includes an interactive menu that permits the select layers that are visible on the map and also permits a user to view connection relationships between various components of the irrigation system;

FIG. 39 is an enlarged view of a portion of the map displayed in FIG. 38;

FIG. 40A shows an exemplary user interface in accordance with some embodiments that permits a user to add one or more polygon shapes to the map and to associate the added polygon shapes with an irrigation station;

FIG. 40B shows an exemplary user interface in accordance with some embodiments that permits a user to add one or more polygon shapes to the map and to associate the added polygon shapes with an irrigation station;

FIG. 41 shows an exemplary user interface in accordance with some embodiments that permits a user to edit the shape of a polygon being added to the map;

FIG. 42 shows an exemplary user interface in accordance with some embodiments that permits a user to calculate an area of a polygon shape added to the map;

FIG. 43 shows an exemplary user interface in accordance with some embodiments that visually displays a numerical value of the area of a polygon added to the map and visually indicates the irrigation station with which the polygon is associated;

FIG. 44 shows an exemplary user interface in accordance with some embodiments that visually displays data indicators and/or operation mode indicators that may be associated with an irrigation station;

FIG. 45 shows a simplified flow diagram illustrating a method of managing irrigation in accordance with some embodiments;

FIG. 46 shows a simplified flow diagram illustrating a method of managing irrigation in accordance with some embodiments;

FIG. 47 shows a simplified flow diagram illustrating a method of managing irrigation in accordance with some embodiments;

FIG. 48 shows a simplified flow diagram illustrating a method of managing irrigation in accordance with some embodiments;

FIG. 49 shows a simplified flow diagram illustrating a method of managing irrigation in accordance with some embodiments;

FIG. 50 shows a simplified flow diagram illustrating a method of managing irrigation in accordance with some embodiments;

FIG. 51 shows a simplified flow diagram illustrating a method of managing irrigation in accordance with some embodiments;

FIG. 52 shows a simplified flow diagram illustrating a method of managing irrigation in accordance with some embodiments;

FIG. 53 shows a simplified flow diagram illustrating a method of managing irrigation in accordance with some embodiments; and

FIG. 54 shows a simplified flow diagram illustrating a method of managing irrigation in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the art as set forth above except where different specific meanings have otherwise been set forth herein.

### DETAILED DESCRIPTION

The following description is not to be taken in a limiting sense, but is made merely for the purpose of describing the general principles of exemplary embodiments. The scope of the invention should be determined with reference to the claims. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Generally and in some embodiments, systems, user interfaces, and methods related to landscape and/or irrigation management include an irrigation management application which, when executed by a control circuit (e.g., processor) of an electronic device, causes a user interface to be displayed to a user. The user interface includes features that permit a user to do one or more of configure, monitor, program, control, adjust various components and/or operations of the irrigation management system. For example, in some embodiments, the user may check the status, operational parameters, and/or other information relating to irrigation stations and/or other stations of the irrigation system. And for example, in some embodiments, the user interface permits the user to adjust operational attributes of one or more of irrigation stations and/or other stations to control operation of the stations according to the system-generated operational attributes and/or user-adjusted operational attributes.

In some embodiments, the user interface is configured to provide a more intuitive and easier to use interface than in traditional complex central irrigation control systems. Often, traditional central control irrigation systems are difficult to learn to use which limits those that can properly operate the central control irrigation system. In some embodiments, the user interface includes interactive features while viewing a map interface. In some embodiments, the user interface includes interactive features while viewing a data interface. And in some embodiments, the user interface includes intuitive programming features to simplify otherwise tedious and mistake prone programming processes. In some embodiments, various features of the user interface provide easy access to functions of the system without the need to complete extensive training or have extensive experience.

Further, in some embodiments, irrigation management applications may be applicable in multiple landscape and irrigation settings and devices. For example, in some embodiments, an irrigation management application may be at least part of a central irrigation control system. In some embodiments, irrigation management application may be stored and executed at least in part by a central computer, a server providing central control functionality, mobile electronic devices (such as mobile computers, mobile tablets and phones, remote controls, etc.) and various field components (such as interface units, satellite controllers, etc.). In some embodiments, irrigation management application may be implemented in irrigation systems that are not central-control based. For example, the irrigation management application may be stored and executed at least in part by mobile electronic devices (such as mobile computers, mobile tablets and phones, remote controls, etc.) in communication with a stand-alone controller (e.g., a residential irrigation controller) or satellite controller configured to function as a stand-alone controller.

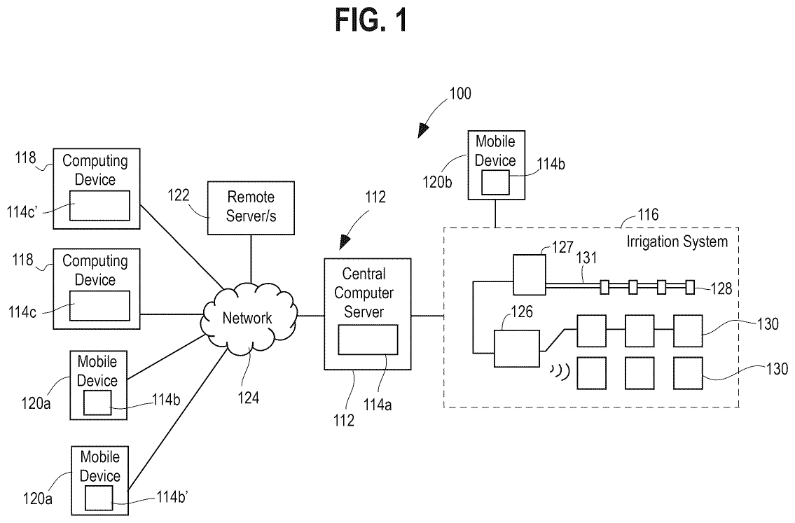

Referring to FIGS. 1-3, various irrigation management systems are illustrated and described according to some embodiments. In such systems and according to some embodiments, an irrigation management application is provided. As used herein, an irrigation management application generally refers to an application (e.g., software or set of code executable by a control circuit) that provides irrigation management functionality. As used herein, irrigation management generally refers to at least one or both of monitoring and controlling irrigation system components and operation. Accordingly, (1) in some embodiments, the irrigation management application monitors the system, (2) in some embodiments, the irrigation management application controls the system, and (3) in some embodiments, the irrigation management application monitors and controls the system. In some embodiments, these functions can be further defined such that irrigation management generally refers to at least one or more of the following general functions of a landscape or irrigation system: configuring, monitoring, programming, controlling, and adjusting irrigation system components and operation.

Referring to FIG. 1, an exemplary irrigation management system 100 is shown. Generally, the system 100 includes an irrigation management application 114a (e.g., central control software) stored on and executed by a central computer 112, which can be used for managing irrigation components of an irrigation system 116 located at one or more sites. The irrigation management application 114a and central computer 112 can be accessed via a network 124 (e.g., the Internet) by authorized remote electronic devices, such as computing devices 118, mobile devices 120a (e.g., mobile phones, tablets, etc.). Further, the central computer 112 can communicate with remote server(s) 122 (e.g., weather servers, map servers, and other third-party data or service providers) via the network 124. The irrigation management application functions to provide one or more of the functions noted above. For example, in some embodiments, the irrigation management application 114a can include, for example, one or more of setting, monitoring and adjusting operational parameters of and informational data associated with any and all components of the irrigation system 116, visually displaying the operational status of and informational data associated with any and all components of the irrigation system 116, automatically or manually controlling the operational parameters of any and all components of the irrigation system 116, and/or automatically or manually turning on and off and/or activating and deactivating any and all components of the irrigation system 116.

In FIG. 1, the central computer 112, computing devices 118, and mobile devices 120a, 120b are examples of electronic devices. The term “electronic device” as used herein may include a stationary or portable electronic device, for example, a desktop computer, a laptop computer, a server, multiple communicatively connected servers, a distributed computer, a tablet computer, a mobile phone, a personal digital assistant (PDA), a smartwatch or other wearable device, or any other electronic device including a control circuit (e.g., processor) that executes at least a portion of the irrigation management application and/or related application/s that support the irrigation management application. The exemplary electronic devices shown in FIG. 1, namely, central computer 112, computing device 118, mobile devices 120a, 120b, and remote server 122, may be configured for data display and entry and processing as well as for communication with each other and other devices of the system 100 via the network 124.

The exemplary network 124 depicted in FIG. 1 may be any computer connection network, e.g., including one or more of a wide-area network (WAN), a local area network (LAN), a personal area network (PAN), a wireless local area network (WLAN), a wired network, a wireless network, or any other internet or intranet network, or combinations of such networks. Generally, communication between various electronic devices of system 100 may take place over hard-wired, wireless, cellular, LoRa, LoRaWAN, Zigbee, Wi-Fi or Bluetooth (e.g., Bluetooth Low Energy (BLE)) networked components or the like. In some embodiments, one or more electronic devices of system 100 may include cloud-based features, such as cloud-based memory storage.

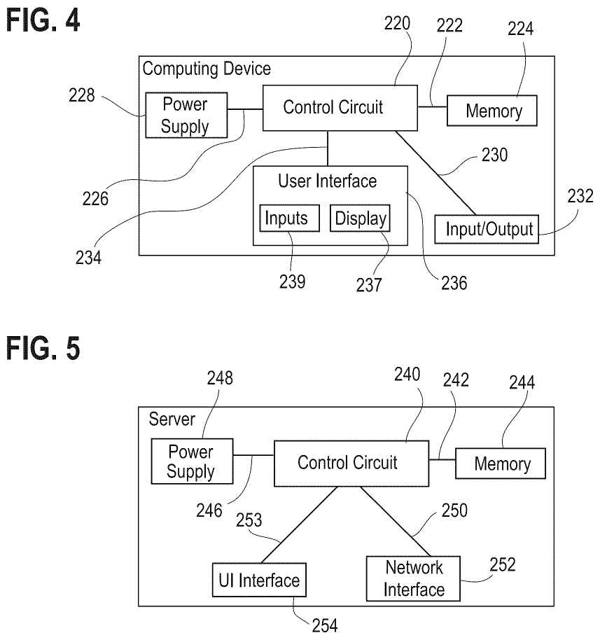

In some embodiments, electronic devices such as the central computer 112, computing device 118, mobile phone/tablet 120a, 120b, and/or remote server 122 include at least a portion of or are otherwise configured to work with the irrigation management application 114a. Accordingly, as shown in FIG. 1, the mobile devices 120a and 120b include one of irrigation management applications 114b and 114b′, and the remote computing devices 118 include one of irrigation management applications 114c and 114c′. In some embodiments, the irrigation management application 114a, 114b, 114b′, 114c, 114c′ comprise computer program code that is configured to be respectively installed on and executed by the electronic devices 112, 118, and 120a, 120b (e.g., by a control circuit of these electronic devices described in more detail below with respect to FIG. 4-5). The irrigation management application 114a, 114b, 114b′, 114c, 114c′ can be executed by the respective electronic devices 112, 118, 120a, 120b in concert with other software modules or applications (computer program code), or groups of applications, such as operating systems, browser applications, location applications (e.g., mapping, GPS, etc. applications), two-factor authentication (TFA) applications, single sign on (SSO) applications, graphics processing applications, security applications, etc. For example, in some embodiments, the irrigation management application 114b′ and 114c′ comprises a browser application including code (e.g., HTML) and/or scripts (e.g., JavaScript) downloaded from the irrigation management application 114a and executed via the browser application that runs on the respective ones of the computing devices 118 and the mobile devices 120a. When the browser application executes the received code (e.g., HTML) and/or scripts (e.g., JavaScript) downloaded from the irrigation management application 114a, the browser application and the downloaded code/scripts together function as the irrigation management application 114b′, 114c′ of the remote computer 118 and mobile device 120a to display a user interface for the user.

In some embodiments, the software of the irrigation management application 114a, 114b, 114c can be a dedicated application (e.g., an application specific to irrigation management functions) or a general application that can provide or support irrigation management functions as well as other operating system and other non-irrigation management functions. In some embodiments, the irrigation management application 114a, 114b, 114c is an add-on application that is installed on one or more of the electronic devices 112, 118, and 120a, 120b, respectively, and that cooperates with and/or is integral to other application/s of the electronic devices 112, 118, 120a, 120b such as the operating system and works with the other application/s to provide the functionality described herein. And in some embodiments, the irrigation management application 114b, 114c can comprise an application configured to link a browser application to a remote computer device (central computer 112, 112a) or server (cloud-based server 112b) configured to provide signaling (code and/or scripts) to cause the browser application to display the user interface. In other words, the irrigation management application 114b, 114c can simply provide a link to a computer or mobile device supported website served by the central computer 112, 112a or the cloud-based server 112b, the website serving the user interface for the display at the remote computer 118 and/or mobile devices 120a, 120c.

With reference to FIG. 1, the general functionality of managing (e.g., monitoring and/or controlling) the irrigation system 116 is implemented via a central computer 112, which is connected to irrigation equipment at one or more sites of the irrigation system 116. The components of the irrigation system 116 are variable depending on the type of system and level of control needed. For example, the equipment of the irrigation system 116 may include various field control devices such as interface units 126, communication components/relays/switches (not shown), satellite controllers 130, encoder units 127 (i.e., a type of interface unit that outputs modulated commands on a two-wire path 131), decoders 128, station valves, master valves, sprinklers, emitters, sensors, pumps, pump stations, lighting devices, etc. Generally, one or more of the field components control operation of stations.

As used herein, a station is a controlled output of the irrigation system that corresponds to a physical component in the field. A station typically has binary states, such as on or off, but could further be a partially on/partially off state. An example “irrigation station” corresponds to a valve that is controlled, for example, using a latching or non-latching solenoid. The valve is typically in an off state (closed, not allowing water to flow therethrough) or an on state (open, allowing water to flow therethrough). When a given valve is open, water flows through the valve to one or more sprinkler devices in the fluid path downstream of the valve. In some cases, the valve is part of a “valve-in-head” sprinkler (such as a rotor) in which case there is a one-to-one relationship between valve (station) and the sprinkler. In some cases, the fluid path from the valve branches to one or more sprinklers is located separate from the valve. In any event, the controlled valve is typically referred to as an irrigation station. In the illustration of FIG. 1, each of the satellite controllers 130 may couple to and control multiple irrigation stations. And in FIG. 1, each of the decoders 128 may directly control one or more valves, such that a given decoder is coupled to and controls one or more irrigation stations. It is also known that other stations may be controlled by embodiments of the irrigation management application 114a. And it is known to use switches e.g., to control pumps, fountains, electrical lighting, and the like, such that the switches can each be considered a station being controlled by the irrigation management system.

In the embodiment illustrated in FIG. 1, the central computer 112 is coupled to the decoders 128 via an encoder unit 127 at the site of the irrigation system 116, and is connected to the encoder unit 127 via the network 124 which can include direct wireline connections from the central computer 112 to the encoder unit 127. In some embodiments, the central computer 112 is owned and operated by the user or customer and has the irrigation management application 114a installed thereon. In certain aspects, the central computer 112 provides, via the software of the irrigation management application 114a, a user interface to the user that is at the central computer 112 (e.g., via a keyboard and display directly coupled to the central computer 112 or viewed by users at their respective remote electronic devices 118, 120a via irrigation management application 114a, 114b, 114b′, 114c, 114c′ running respectively thereon.

As will be described in more detail below, in some aspects, the irrigation management application 114a of the central computer 112 may generate, via the irrigation management application 114b, 114b′, 114c, 114c′ (e.g., a conventional application, mobile application, web browser application, etc.) a user interface for a user of the electronic device 118, 120a that permits the user to monitor the operational status of any component of the irrigation system 116 and to enter and/or modify various operational or informational parameters associated with any of the components of the irrigation system 116. For example, in one aspect, the user of an electronic device 118, 120a may enter a user-desired selections (e.g., run time schedule, irrigation station identifier, command to turn irrigation on/off, etc.) via the user interface of the irrigation management application 114b, 114b′, 114c, 114c′ accessible on the user's electronic device 118, 120a, and the entry is received by the central computer 112 and stored in its memory.

In some embodiments, the output signals corresponding to the inputs entered by a user of an electronic device 112, 118, 120a into a user interface generated by the respective irrigation management application 114a, 114b, 114b′, 114c, 114c′ are transferred by the central computer 112 to the field components. For example, in some embodiments, the central computer 112 sends on/off commands to the interface unit 126 to be passed to the appropriate satellite controller 130 to control the appropriate stations, or may be passed to the encoder unit 127 to be formatted into a command to be transmitted to the appropriate decoder 128 to control the appropriate one or more valve (irrigation station) controlled by the decoder 128. In some embodiments, the irrigation management application 114a at the central computer 112 transmits an irrigation schedule or an adjustment to an irrigation schedule to a given satellite controller 130 via the interface unit 126, the schedule stored and executed by the satellite controller 130. Notably, while the central computer 112 is shown in FIG. 1 as not being at the site of the irrigation system 116, in some aspects, the central computer 112 may be located at the site of the irrigation system 116. Such a central computer 112 may be a customer-owned computer with irrigation management application 114a installed thereon.

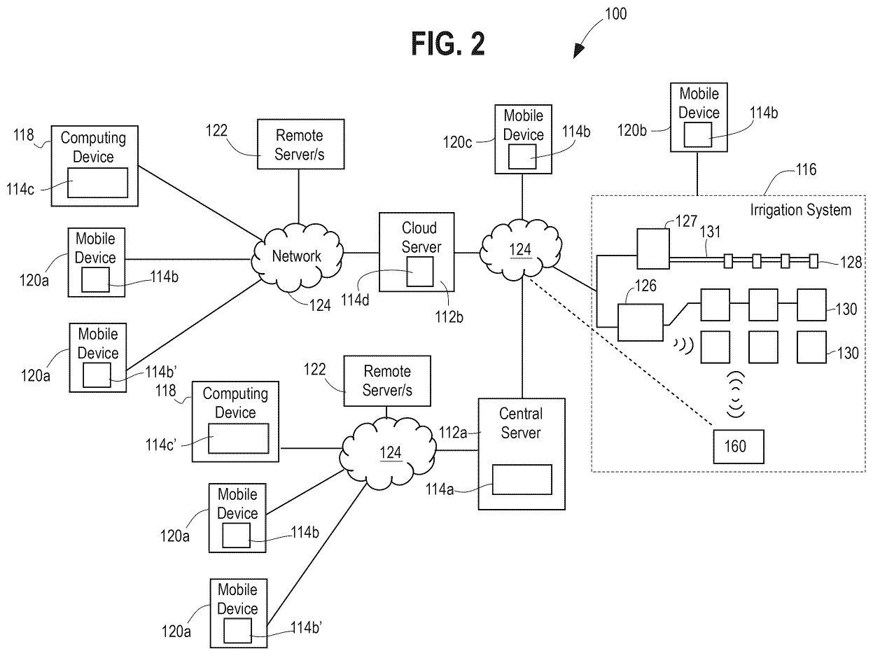

With reference to FIG. 2, in some embodiments, the central computer 112a is similar to the central computer 112 of FIG. 1 in that it is remote from the site of the irrigation system 116 and coupled to the irrigation system 116 by a network 124 (e.g., a wide area network). As also shown in FIG. 2, the irrigation management application 114d may be stored and executed by a cloud-based server 112b. In such embodiments, the cloud-based server 112b may be hosted by an irrigation company that provides irrigation control services (such as irrigation system monitoring, irrigation schedule creation, management and execution) from a remote central location to multiple different users or customers via remote computing devices 118 and/or mobile devices 120a for their respective irrigation systems at their respective sites. As shown in FIG. 2, the cloud-based server 112b is communicationally coupled to the devices at the site of the irrigation system 116 via the network 124 similar to how the central computer 112a is communicationally coupled to the devices at the site of the irrigation system 116.

In some embodiments, the cloud-based server 112b is owned and operated by the user or customer and has irrigation management application 114d installed thereon. In some embodiments, the functionality of monitoring and/or controlling the irrigation system 116 is implemented via the cloud-based server 112b. For example, the cloud-based server 112b may provide a user interface via the irrigation management application 114b, 114b′, 114c, 114c′ to the user that is viewed by the user at the user's remote computing device (e.g., computer) 118 and/or mobile device 120a. Using the irrigation management application 114b, 114b′, 114c, 114c′, the user of a remote computer 118, mobile devices 120a may enter a user-desired operational attribute selections (e.g., pause irrigation, restart irrigation, turn irrigation station on/off, etc.), and these selections are received by the cloud-based server 112b and may be stored in its memory. The output signals from the cloud-based server 112b are communicated to the field devices at the site of the irrigation system 116.

In some embodiments, similar to that described in FIG. 1, the irrigation management application 114b, 114c shown in FIG. 2 can be a dedicated application (e.g., an application specific to irrigation management functions), or a general application that can provide or support irrigation management functions as well as other operating system and other non-irrigation management functions. And in some embodiments, the irrigation management application 114b′ and 114c′ can be a browser-based application that is native to an operating system of the remote computer 118 or mobile device 120a or downloaded to and installed on the remote computing device 118 or mobile device 120a. When the browser-based application receives code (e.g., HTML) and/or scripts (e.g., JavaScript) downloaded from the irrigation management application 114a or 114d, the browser-based application and the downloaded code/scripts together function as the irrigation management application 114b′, 114c′ to display a user interface at the remote computing device 118 and mobile device 120a. And in some embodiments, the irrigation management application 114b, 114c can comprise an application configured to link a browser application to a remote computer device (central computer 112, 112a) or server (cloud-based server 112b) configured to provide signaling (code and/or scripts) to cause the browser application to display the user interface. In other words, the irrigation management application 114b, 114c can simply provide a link to a computer or mobile device supported website served by the central computer 112, 112a or the cloud-based server 112b, the website serving the user interface for the display at the remote computer 118 and/or mobile devices 120a, 120b.

Also as shown in FIGS. 1 and 2, in some embodiments, the irrigation management application 114b of the mobile device 120b can be configured to provide irrigation management functionality directly to one or more of the components of the irrigation system 116 at the site. For example, the mobile device 120b can be configured to communicate wirelessly and directly to one or more of the encoder units 127, the decoder 128, the interface unit 126 and the satellite controllers 130. For example, one or more of these devices may include an integrated or removably connectable transceiver to communicate with the mobile device 120b. In such embodiments, the mobile device 120b may communicate directly to these devices without first communicating to the irrigation management application 114a or 114d. Also shown in FIG. 2, in some embodiments, the irrigation management application 114b of mobile device 120c can directly communicate with one or more of the field devices via the network 124 without first communicating to the irrigation management application 114a on the central server or the irrigation management application 114d on the cloud-based server 112b.

Generally, users can access features of the irrigation management application 114a at the central computer 112, 112a and/or at the remote electronic devices 118, 120a, e.g., to manage the irrigation system 116 by checking the status of various components of the irrigation system 116, sending commands to various components of the irrigation system 116, making programming changes associated with various components of the irrigation system 116, viewing reports/status/alerts in connection with various components of the irrigation system 116, and so on. In some embodiments, the irrigation management application 114a, 114b, 114c, 114d can communicate with remote servers 122, for example, map servers to obtain map information and/or imagery, weather servers, to obtain rainfall, humidity and other weather-related information that can be used by the irrigation management application 114a-114d to adjust watering schedules of the irrigation system 116.

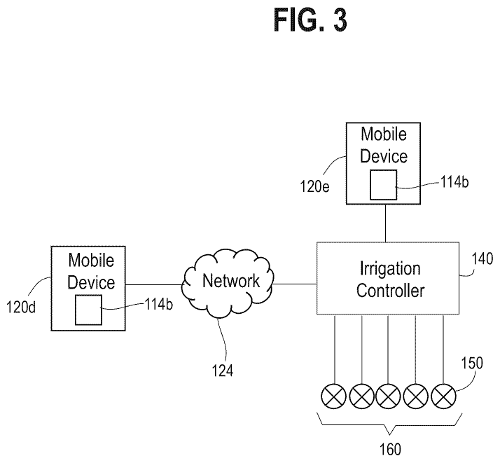

Referring next to FIG. 3, in some embodiments, the irrigation management application 114b permits mobile devices 120d and 120e to communicate with an irrigation controller 140 directly or via a network 124 without communicating via any central computer 112, 112a, or via the cloud-based server 112b. For example, in some embodiments, the irrigation controller 140 is a stand-alone controller or irrigation control unit that is independent of or not part of a larger central control system. In other words, as shown in FIG. 3, a user of the mobile device 120d, 120e may use the irrigation management application 114b to monitor and/or control various aspects of the status and/or operation of one or more stations 150 via various user interfaces. In this illustrated embodiment, the stations 150 connected to the irrigation controller 140 are irrigation stations (e.g., valves that control the flow of water to one or more sprinkler device fluidly connected to valves).

With continued reference to FIG. 3, in some embodiments, the network 124 used by the mobile device 120d may be any local or wide area network and can include a cellular network, a local wireless network (e.g., a Wi-Fi network), and so on. And in some embodiments, the mobile device 120e may communicate with an integrated or removably connected transceiver of the irrigation controller 140 (e.g., using Bluetooth or other direct wireless connection). It is understood that the irrigation controller 140 can be any irrigation control device, such as a station-based controller, decoder-based controller, a decoder, wireless valve/rotor, and so on.

Also, as shown in FIGS. 1-3, in some embodiments, the functionality of managing (e.g., monitoring and/or controlling) the irrigation system 116 is implemented via software stored on or accessible by the mobile electronic device 120a-120e, such as a mobile application version of the irrigation management application 114b and/or a browser that works together with the irrigation management application 114a, 114d. In some embodiments, the browser function executing commands and code received from the irrigation management application 114a, 114d can be referred to as an irrigation management application 114b′, 114c′.

As shown in FIGS. 1-3, the irrigation management application 114b can be an iOS or Android-based irrigation management application (or app) installed on the mobile device 120a-120e and is configured to wirelessly communicate via the network 124 with one or more of the central computer 112, 112a, cloud-based server 112b, and/or with components of the irrigation system 116 in the field. In such case, a mobile application (mobile app) 114b of the mobile devices 120a-120e provides a user interface to the user on a display screen of the mobile device to allow the user to monitor and/or control various aspects of the irrigation system 116. In some embodiments, the mobile device 120a-120e can transmit wireless signals to one or more of the central computer 112, 112a, cloud-based server 112b to provide the signaling to the components of the irrigation system 116 to implement various operational attribute adjustments and/or control commands to one or more components of the irrigation system 116.

It is noted that in some embodiments, at least portions of the irrigation management application is stored in the memory of different devices in the system such that the irrigation management application is distributed between various devices, e.g., the central computer 112, 112a, cloud-based server 112b, the remote computers 118 and the mobile devices 120a-120c. Further, in some embodiments, the irrigation management application at the remote computer 118 and/or mobile devices 120 comprises a browser application configured to display the user interface based on signaling received from a remote computer device or server in order to provide irrigation management functionality to the user via the user interface.

In some embodiments, as shown in FIG. 2, some components of the irrigation system 116 may be part of a local wireless network, such as a LoRaWAN network including a LoRaWAN gateway 160 that is in communication with the network 124. For example, one or more local controllers, sensors, actuators of the irrigation system 116, may include a LoRa transceiver and communicate using LoRa radio technology (over ISM bands) with the LoRaWAN gateway 160. As is known, a LoRaWAN gateway can communicate using LoRaWAN to devices within 1000-5000 meters. A typical LoRaWAN gateway 160 can communicate with the network 124 using cellular, WiFi, etc.). In some cases, a LoRaWAN server which is part of the cloud can be used to implement LNS server functionality for the LoRaWAN gateway 160. Accordingly, in some embodiments, any of the various computers, servers, controllers, mobile devices, and so on, may communicate with LoRaWAN-based devices at the site via the LoRaWAN gateway 160.

With reference to FIG. 4, an exemplary computing device (e.g., computer 112, 118) configured for use with exemplary systems and methods described herein may include a control circuit 220 electrically coupled via a connection 222 (e.g., a bus, etc.) to a memory 224 and via a connection 226 (e.g., a bus, etc.) to a power supply 228. In some embodiments, the control circuit 220 is a programmable processor (e.g., a microprocessor or a microcontroller). And in some embodiments, the control circuit 220 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description.

The control circuit 220 can be configured (for example, by using corresponding programming stored in the memory 224 (such as the irrigation management application) as will be well understood by those skilled in the art) to carry out one or more of the steps, actions, and/or functions described herein. In some embodiments, the memory 224 may be integral to the control circuit 220 or can be physically discrete (in whole or in part) from the control circuit 220 and may be configured to non-transitorily store the computer instructions that, when executed by the control circuit 220, cause the control circuit 220 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 224 may be referred to as a non-transitory medium or non-transitory computer readable medium.

The control circuit 220 of the computing device may be also electrically coupled via a connection 230 to an input/output 232 that can receive signals from other devices, for example, the central computer 112, 112a, cloud-based server 112b, one or more mobile devices 120, remote server 122, etc., and/or from another electronic device of the system 100 or in communication with the system 100. The input/output 232 of the computing device can also send signals to other devices, for example, interface units 126, encoder units 127, etc.

The control circuit 220 of the exemplary computing device shown in FIG. 4 may be electrically coupled via a connection 234 to a user interface 236, which may include a visual display or display screen 237 (e.g., LED screen) and/or button input 239 that provide the user interface 236 with the ability to permit a user of the computing device to user the irrigation management application 114a to monitor and/or control the irrigation system 116 by inputting menu selections and/or commands via touch-screen and/or button operation and/or voice commands as will be described in more detail below. It will be appreciated that the performance of such functions by the control circuit 220 of the computing device may not be dependent on a human operator, and that the control circuit 220 of the computing device may be programmed to perform such functions without a human operator. In some embodiments, the user interface 236 is integral with the other components of the computing device, e.g., the computing device is a laptop computer with a display screen 237 and inputs 239 (e.g., keyboard, mousepad). And in some embodiments, the user interface 236 is separated from the other components of the computing device, e.g., the computing device is a desktop or tower computer to which the display screen 237 and inputs 239 (e.g., keyboard/mouse) are connected.

With reference to FIG. 5, an exemplary server (e.g., cloud-based server) 112b configured for use with exemplary systems and methods described herein may include a control circuit 240 electrically coupled via a connection 242 (e.g., a bus, etc.) to a memory 244 and via a connection 246 (e.g., a bus, etc.) to a power supply 248. As noted above, the control circuit 240 can comprise a fixed-purpose hard-wired platform or can comprise a partially or wholly programmable platform, such as a microcontroller, an application specification integrated circuit, a field programmable gate array, and so on.

The control circuit 240 can be configured (for example, by using corresponding programming stored in the memory 244 as will be well understood by those skilled in the art) to carry out one or more of the steps, actions, and/or functions described herein. In some embodiments, the memory 244 may be integral to the processor-based control circuit 240 or can be physically discrete (in whole or in part) from the control circuit 240 and may be configured to non-transitorily store the computer instructions that, when executed by the control circuit 240, cause the control circuit 240 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 244 may be referred to as a non-transitory medium or non-transitory computer readable medium.

The control circuit 240 of the server may be also electrically coupled via a connection 250 to a network interface 252 that can receive signals from, for example, the central computer 112/112a, mobile device 120, cloud-based server 112b, remote server 122, etc., and/or from another electronic device of the system 100. The input/output 232 of the computing device 118 can also send signals to other devices, for example, interface units, encoder units 127, etc.

The control circuit 240 of the exemplary server shown in FIG. 5 may be electrically coupled via a connection 253 to a UI interface 254 that provides a user of the server with the ability to run the irrigation management application 114d to monitor and/or control the irrigation system 116 as will be described in more detail below. It will be appreciated that the performance of such functions by the control circuit 240 of the server may not be dependent on a human operator, and that the control circuit 240 of the server may be programmed to perform such functions without a human operator.

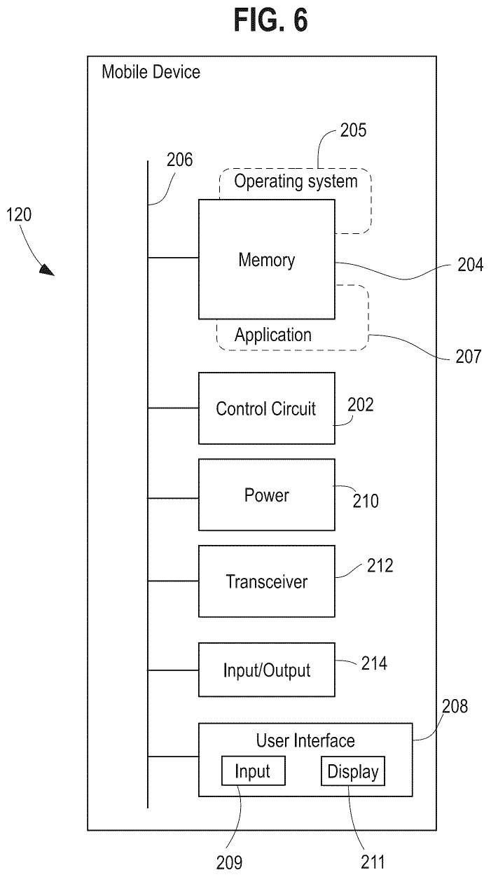

FIG. 6 is a block diagram of a mobile device 120 (e.g., example mobile devices 120a-120e), according to some embodiments. The mobile device 120 may be used for implementing any of the functionalities described herein. By way of example, the mobile device 120 may comprise a control circuit 202 (e.g., processor), memory 204, and one or more communication bus 206 (e.g., links, paths, interconnections, or the like). Some embodiments may include one or more internal and/or external power sources or supplies 210. The control circuit 202 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, etc. Further, in some embodiments, the control circuit 202 can be part of control circuitry and/or a control system, which may be implemented through one or more processors with access to one or more memory 204 that can store commands, instructions, code and the like that is implemented by the control circuit 202 and/or processors to implement intended functionality. In some applications, the control circuit 202 and/or memory 204 may be distributed over a communications network (e.g., LAN, WAN, Internet) providing distributed and/or redundant processing and functionality.

In one embodiment, the memory 204 of the mobile device 120 stores data and executable code, such as an operating system 205 and an application 207. The application 207 is configured to be executed by the mobile device 120 (e.g., by the control circuit 202). The application 207 can be a dedicated application (e.g., an application dedicated to monitoring and/or controlling an irrigation system 116), a general-purpose application (e.g., a web browser, etc.), and/or a dedicated application linking a general-purpose application such as a browser to a user interface transmitted by a central computer or remote server. Accordingly, the application 207 is representative of all types of applications that may be resident on or run by the mobile device 120 (e.g., software preinstalled by the manufacturer of the mobile device, software installed by an end user (which may be a mobile app or an internet browser app), software installed by a vendor (e.g., irrigation company), etc.).

In one embodiment, the application 207 operates in concert with the operating system 205 when executed by the control circuit 202 to cause actions to be performed by the mobile device 120. For example, with respect to the disclosure contained herein, execution of the application 207 by the processor of the control circuit 202 causes the mobile device 120 to perform actions consistent with the managing (e.g., monitoring and/or controlling) of the irrigation system 116. In some embodiments, the application 207 includes at least a part of the irrigation management application referred to herein. And in some embodiments, to the extent a browser function which is part of the application 207 or the operating system 205 in receiving commands, code (Java Script) and data to provide a user interface, such browser function can be considered part of the irrigation management application referred to herein.

The user interface 208 of the mobile device 120 can allow a user to interact with the system 100 and receive information through the system 100. In some instances, the user interface 208 includes a display device 211 (e.g., display screen, etc.) and/or one or more user input device 209 (e.g., buttons, touch screen, track ball, keyboard, mouse, etc.), which can be a part of, or wired, or wirelessly coupled with the mobile device 120. In the embodiment shown in FIG. 6, the mobile device 120 further includes one or more communication interfaces, ports, and/or transceivers 212 and the like, allowing the mobile device 120 to communicate over a communication bus, a distributed computer and/or communication network (e.g., a local area network (LAN), wide area network (WAN), etc.), other wired or wireless networks or communication channels with other devices and/or other such communications or combination of two or more of such communication methods.

Further, the transceiver 212 can be configured for wired, wireless, optical, fiber optical cable, satellite, or other such communication configurations or combinations of two or more of such communications. Some embodiments include one or more input/output (I/O) ports 214 that allow one or more devices to couple with the mobile device 120. The I/O ports 214 can be substantially any relevant port or combinations of ports, such as but not limited to USB, Ethernet, or other such ports. The I/O ports 214 can be configured to allow wired and/or wireless communication coupling to external components. For example, the I/O ports 214 can provide wired communication and/or wireless communication (e.g., Wi-Fi, Bluetooth, LoRa, LoRaWAN, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The mobile device 120 is an example of a control and/or processor-based system with a control circuit 202. Again, the control circuit 202 can be implemented through one or more processors, controllers, central processing units, logic, software and the like. Further, in some implementations the control circuit 202 may provide the processor functionality. The memory 204, which can be accessed by the control circuit 202, typically includes one or more processor-readable and/or computer-readable media accessed by at least the control circuit 202, and can include volatile and/or nonvolatile media, such as RAM, ROM, EEPROM, flash memory and/or other memory technology. Further, while the memory 204 is shown as internal to the mobile device 120, the memory 204 can be internal, external or a combination of internal and external memory. The external memory can be substantially any relevant memory such as, but not limited to, solid-state storage devices (SSDs) or drives, hard disk drives (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 204 can store code, software, executables, scripts, data, content, lists, programming, programs, log or history data, user information, irrigation system information, and the like. While FIG. 6 shows various components being coupled together via a bus 206, it is understood that the components may actually be coupled to the control circuit 202 and/or one or more other components directly.

The following description relates to various user interface (UI) and programming features provided by the software of irrigation management application 114a-114d, which, as mentioned above, can be installed on and executed by, for example, a central control computer/server, a cloud-based server, a stand-alone computing device (e.g., desktop, laptop, etc.), and a mobile device (e.g., a mobile phone, tablet, etc.) using an irrigation application.

In several embodiments, an irrigation management application is configured to cause a user interface to be displayed on a display to a user, the user interface including a map of a geographic region that includes at least one irrigation area. In some embodiments, various information and/or interactive features are caused to be displayed together with the map. In some embodiments, the map includes imagery, such as aerial image data, whereas in some embodiments, the map is line-based and is a rendering of the geographic region.

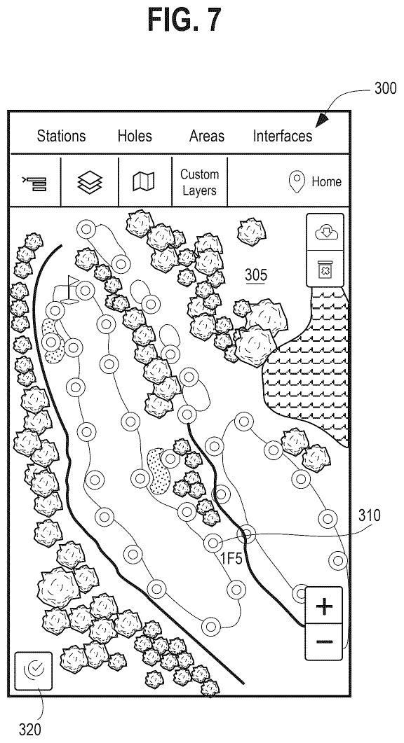

With reference to FIG. 7, in some embodiments, a user interface 300 is caused to be displayed by the irrigation management application 114a-114d to a user and shows a map 305 of a landscape including portions to be irrigated (referred to herein as an “irrigation area”) by an irrigation system 116. As shown in FIG. 7, such a map 305 may show the landscape (buildings, roads, cars, grass, trees, bushes, etc.) as well as the locations of various components of the irrigation system 116, such as irrigation stations represented by station icons 310 (e.g., an irrigation station being an irrigation valve).

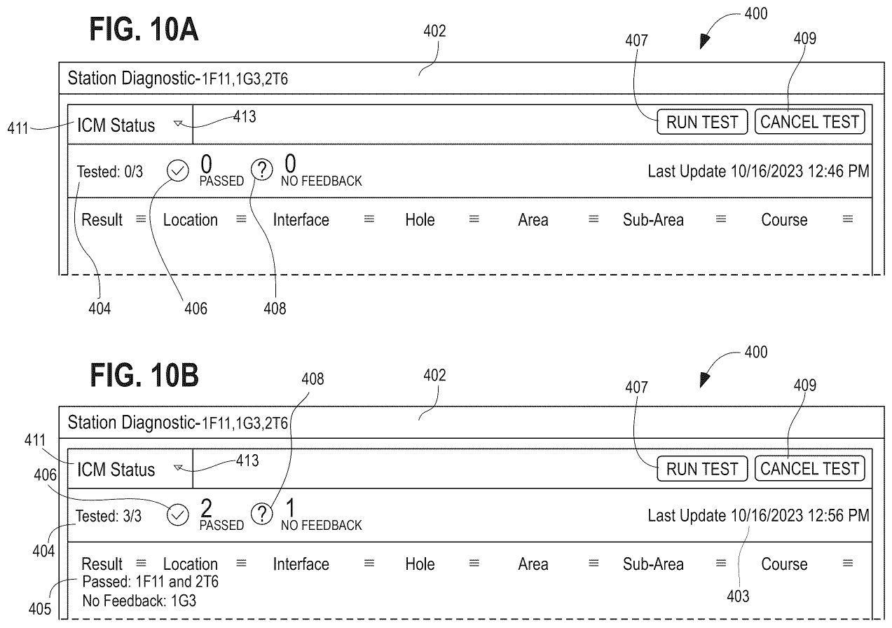

In some embodiments, the irrigation management application 114a-114d displays the map 305 of a geographic region including the irrigation area within the user interface 300 using satellite imagery, but other types of maps (e.g., street view, terrain, etc.) may be used. Notably, whether the software of the irrigation management application 114a-114d causes the user interface 300 to display the map 305 on a mobile device (e.g., FIGS. 7-9) or on a computer (FIGS. 10-12), the landscape features (i.e., golf course, as well as buildings, parking lot, roads/driveways, and surrounding area) shown in FIG. 7-9 are shown by way of example only, and the map 305 displayed within the user interface 300 may be a map of a commercial area, residential area, park, crop fields, etc.

It is noted that in many of the user interfaces presented herein, maps are shown of portions of geographic areas that include portions of an irrigation area. It is understood that the various views illustrated are for exemplary purposes, and that a user can manipulate the map views to zoom in on an area in more detail, or to back out to view a larger area and/or to move to other portions of the irrigation area. Such manipulation of map interfaces is well known and can be implemented through user movements (mouse clicks, finger taps/pinches, etc.). In some embodiments, some displayed features may be viewed depending on the zoom levels.

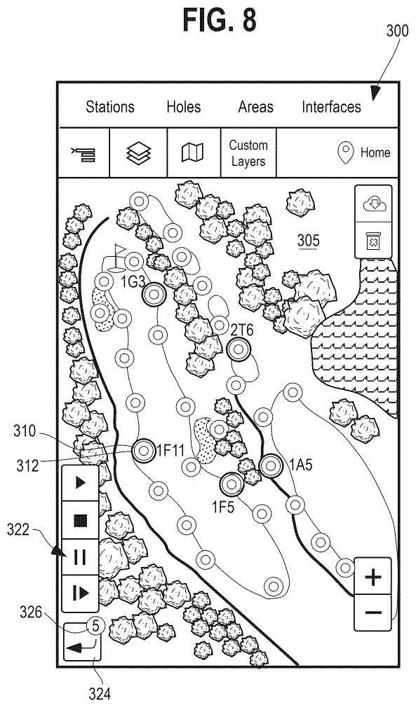

In some embodiments, described in more detail below with reference to FIGS. 7-10, the irrigation management application 114a provides a user interface 300 that allows a user to select one or more station icons 310 (each associated with an irrigation station) directly from the map 305 to create a group of irrigation stations, and then apply a control action to the selected irrigation stations. In some aspects, the control actions that may be applied include but are not limited to turning a station on, turning a station off, pausing irrigation by a station, and resuming the irrigation by the station, as shown for example, in FIG. 8.

In some embodiments, described in more detail below with reference to FIG. 7, the irrigation management application 114a is configured to generate a user interface 300 that causes a multi-station selector tool 320 (i.e., multi-station selector feature) to be displayed to the user and that permits a user to select one or more station icons 310 (corresponding to irrigation stations) and display an interactive control panel 322 overlaid on a portion of the map 305 to allow a control selection to be applied to each of the selected irrigation stations corresponding to the station icons 310 selected by the user. In particular, in some embodiments, the irrigation management application 114a provides the user with an interactive user interface 300 that shows a map 305 of an irrigation area and permits the user to use a multi-station selector tool 320 that allows the user to select multiple station icons 310 corresponding to irrigation stations from the displayed map 305 of the irrigation area to create or select a group of irrigation stations, which then permits the user to make a control selection and cause a control and/or other operation to be executed for the irrigation stations associated with the station icons 310 in the user-selected group.

For example, the multi-station selector feature is shown as a multi-station selector tool 320 in FIG. 7, which when activated, allows a user to pick a user-desired number of station icons 310 corresponding to irrigation stations of the irrigation system 116 deployed in the irrigation area, and to then manage (e.g., monitor, control, etc.) such irrigation stations directly from the map 305 of the irrigation area (e.g., to cause those irrigation stations to irrigate for a user-selected period of time or to stop irrigating, or to adjust the operational parameters of the irrigation stations, etc.). The exemplary user interface 300 shown in FIG. 7 displays a map 305 of the irrigation area to the user, and the map includes imagery (e.g., aerial imagery) of the irrigation area with overlaying graphics showing each station icon 310 (shown as a circle). In some aspects, as shown in FIG. 7, and depending on the zoom level of the map 305, at least some station icons 310 are displayed with a pre-selected identifier, name, or label of the corresponding irrigation station label, e.g., 1F5 (Hole #1, Fairway, Station #5 on a golf course).

Notably, while the exemplary user interface 300 shows aerial imagery of an irrigation area comprising portions of a golf course, it will be appreciated that the user interface 300 may display a map of any irrigation landscape other than a golf course. It is also understood that station identifiers may or may not be displayed adjacent to the station icons 310 depending on the zoom of the map 305 and available space to display the information to the user.

In the embodiment illustrated in FIG. 7, when a user viewing the user interface 300 desires to select multiple station icons 310 on the map 305 of the irrigation area to manage operation or view status or other information associated with the irrigation stations associated with the user-selected station icons 310, the user interface 300 provides the user with the interactive multi-station selector tool 320, which may be, for example, an interactive icon, and the user may select the multi-station selector tool 320 by clicking or tapping on the icon for the multi-station selector tool 320.

In the embodiment shown in FIGS. 7-8, the user's interaction with the multi-station selector tool 320 of the user interface 300 causes the user interface 300 to display an interactive control panel 322 overlaid on a portion of the map 305 or adjacent the map 305. In the example shown in FIG. 8, the interactive control menu is illustrated as a control panel 324 (that includes various control selections that permit the user to, for example, start, stop, pause, and resume irrigation) and a selected stations icon 326 (indicating how many station icons 310 were selected by the user). The user is then permitted to click or tap on one or more of the station icons 310 on the map 305 of the irrigation area to select them. In the embodiment shown in FIG. 8, responsive to a selection by the user of the station icon 310 (corresponding to irrigation station 1F11), the user interface 300 generates a graphical element 312 associated with the station icon 310 to visually indicate that the station icon 310 has been selected by the user, e.g., a circle outline or border around the selected station icon 310.

Notably, in some embodiments, the exemplary user interface 300 is configured such that, while using the multi-station selector tool 320, the user is permitted to unselect a previously user-selected irrigation station (e.g., 1F11) individually from the map 305 of the irrigation area (e.g., by selecting, clicking, tapping, or hovering over the selected station icon 310 corresponding to the irrigation station 1F11). Alternatively, in some aspects, instead of generating the graphical element 312 around the user-selected station icon 310 (and any other station icons 310 that also have been selected by the user, e.g., 1G3 and 2T6), the user interface 300 may be configured to change the color of the user-selected station icon 310 to make this station icon 310 appear visually distinct from the color of the station icons 310 that have not been selected by the user. In other embodiments, the graphical element 312 can be positioned nearby or adjacent to the selected station icon 310.

In the exemplary interface 300 shown in FIG. 8, five station icons 310 (corresponding to irrigation stations 1F11, 1F5, 1A5, 2T6, and 1G3) have been selected by the user. Notably, the identifiers of the irrigation stations, e.g., 1F11, 1G3, etc. may be selected to visually indicate to the user a location type on the map where the irrigation station is located and a sequential number assigned to the irrigation station within the location type. For example, in one embodiment, where the irrigation area covers portions of a golf course, and there are 12 irrigation stations installed on the fairway of hole 1, an irrigation station may be assigned the identifier 1F11 (shown in FIG. 8), with the 1 indicating “hole 1,” F indicating “fairway” (G could indicate “green,” B could indicate bunker, T could indicate tee area, etc.), and 11 indicating that this irrigation station is “number 11.”

In the example shown in FIG. 8, the user interface 300 displays a selected stations icon 326 that visually displays to the user the number of station icons 310 selected by the user thus far. In the illustrated embodiment, the selected stations icon 326 appears as a small number 5 in a circle at the upper right corner of the selected stations icon 326 (which itself may visually change from a check mark inside a circle as shown in FIG. 7 to a return key arrow-like symbol as shown in FIG. 8) to indicate 5 station icons 310 (i.e., the icons for station 1F11, 1F5, 1A5, 2T6, and 1G3) have been selected by the user. It will be understood that the location of the selected stations icon 326 is shown by way of example only, and that the selected stations icon 326 may appear at any other location within the user interface 300, and may spell out the word “Five” instead of showing the number “5” corresponding to the user-selected number of station icons 310. As can be seen in FIG. 8, each of the user-selected five station icons 310 has the graphical element 312 associated therewith to visually indicate that the station icon 310 has been selected by the user. As mentioned above, the graphical element 312 surrounding a user-selected station icon 310 may be a distinctly-colored circle or ring (or another geometric figure) to visually indicate the station icons 310 that have been selected by the user.

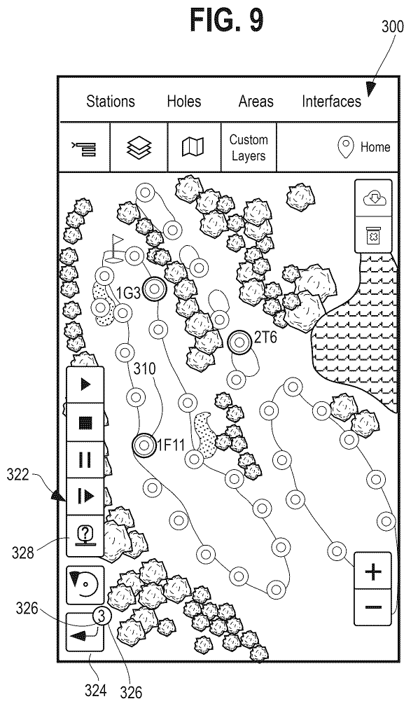

In the example shown in FIG. 8, the user interface 300 displays a selected stations icon 326 that visually displays to the user the number of station icons 310 selected by the user thus far, with the selected stations icon 326 appearing as a small number 3 to indicate 3 station icons 310 (i.e., the icons for station 1F11, 2T6, and 1G3) have been selected by the user. As mentioned above, a user's interaction with the multi-station selector tool 320 of the user interface 300 causes the user interface 300 to display an interactive control panel 322 that includes various control selections that permit the user to control and/or monitor operation of the irrigation stations associated with the user-selected station icons 310. The exemplary control panel 322 of the user interface 300 shown in FIG. 8 includes interactive icons/buttons such as Start (represented by the triangle shape), Stop (represented by the square shape), Pause (represented by two parallel lines), and Resume (represented by a vertical line adjacent a triangle), but it will be appreciated that additional or alternative icons/buttons may be used. Notably, in the embodiment illustrated in FIG. 9, the exemplary control panel 322 of the user interface 300 shown in FIG. 9 includes an interactive button or icon 328 (represented by the encircle question mark shape), which provides a control action (e.g., a diagnostics tool) that enables the start of a station diagnostic test for the irrigation stations (i.e., 1F11, 1G3, and 2T6) associated with the three station icons 310 in the group of user-selected station icons 310.

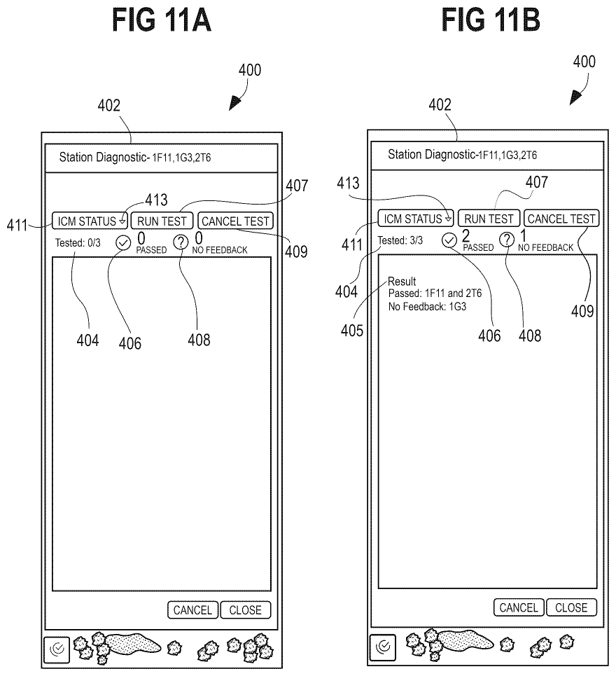

In the illustrated embodiment, when the user selects the diagnostics tool icon 328 in the control panel 322 displayed in FIG. 9, the irrigation management application 114a responds by causing the user interface 300 to display a diagnostic test window 400 as shown in FIG. 10A, which displays information relating to the diagnostic test, and permits the user to initiate (or to cancel) the diagnostic test. Notably, FIG. 10A illustrates an example of how the user interface 300 and diagnostic test window 400 would appear on a display coupled to a computer (e.g., desktop, laptop, etc.), while FIG. 11A illustrates an example of how the user interface 300 and diagnostic test window 400 would appear on a display coupled to a mobile device (e.g., mobile phone, tablet, etc.)

The diagnostic test window 400 includes a first informational field 402 that indicates which irrigation stations are being tested (i.e., in this exemplary case, stations 1F11, 1G3, and 2T6). The diagnostic test window 400 shown in FIGS. 10A and 11A includes an informational field 406 that indicates a number of the irrigation stations in the selected group of irrigation stations that have passed the diagnostic test (in this example, the number is 0, since the diagnostic test has not been run yet). In addition, the diagnostic test window 400 shown in FIGS. 10A and 11A includes an informational field 408 that indicates a number of the irrigation stations that have not passed the diagnostic test because they did not provide feedback responsive to the diagnostic test (in this example, the number is 0, since the diagnostic test has not been run yet). The exemplary diagnostic test window 400 shown in FIGS. 10A and 11A includes a fourth informational field 403 that indicates the date and time (in this case, on 10/16, 2024 at 12:56 pm) on which the diagnostic test was run.

Further, the diagnostic test window 400 shown in FIGS. 10A and 11A includes a first interactive button or icon 407 that causes the diagnostic test to be run, in this exemplary case, on irrigation stations 1F11, 1G3, and 2T6 and a second interactive button or icon 409 that cancels the diagnostic test of irrigation stations 1F11, 1G3, and 2T6. In the illustrated embodiment, in response to the user interactive with the first interactive icon 407 (i.e., “Run Test”), the irrigation management application 114a causes a diagnostic test to be run on each of the irrigation stations (i.e., 1F11, 1G3, and 2T6) selected by the user.

In some aspects, during the diagnostic test, a measured or sensed voltage data is obtained at each of the two or more irrigation stations associated with the station icons 310 selected by the user and/or a measured or sensed pressure data is obtained at each of the two or more irrigation stations associated with the station icons 310 selected by the user. In particular, in some aspects, the diagnostic test may be to obtain a measured/sensed voltage and/or pressure data at each user-selected irrigation station (i.e., 1F11, 1G3, and 2T6) and indicate whether the irrigation stations passed the test (e.g., the sensed values were within normal operating ranges), did not pass the test (e.g., the sensed values were outside of normal operating ranges), or that the test could not be run or completed (e.g., “no feedback” since sensor data was not available). In the Example shown in FIGS. 10A and 11A, the diagnostic test that is being performed is the Irrigation Control Module (ICM) Status test, which is reflected by the text select informational field 411, which includes an interactive button or icon 413, which, when interacted with by the user, permits the user to select a different diagnostic test, for example, voltage test, pressure test, etc. In some embodiments, the ICM Status Test sends a test message to various decoder devices (e.g., ICM devices) acting as irrigation stations attached to a multi-wire path to see if the decoder devices are properly working. In some embodiments, the test is successful if the decoder responds to the test signal.

In the example shown in FIG. 10B, the irrigation management application 114a, after completion of the diagnostic test, caused the user interface 300 to display the diagnostic test results within the diagnostic test window 400, which is overlayed over the map 305 of the user interface 300. Notably, FIG. 10B illustrates an example of how the user interface 300 and diagnostic test window 400 would appear on a display coupled to a computer (e.g., desktop, laptop, etc.), while FIG. 11B illustrates an example of how the user interface 300 and diagnostic test window 400 would appear on a display coupled to a mobile device (e.g., mobile phone, tablet, etc.)

In the exemplary diagnostic test window 400 shown in FIGS. 10B and 11B, informational field 404 indicates that the total number of irrigation stations that were tested in the diagnostic test (in this case, the total number being 3). Also in FIGS. 10B and 11B, the informational field 406 indicates that 2 of the irrigation stations tested in the diagnostic test passed the diagnostic test, while the informational field 408 indicates that 1 of the irrigation stations tested in the diagnostic test did not pass the diagnostic test. Also in FIGS. 10B and 11B, the informational field 405 of the diagnostic test window 400 indicates which irrigation stations passed the test, and which did not provide feedback in response to the diagnostic test. In this example, the informational field 405 shows that irrigation stations 1F11 and 2T6 passed the diagnostic test while irrigation station 1G3 did not provide feedback (which may cause a technician to go out to inspect irrigation station 1G3).

If, for example, after the completion of the diagnostic test, all three irrigation stations passed the diagnostic test, the informational field 404 would indicated that the total number of irrigation stations that were tested in the diagnostic test was 3, the informational field 406 would indicates that 3 of the irrigation stations tested in the diagnostic test passed the diagnostic test, the informational field 408 would indicate that 0 of the irrigation stations tested in the diagnostic test did not pass the diagnostic test, and the informational field 405 would show that all irrigation stations 1F11, 1G3, and 2T6 passed the diagnostic test. This above-described user interface 300 makes it easier and faster to run diagnostics on multiple stations at once directly from the map 305 without the need to exit the map 305 and run diagnostics in a separate data view interface.

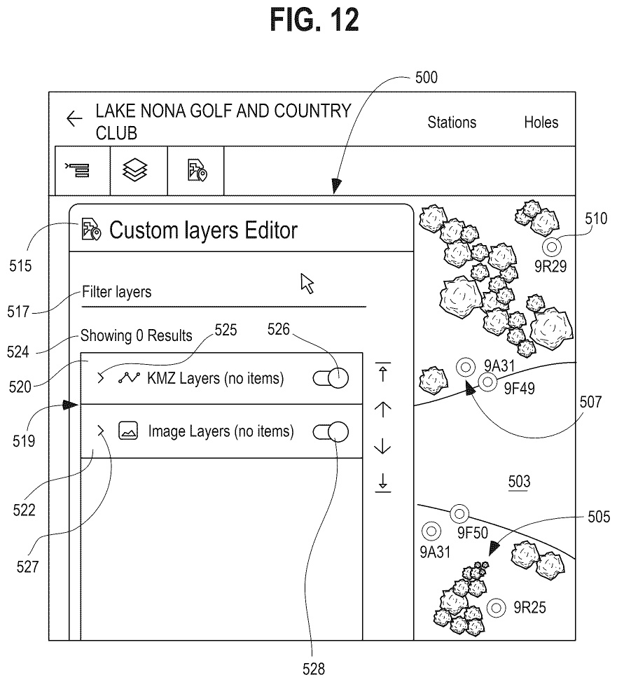

With reference to FIG. 12, in some embodiments, a user interface 500 may include multiple layers such as a map layer 503 having aerial map imagery 505 and various control layers 507 superimposed over the map layer 503 and/or each other. The control layers 507 may include irrigation system features such as the irrigation station (FIG. 12 shows six exemplary station icons 510 associated with six exemplary irrigation stations 9R29, 9A31, 9F49, 9A31, 9F50, and 9R25), the station labels, pump locations, controller locations, etc. Some of the layers may be at least partially transparent and others block features underneath features in the map layer 503.

In some aspects, the map interface may include a custom layers editor feature 515 which can also provide an “import file feature” that allows users to import vector files and/or image files to create new map layers. For example, a user may have a vector or image file from a prior installation or prior central control software system and would like to re-use the vector file or the image file with the software application. Such files defining the locations of irrigation system components would normally take great time and effort to create, and the File Import feature allows the user to avoid having to create new files or re-creating the equivalent of these files for use with the irrigation management application 114a. In other words, in some embodiments, the custom layers editor feature 515 allows the user to import an existing vector file or an existing image file as an additional layer into the user interface 500 as a layer that is superimposed with the map layer 503 and/or a control layer 507.

In some embodiments, the vector files are files in .kmz/.kml vector file format and/or in the .shp file format (referred to as shape files for use with geographic information system (GIS) software). The .shp files may include multiple vector files and are tied to a coordinate system to allow the vector files to be correctly projected onto a map. Generally speaking, the coordinate systems may be known or custom coordinate systems. In certain aspects, the image files may be any image file format, for example, .jpg, .gif, png, .tiff, or the like file format.

FIG. 12 shows an exemplary user interface 500 with a custom layers editor feature 515 overlaying a portion of the map imagery 505. In this embodiment, the custom layers editor feature 515 includes a menu 517 that includes a listing 519 of all custom layers that are imported into the user interface 500. Also in FIG. 12, the exemplary listing 519 of the custom layers includes a first informational field 520 indicating the number of KMZ layers imported into the user interface 500 (in this case, the number is zero and the first informational field 520 states “no items”), and a second informational field 522 indicating the number of image layers imported into the user interface 500 (in this case, the number is zero and the second informational field 522 states “no items”). In the illustrated embodiment, the menu 517 also includes a third informational field 524 that indicates a total number of results (i.e., custom layers) that have been detected as imported into the user interface 500 (in this case, the number is zero and the third informational field 524 states “Showing 0 results”).

In the embodiment illustrated in FIG. 12, the custom layers editor feature 515 further includes a first interactive icon 526 that permits the user to toggle between making the kmz custom layer(s) listed in the listing 519 of the menu 517 visible over the map layer 503 and not visible over the map layer 503. By the same token, the custom layers editor feature 515 further includes a second interactive icon 528 that permits the user to toggle between making the image custom layer(s) listed in the listing 519 of the menu 517 visible over the map layer 503 and not visible over the map layer 503.

Also in the illustrated embodiment, the first informational field 520 includes a first expansion symbol 525, which, in the event that one or more (for example, 2) KMZ layers are present in the user interface 500, would permit the user to expand the first informational field 520 by selecting/clicking/tapping on the first expansion symbol 525 and reveal the kmz layer file names (in this example, 0 file names) that are imported into the user interface 500. Also in the illustrated embodiment, the second informational field 522 includes a second expansion symbol 527, which, in the event that one or more (for example, 2) image layers are present in the user interface 500, would permit the user to expand the second informational field 522 by selecting/clicking/tapping on the second expansion symbol 527 and reveal the image layer file names (in this example, 0 file names) that are imported into the user interface 500. If, for example, 2 kmz files and 2 image layers were imported into the user interface 500, the third informational field 524 would indicate that there a 4 custom layers detected (and would state, e.g., “Showing 4 Results”).

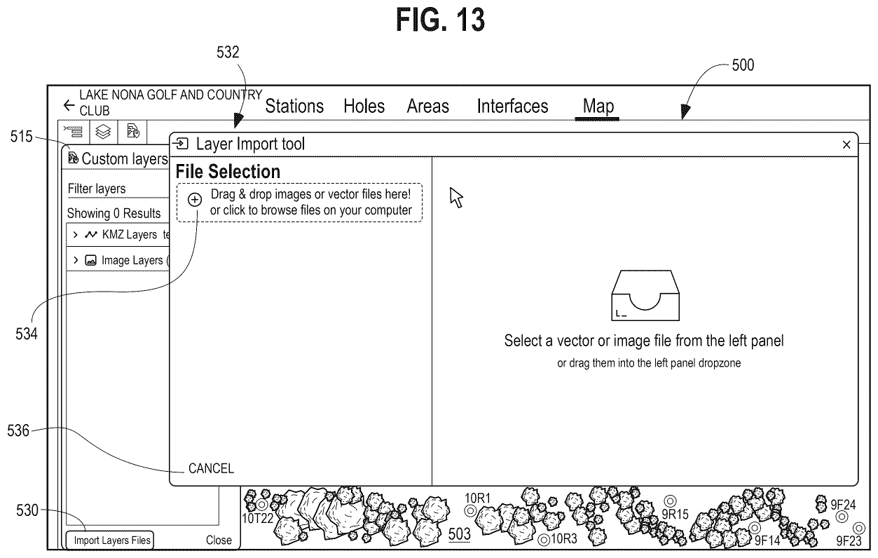

In the embodiment shown in FIG. 13, the custom layers editor feature 515 includes an option to import layer files. In particular, the exemplary custom layers editor feature 515 in FIG. 13 includes an interactive import layers file icon 530, and, in response to the user's selection of the interactive import layers file icon 530, the user interface 500 displays a layer import tool 532 overlaid over a portion of the map layer 503 to permit the user to import one or more vector files and/or one or more image files to create one or more new layers in the user interface 500. With reference to FIG. 13, the layer import tool 532 includes an interactive import file field 534 that permits the user to select a vector file or an image file the user wishes to import, or to drag and drop a vector file or an image file the user wishes to import. In the illustrated embodiment, the layer import tool 532 also includes an interactive icon 536 (e.g., “Cancel”) that permits the user to cancel the import of a vector file (e.g., a .kmz, .shp, or the like file) or an image file (e.g., a .jpg, .gif, .tiff, or the like file) into the user interface 500 by closing the layer import tool 532.

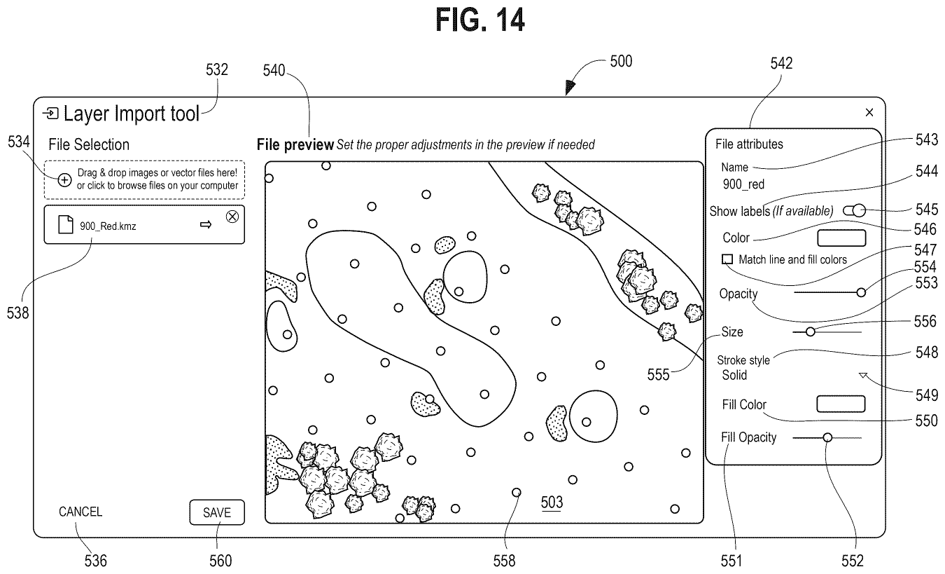

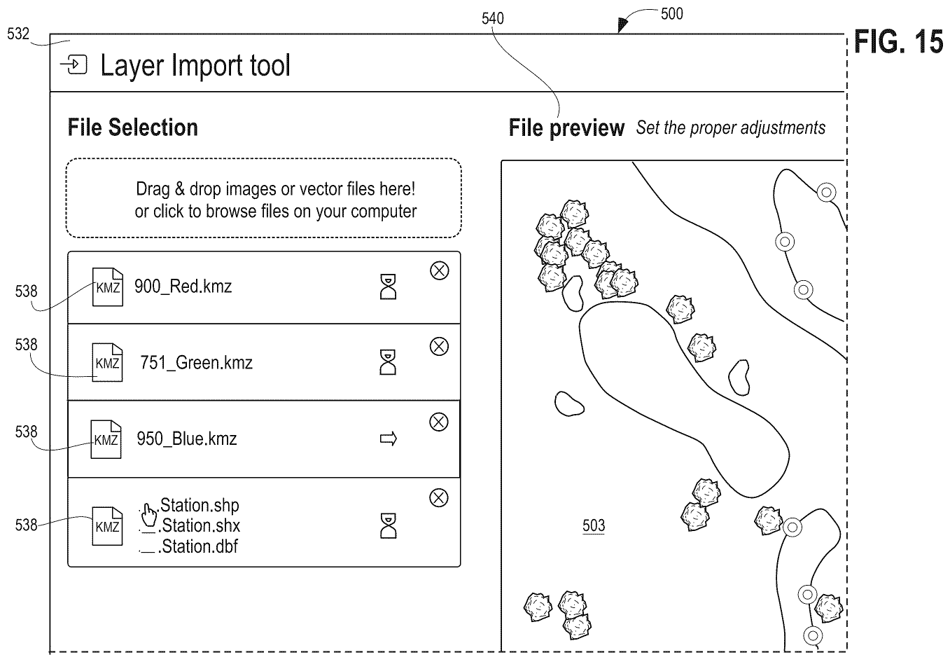

In the embodiment illustrated in FIG. 14, a .kmz file 538 (named 900_Red.kmz) has been selected within the layer import tool 532 for import into the map layer 503 of the user interface 500. In this embodiment, in response to an interaction by the user with the layer import tool 532 to import the .kmz file 538 into the user interface 500, the irrigation management application 114a causes the user interface 500 to generate a file preview window 540. The exemplary file preview window 540 of FIG. 14 displays the map layer 503 as it would look if the vector file (i.e., the .kmz file 538 named 900_Red.kmz) or an image file (e.g., a .jpg file) were imported and superimposed over the map layer 503.

In some embodiments, the file preview window 540 includes a file attributes menu 542 that permits the user to define/change/adjust multiple attributes of the imported vector file. For example, the file attributes menu 542 includes: an interactive field 543 that permits the user to define/change/adjust the name of the file being imported; an interactive field 544 that includes an interactive icon 545 that permits the user to show labels associated with the file; an interactive field 546 that permits the user to define/change/adjust the color of the layer being imported and includes an interactive option 547 that permits the user to select an option to match line and fill colors in association with the layer being imported; an interactive field 553 that permits the user to define/change/adjust the opacity of the imported layer by using a movable button/icon 554 to the left (to reduce the opacity) and to the right (to increase the opacity); an interactive field 555 that permits the user to define/change/adjust the size of the imported layer by using a movable button/icon 556 to the left (to reduce the size) and to the right (to increase the size); a field 548 that permits the user to set the stroke style (e.g., visual properties of outline or border applied to the imported layer) and includes an interactive expansion arrow 549 that permits the user to expand the choices available for the stroke style (in FIG. 14, “Solid” is selected for the stroke style); an interactive field 550 that permits the user to define/change/adjust the fill color of the layer being imported; and an interactive field 551 that permits the user to define/change/adjust the fill opacity by using a movable button/icon 552 to the left (to make the fill opacity more transparent and less opaque) and to the right (to make the fill opacity more opaque and less transparent).

In certain aspects, the file attributes menu 542 and the above-described attributes that may be defined, changed, and/or adjusted using the file attributes menu 542 allow user to preview and see the image layer associated with the layer file (in this case, a .kmz file) as it would be applied or projected over the map layer 503 before saving this image layer as a layer in the system. For example, in the embodiment illustrated in FIG. 14, the circles 558 (e.g., black circles with no fill) overlaying the map layer 503 in FIG. 14 are from the vector file 538 named 900_Red.kmz and provide a preview of how they would be projected onto the map layer 503 if this layer is saved. Also in FIG. 14, the layer import tool 532 includes an interactive button or icon 560 which is called “Save” (but may have another similar name), and which permits the user to save the layer associated with the vector file 900_Red.kmz as an overlay over the map layer 503. If the user does not wish to save the layer associated with the vector file 900_Red.kmz as an overlay over the map layer 503, the user may press the “Cancel” button or icon 536 to cancel the importation of the vector file 900_Red.kmz into the user interface 500 as an overlay over the map layer 503.

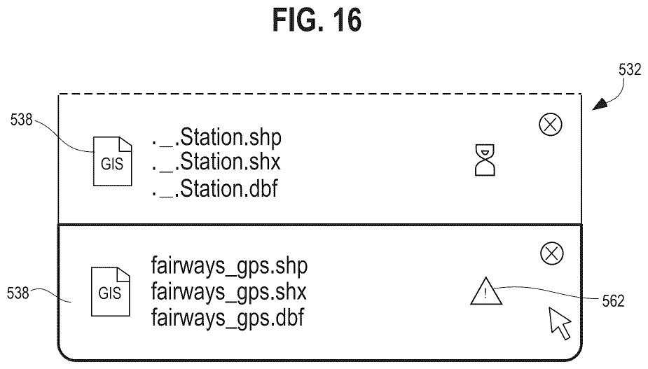

As mentioned above, .shp files may be multiple vector files and may be tied to a coordinate system. In the exemplary user interface 500 shown in FIG. 15, the layer import tool 532 shows a .shp file 538 (named “Station.shp”) selected for import (also selected for import in this example are the above-discussed .kmz file 538 named 900_Red.kmz, another kmz file 538 named 751_Green.kmz, and another kmz file 538 named 950_Blue.kmz). In some embodiments, the layer import tool 532 can provide a warning or notification if a .kmz file, .shp file, or an image file is incomplete or has an error. In the example illustrated embodiment shown in FIG. 16, the layer import tool 532 provides a warning, indicated by an image 562 (in this example, in the form of a triangle enclosing an exclamation sign) that the .shp file 538 named “fairways_gps.shp” is associated with an error, is incomplete, or has some other issue with it that interferes with the ability of the layer import tool 532 to import this .shp file 538 into the map layer 503.

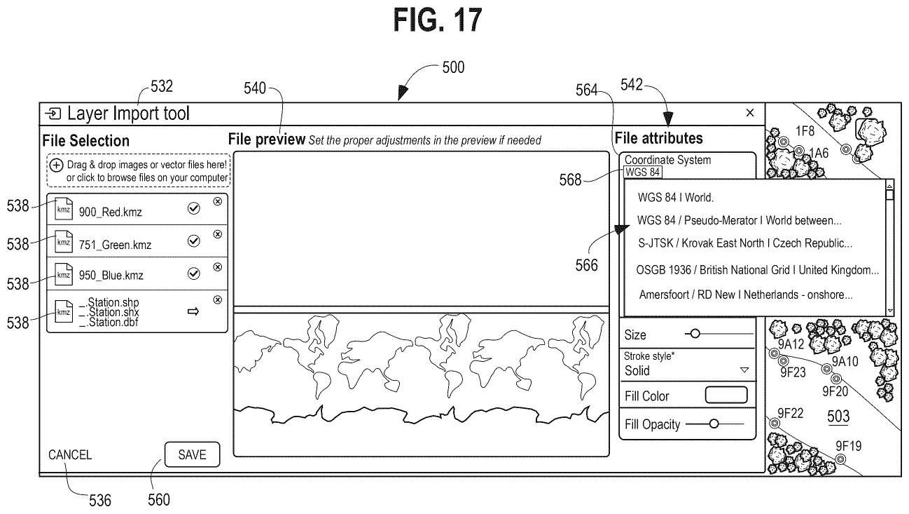

In some embodiments, for example, as illustrated in FIG. 17, the exemplary illustrated layer import tool 532 allows the user to interact with the file attributes menu 542 to cause the user interface 500 to generate a coordinate system menu 564 that partly overlays the map layer 503 and includes a listing of user-selectable coordinate systems 566 (in this example, WGS 84 (World Geodetic System 1984), WGS 84/Pseudo-Merator (commonly used for web mapping applications, such as Google Maps and OpenStreetMap), S-JTSK/Krovak East North (geographic coordinate system used primarily in the Czech Republic and Slovakia), OSGB 1936 (Ordnance Survey Great Britain 1936), and Amersfoort). In the illustrated embodiment, the file attributes menu 542 includes an informational field 568 that indicates that the user has chosen the coordinate system WGS 84, which, generally speaking, is a global reference system for spatial data and provides a framework for measuring and mapping locations on the Earth's surface and is widely used in GPS technology and mapping applications.

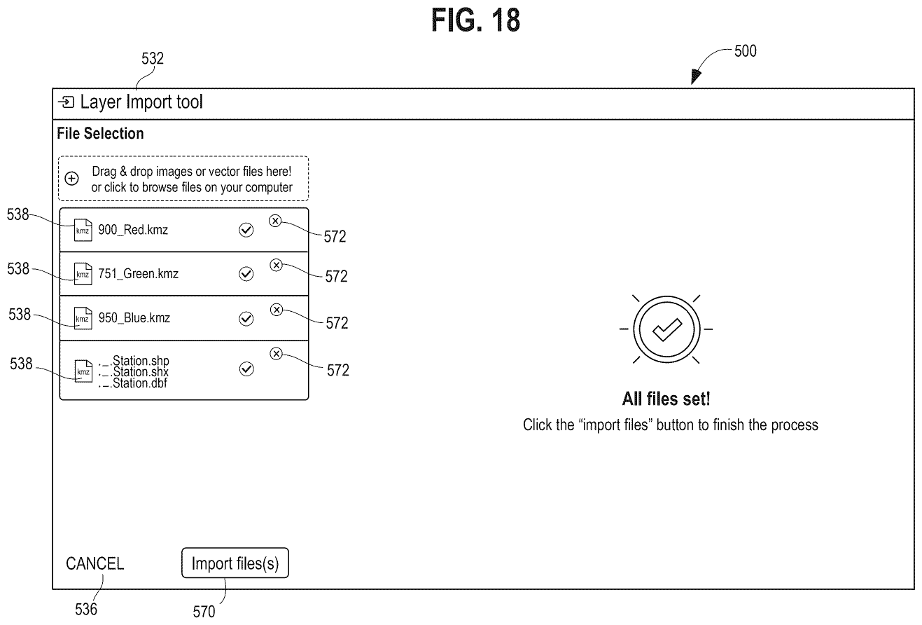

In the exemplary embodiment shown in FIG. 18, the layer import tool 532 lists the layer files 538 (in this case, 900_Red.kmz, 751_Green.kmz, 950_Blue.kmz, and Station.shp) the user selected to be imported into the map layer 503 of the user interface 500. As illustrated in FIG. 18, after all attributes of the layers to be imported as set and none of the layer files 538 have any errors, the layer import tool 532 includes an interactive field 570 (icon, button, etc.) that the user may interact with (e.g., click, tap, etc.) to import all four of the layer files 538 listed in the layer import tool 532 in FIG. 18 as layers to be displayed or projected over the map layer 503 of the user interface 500. In some aspects, the layer import tool 532 provides the user with the ability to remove (delete) any one of the layer files 538 from the listing of the layer files 538 to be imported into the map layer 503. In the embodiment illustrated in FIG. 18, the layer import tool 532 includes interactive fields 572 (buttons, icons, etc.) associated with each of the layer files 538 (and, in this example, shown as circles encircling an X) which, when interacted with by the user, delete/remove the corresponding layer file 538 from the listing of the layer files 538 to be imported into the map layer 503. For example, if the user were to click or tap on the interactive field 572 associated with the layer file 538 named Station.shp, this layer file 538 would be removed and, after the user clicks on the interactive field 570 for importing the layer files 538, only the layer files 538 named 900_Red.kmz, 751_Green.kmz, and 960_Blue.kmz would be imported.

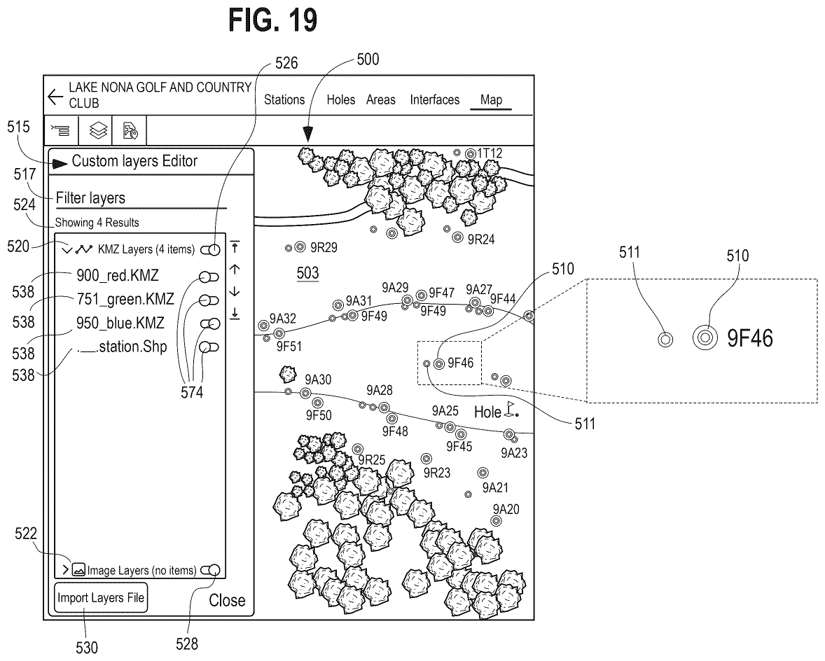

As mentioned above, in some embodiments, the irrigation management application 114a permits a user to import not only vector files, but also to import image files into the user interface 500. FIG. 19 shows an example, where the custom layers editor feature 515 shows that four vector files (i.e., 900_red.kmz, 751_green.kmz, 950_blue.kmz, and ._.station.shp) have been successfully imported, but no image files have been imported. Notably, by way of example, the smaller (by comparison to station icons 510) circle symbols 511 next to the station icons 510 are part of one of the vector files 538 (in this example, “950_blue”) imported to superimpose over the map layer 503.

In the example illustrated in FIG. 19, the symbols/objects that are part of the custom layer associated with vector file 538 named 950_blue is visible as superimposed over the map layer 503 because the interactive icon 574 associated with the 950_blue vector file 538 is toggled to the right-most position in which the symbols/objects associated with the vector file 538 named 950_blue are visible as being superimposed over the map layer 503. On the other hand, the symbols/objects that are part of the custom layers associated with the other three custom layer files 538 (i.e., 900_red.kmz, 751_green.kmz, and . _.station.sh) are not visible as superimposed over the map layer 503 because the interactive icons 574 associated with each of these other three vector files 538 are toggled to the left-most position in which the symbols/objects associated with these vector files 538 are not visible as superimposed over the map layer 503.

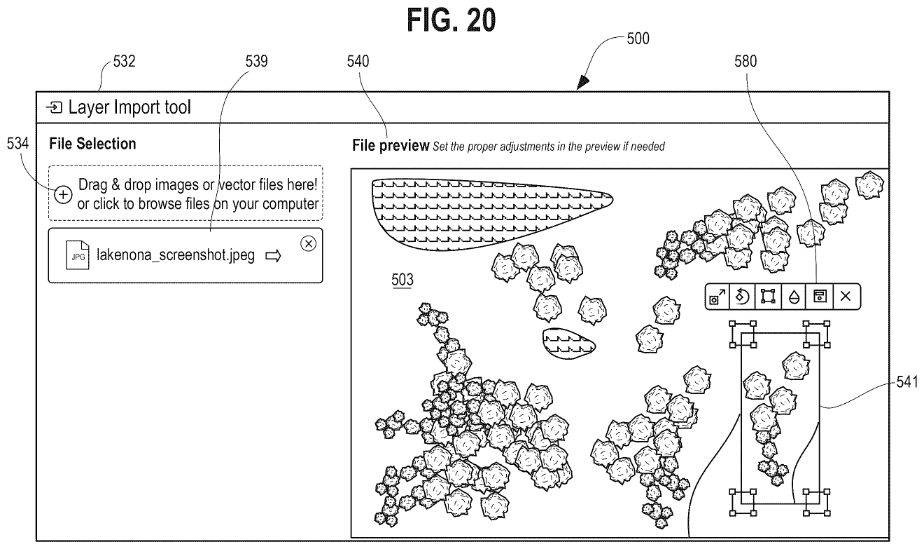

In some embodiments, to import an image into the user interface 500 to be superimposed with the map layer 503, the user may select the interactive import layers file icon 530 of the exemplary custom layers editor feature 515 in FIG. 13, which causes the irrigation management application 114a to cause the user interface 500 to display the exemplary layer import tool 532 as shown in FIG. 20. In the example shown in FIG. 20, the interactive import file field 534 of the layer import tool 532 indicates that one image file 539 (in this example, named “lakenona_screenshot.jpeg”) has been selected for import, and a preview of the image file 539 is shown in the file preview window 540, which is akin to the file preview window 540 discussed above in reference to FIG. 14, and which displays the map layer 503 as it would look if the image file (i.e., the image file 539 named lakenona_screenshot.jpeg) were imported and superimposed with the map layer 503. As can be seen in FIG. 20, the exemplary file preview window 540 shows the actual image 541 superimposed over the map layer 503.

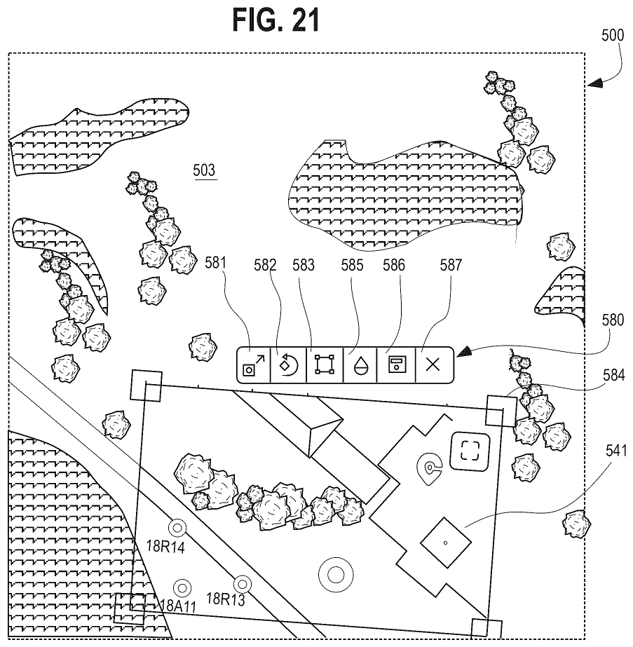

In some embodiments, the user interface 500 includes an attribute editor tool 580 as shown in FIGS. 20 and 21 that overlies a part of the map layer 503 and that allows the user to manipulate the image 541 being imported and determine how the image 541 will be superimposed with/projected onto the map layer 503. With reference to FIG. 21, the exemplary attribute editor tool 580 (enlarged in the view of FIG. 21) provides multiple exemplary control actions (but it will be appreciated that other control actions may be included). In this example, the control actions for adjusting the attributes of the image 541 that are provided by the attribute editor tool 580 include: a size adjust control 581, a rotate control 582, a move vertices tool or move vertices control 583 (the vertices of the image 541 being the corners of the image 541 emphasized with surrounding boxes 584 that may be moved to, for example, stretch, pull, or push the image 541 to best conform to the features of the underlying map layer 503). In the embodiment illustrated in FIGS. 19-20, the attribute editor tool 580 also includes an opacity control 585 to enable the user to adjust the transparency or opacity of the image 541 relative to the map layer 503, a save control 586 (that permits the user to save the attribute changes that have been applied by the user to the image 541) and a close tool control 587 (that allows the user to close the attribute editor tool 580).

In the example shown in FIG. 21, it can be seen that the image 541 has been sized using the size adjust control 581 and/or the move vertices control 583 and rotated counterclockwise using the rotate control 582 to a position and orientation, where the map imagery depicted by the image 541 correctly matches the map imagery depicted by the map layer 503. In this example, if the user is satisfied with the position, size, and/or orientation (and any other attributes) of the image 541, the user selects (e.g., clicks, taps, etc.) the save control 586 to add the image 541 associated with the image file 539 a new custom layer superimposed with the map layer 503. Like the custom layers associated with the above-described vector files 538, the added image file layers may be toggled (using an interactive icon/button akin to the interactive icon 574 described above with reference to FIG. 19) to be visible or not visible as overlays over the map layer 503 in the custom layers editor feature 515 (see FIGS. 12 and 19). The ability to import already created vector and image files can save a tremendous amount of programming when migrating existing systems to software 14 in some embodiments.

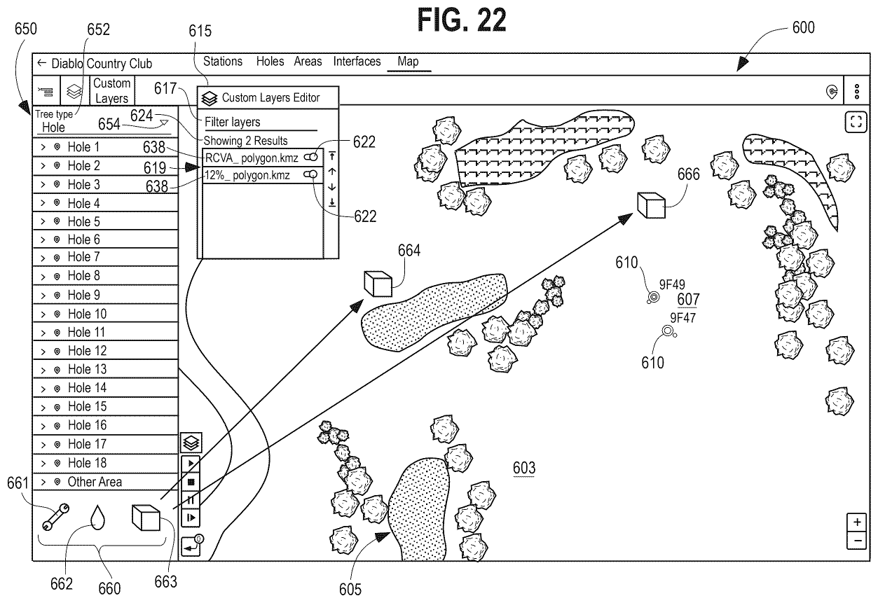

In some embodiments, the irrigation management application 114a permits the user to add a custom layer to the map layer 503 of the user interface 500 by dragging one or more icons onto the map layer 503. In certain implementations, the user may be able to view the organization of the irrigation site (e.g., golf course) from a tree view. FIG. 22 illustrates an embodiment of a user interface 600 that includes a map layer 603 depicting map imagery 605 of an irrigation area and visually displays to the user station icons 610 (of an irrigation control layer 607) corresponding to the irrigation stations of the irrigation system associated with the irrigation area. In some embodiments, the user interface 600 also visually displays to the user an interactive tree view irrigation control selection menu 650 together with the map layer 603 depicting the map imagery 605 of the irrigation area. In some aspects, the tree view irrigation control selection menu 650 permits the user, among other things, to apply a user-selected control/management selection to one or more user-selected irrigation stations and/or to view various informational attributes associated with the irrigation stations.

In some embodiments, the tree view irrigation control selection menu 650 is a hierarchical listing or tree of expandable/contractable branches and sub-branches. A user can expand main branches to reveal a sub-branch and may further expand a sub-branch to reveal another sub-branch, and so on. When viewing any particular main branch or sub-branch, the user can make a selection of parameters of the branch or sub-branch. For example, the exemplary tree view irrigation control selection menu 650 of the user interface 600 shown in FIG. 22 is configured to individually list the holes of the golf course (in this example, holes 1-18). In other words, in the embodiment of FIG. 22, the tree type selector 652 of the tree view irrigation control selection menu 650 is selected to be “Hole,” which defines the architecture, main branch, sub-branches, naming, and expansion/contraction of the main branches and one or more sub-branches. In the embodiment illustrated in FIG. 22, when the tree type that is selected by the user is Hole, the tree view irrigation control selection menu 650 displays a listing of main branches (e.g., Hole 1, Hole 2, Hole 3, etc.), any of which can be expanded (e.g., by clicking or tapping on branch expansion/contraction arrow 654 associated with each Hole listed in the tree view irrigation control selection menu 650 to reveal a selectable listing of items or parameters of a first sub-branch (e.g., Green, Tee, Fairway, Fairway Perimeters, Perimeter, and Rough), any of which can be further expanded to reveal a selectable listing of items or parameters of a second sub-branch (e.g., a listing of irrigation stations, i.e., a listing of identifiers corresponding to irrigation stations).

In some embodiments, the exemplary tree view irrigation control selection menu 650 of the user interface 600 icons includes a group of icons 660 as shown in FIG. 22, any one of which may be dragged onto the map layer 603 and dropped to a location of the map imagery 605. For example, in the embodiment illustrated in FIG. 22, the icon 663 (which, in this example, is shaped like a cube) has been dragged by the user and dropped onto the map imagery 605 as icons 664 and 666, which become superimposed with the map layer 603 and are visible to the user within the user interface 600. Also in FIG. 22, after the icons 664 and 666 are dropped onto the map imagery 605, the custom layers editor feature 615 lists the two icons 664, 666 as polygons which can be toggled to be visible or not visible like the other custom layers described above.

In the Example shown in FIG. 22 the custom layers editor feature 615 includes a menu 617 that includes a listing 619 of all custom filter layers that are imported into the user interface 600. Also in FIG. 22, the exemplary listing 519 of the custom filter layers indicates that two .kmz layer files 638 (i.e., RCVA_polygon.kmz and 12%_polygon_kmz) have been imported (in this example, via the user dragging the two icons 664, 666 to superimpose the map layer 603) into the user interface 600. In the illustrated embodiment, the menu 617 also includes an informational field 624 that indicates a total number of results (i.e., custom layers) that have been detected as imported into the user interface 600 (in this case, the number of layers detected is two and the informational field 624 states “Showing 2 results”). In the example illustrated in FIG. 22, the icons 664, 666 that are part of the custom layers associated with RCVA_polygon.kmz and 12%_polygon.kmz are visible as superimposed over the map layer 603 because the interactive icon 622 associated with each of the RCVA_polygon.kmz and 12%_polygon.kmz vector files 638 is toggled to the right-most position in which the symbols/objects associated with the vector files 538 RCVA_polygon.kmz and 12%_polygon.kmz are visible as being superimposed over the map layer 603. On the other hand, if any one of the interactive icons 574 associated with these vector files 538 were to be toggled to their left-most position, the icons 664, 666 associated with the vector files 638 named RCVA_polygon.kmz and 12%_polygon.kmz would become not visible as superimposed over the map layer 503.

In some aspects, the icons can each have a specific meaning. In the embodiment illustrated in FIG. 22, the icon 663 is shaped like a polygon (in this example, a cube) and may represent a valve box, the icon 661 is shaped like a wrench and may correspond to settings, and the icon 662 is shaped like a water drop and may correspond to a watering location. It will be appreciated that the number (i.e., 3) of icons 660 included in the exemplary tree view irrigation control selection menu 650 has been illustrated in FIG. 22 by way of example only, and that the tree view irrigation control selection menu 650 of the user interface 600 may include less than three or more than three icons 660, which may have a variety of shape and specific meanings.

In some implementations, once the icons 660 dragged onto the map layer 603 are positioned by the user into their desired locations, the custom layers editor feature 615 permits the user to add notes to the icons 660 that are viewable within the user interface 600 in response to the user selecting (e.g., clicking on, tapping on, etc.) an icon 660 on the map imagery 605. For example, such notes can be added to assist users and/or alert the users to issues to address.

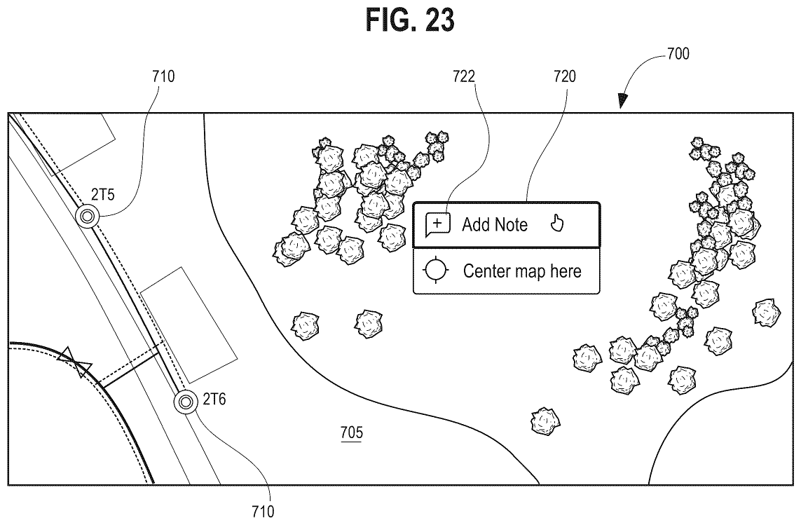

With reference to FIG. 23, in some embodiments, the user interface 700 provides the user with the ability to add a note to a location on the map 705, or to pin a note to a feature of the map 705. For example, as shown in FIG. 23, the user interface 700 permits the user to select (e.g., click on, tap on, etc.) a first portion of the map 705 (e.g., a location on the map 705 that does not include a specific feature such as a station icon 710 associated with an irrigation station). In response to this interaction by the user with the first portion of the map 705, the user interface 700 generates an interactive menu 720 including an add note option 722 as an overlay over the first portion of the map 705 interacted with by the user. In other words, after the user taps or clicks (this may be, for example, a longer than usual tap or a right-mouse click) on a portion of the map 705 that does not include a specific irrigation control feature (such as a station icon 710), the interactive menu 720 generated by the user interface 700 overlays (i.e., obstructs from view) the portion of the map 705 that the user interacted with. As will be discussed in more detail below, the user will then be permitted to pin the note that the user creates to the first portion of the map 705 that the user initially interacted with.

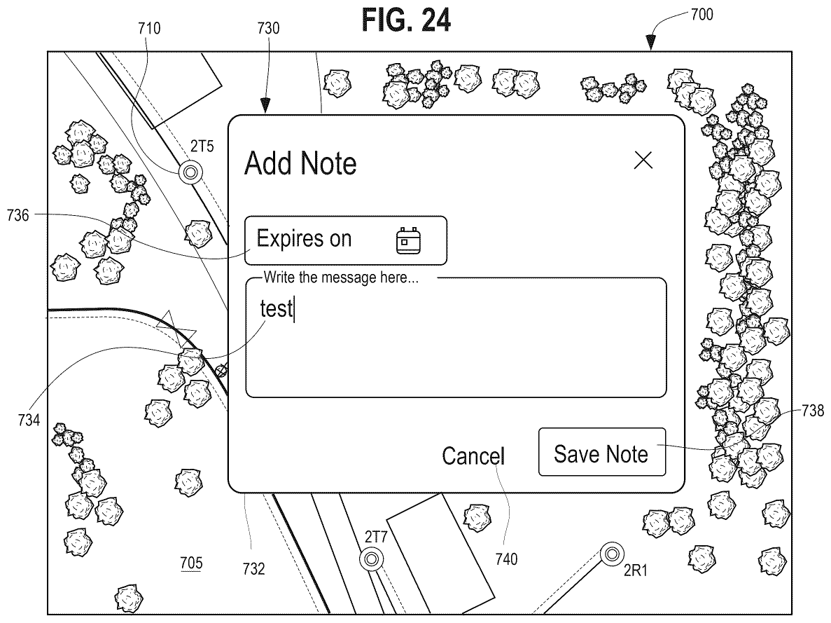

In some aspects, after the user interacts with (e.g., clicks, taps, etc.) the add note option 722 of the user interface 700 shown in FIG. 23, the irrigation management application 114a causes the user interface 700 to generate an add note feature 730 overlaid over the first portion of the map 705 initially interacted with by the user as shown in FIG. 24. In the illustrated embodiment, the add note feature 730 includes a free-form text entry field 732 that permits the user to enter (e.g., by typing text) the text 734 for the note. Also in the illustrated embodiment, the add note feature 730 includes an interactive expiration date field 736 that permits the user to manually enter a date on which the note will expire and disappear from view over the first portion of the map 705. Also in the illustrated embodiment, the add the note feature 730 includes an interactive icon or interactive button 738 called “Save Note” (but may be simply called, for example, “Save”) which permits the user to save the note created using the add the note feature 730, and an interactive icon (or button) 740 called “Cancel,” which permits the user to cancel the creation of the note.

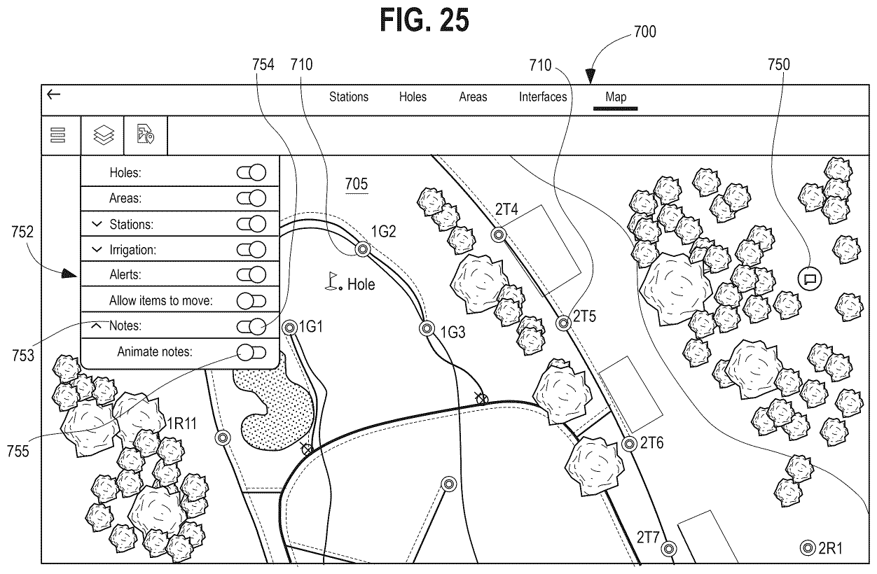

In the embodiment shown in FIG. 25, after the user saves the note by interacting with the interactive button 738, the resulting note 750 (represented by a flag-like symbol, but may be represented by an envelope-like or another symbol) created by the user is added (e.g., pinned) to the map 705 by being overlaid or projected at the location of the first portion of the map 705 that the user initially interacted with to bring up the interactive menu 720 shown in FIG. 23. In some aspects, similar to the other custom layers that may be added to the map 705, the notes may be made visible on the map 705 or not visible on the map 705 by the user. For example, the user interface illustrated in FIG. 25 includes an interactive menu 752 that includes various interactive fields that control what objects are displayed on the map 705 and/or how the objects are displayed on the map 705. The exemplary interactive menu 752 includes an interactive field 753 (called “Notes” in this example) that includes an interactive button or icon 754 (akin to the interactive icon 574 described above with reference to FIG. 19) that permits the note 750 (i.e., the portion of the note layer containing the note 750) to be visible or not visible as an overlay over the map 705. In the example shown in FIG. 25, the interactive icon 754 associated with the note 750 is toggled to the right-most position in which the note 750 is visible as being superimposed over the map layer that provides the map 705 that is visible to the user within the user interface 700.

In the illustrated embodiment, the interactive menu 752 further includes an interactive field 755 (called “Animate note” in this example), which enables the user to set the note 750 to be animated. For example, in some embodiments, the animate note feature provides the appears of motion to the note, such as changing color, changing size, flashing, etc. As illustrated, the interactive menu 752 includes an interactive button or icon 754, which, when toggled to the right-most position (as shown in FIG. 25), causes the note 750 to be visible as being superimposed over the map layer that provides the map 705, but when toggled to the left-most position (not shown in FIG. 25), causes the note 750 to be not visible as an overlay over a portion of the map 705.

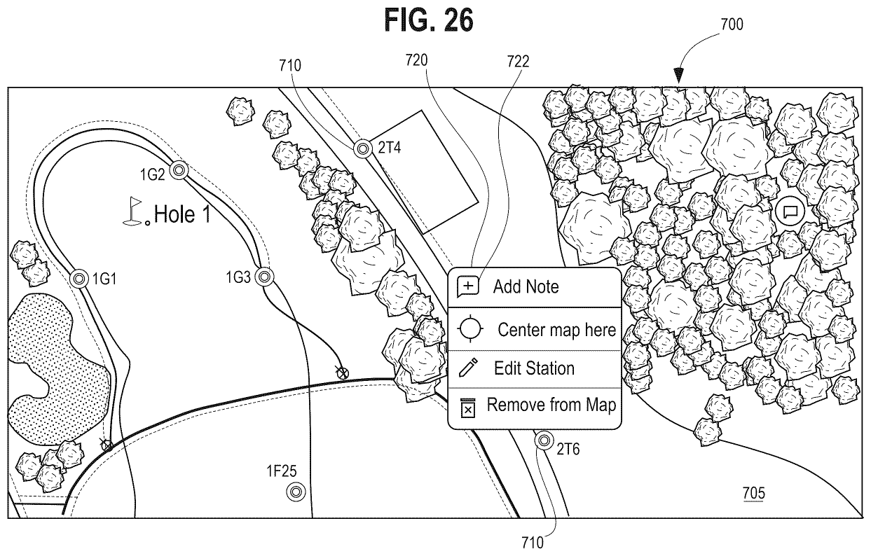

In some embodiments, the user interface 700 permits a user to pin a note 750 to another, more specific, feature on the map 705 (in contrast to FIG. 23, where the user interface 700 permits the user to pin a note 750 to any portion of the map 705 that lacks a specific feature). For example, in the embodiment shown in FIG. 26, the user interface 700 permits the user to create a note 750 and to pin the note 750 to a station icon 710 that is visible as a feature on the map 705 and associated with a specific irrigation station of the irrigation system 116.

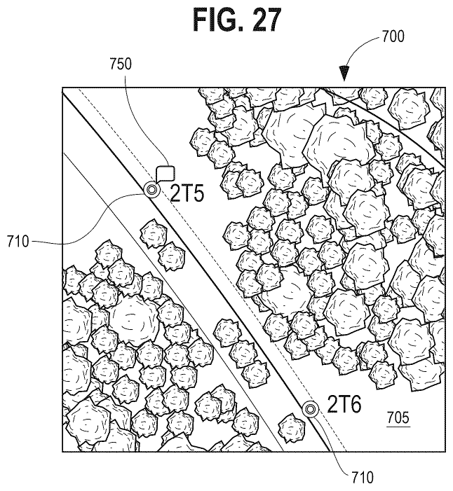

In the exemplary embodiment shown in FIG. 26, the user interface 700 permits the user to select (e.g., click on, tap on, etc.) a specific station icon 710 visible on the map 705 (the station icon 710 corresponding to irrigation station 2T5 (as seen in FIG. 27) is obstructed from view by the interactive menu 720). In response to this interaction by the user with the station icon 710, the user interface 700 generates the interactive menu 720 including an add note option 722 as an overlay over the specific station icon 710 interacted with by the user. In other words, after the user taps or clicks (this may be, for example, a longer than usual tap or a right-mouse click) on a given station icon 510 on the map 705, the interactive menu 720 generated by the user interface 700 overlays (i.e., obstructs from view) the station icon 710 that the user interacted with.

In some aspects, after the user interacts with (e.g., clicks, taps, etc.) the add note option 722 of the interactive menu 720 shown in FIG. 26, the irrigation management application 114a causes the user interface 700 to generate an add note feature 730 (akin to the add note feature 730 shown in FIG. 24) overlaid over the station icon 710 that the user interacted with. As discussed above in reference to FIG. 24, the add note feature 730 includes a free-form text entry field 732 that permits the user to enter (e.g., by typing text) the text 734 for the note and may include an interactive expiration date field 736 that permits the user to manually enter a date on which the note will expire and disappear from view when the user view the map 705.

In the embodiment shown in FIG. 27, after the user saves the note by interacting with the interactive button 738 (see FIG. 24), the resulting note 750 (represented by a flag-like symbol, but may be represented by an envelope-like or another symbol) created by the user is added (e.g., pinned) to the station icon 710 on the map 705 by being overlaid or projected at least partially over (but may be adjacent to) the station icon 710 that the user interacted with to bring up the interactive menu 720 shown in FIG. 26.

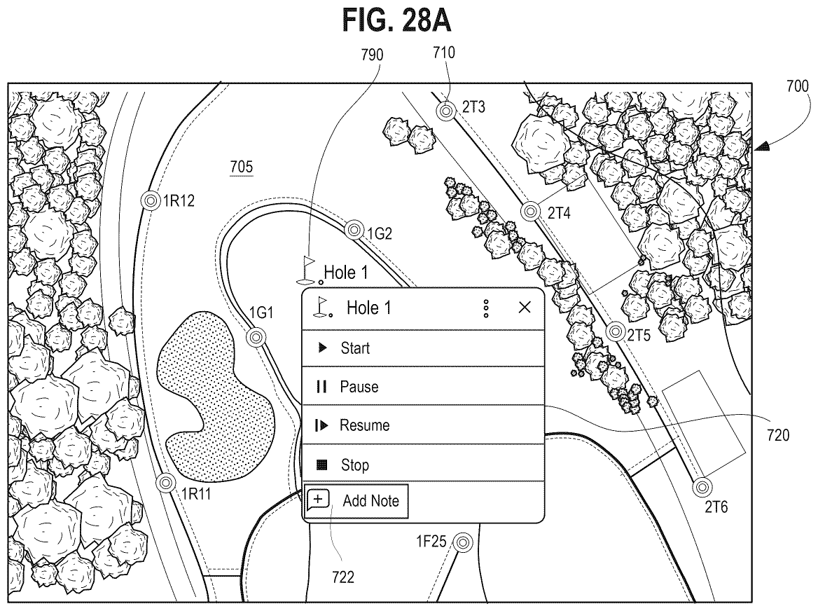

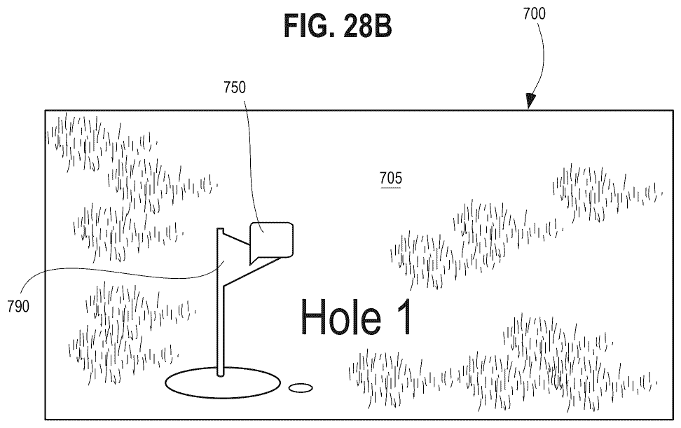

In some embodiments, the user interface 700 permits a user to pin a note 750 to another, more specific, feature on the map 705 that is not a station icon 710 corresponding to an irrigation station. For example, in the embodiment shown in FIG. 28A, the user interface 700 permits the user to create a note 750 and to pin the note 750 to a user-selected hole of a golf course that is visible as a user-selectable feature on the map 705

In the exemplary embodiment shown in FIG. 28A, the user interface 700 permits the user to select (e.g., click on, tap on, etc.) a golf course hole visible on the map 705 (in this example, the golf course hole interacted with by the user is Hole 1). In response to this interaction by the user with icon 790 corresponding to Hole 1, the user interface 700 generates the interactive menu 720 including an add note option 722 as an overlay over a portion of the surface area of Hole 1 (but in this example not overlaying the icon 790 that represents the actual hole and flag inserted into the hole). In some aspects, after the user interacts with (e.g., clicks, taps, etc.) the add note option 722 of the interactive menu 720 shown in FIG. 28A, the irrigation management application 114a causes the user interface 700 to generate an add note feature 730 (akin to the add note feature 730 shown in FIG. 24) overlaid over a portion of the map 705 (not shown in FIG. 28A).

As discussed above in reference to FIG. 24, the add note feature 730 includes a free-form text entry field 732 that permits the user to enter (e.g., by typing text) the text 734 for the note and may include an interactive expiration date field 736 that permits the user to manually enter a date on which the note will expire and disappear from view when the user views the map 705. In the embodiment illustrated in FIG. 28B, after the user saves the note by interacting with the interactive button 738 (see FIG. 24), the resulting note 750 (represented by a flag-like symbol, but may be represented by an envelope-like or another symbol) created by the user is added (e.g., pinned) to the icon 790 representing the hole and flag of Hole 15 by being overlaid or projected at least partially over (but may be adjacent to) the icon 790 that the user interacted with to bring up the interactive menu 720 shown in FIG. 28A. Like other notes, the note 750 can be animated.

In some embodiments, as will be discussed in more detail below, the user interface is configured to permit one or more users to, among other things, edit an existing note to add a reply note to the original note, or to close/delete the note.

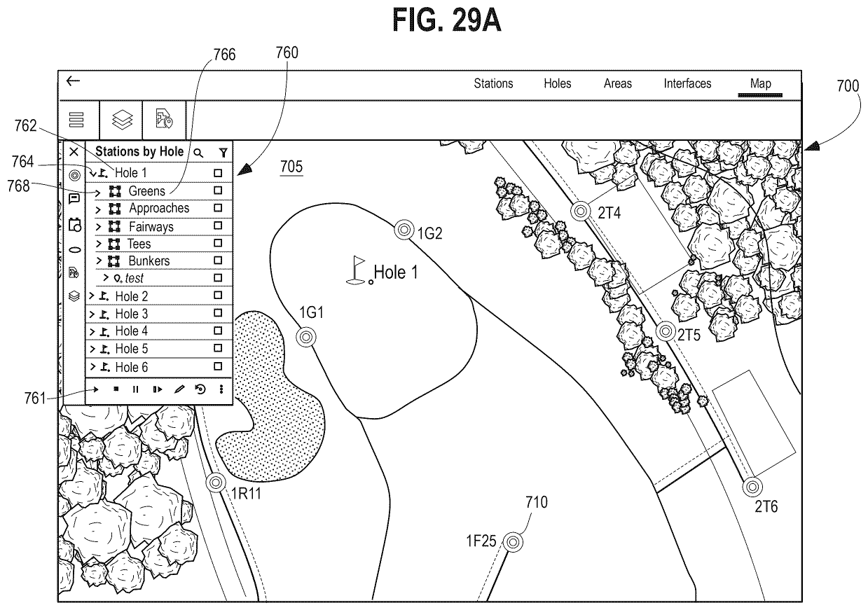

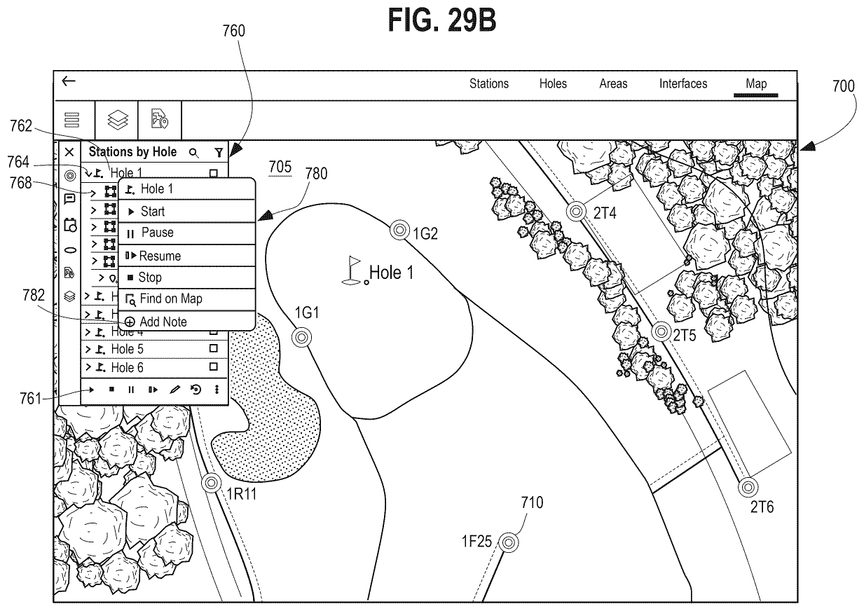

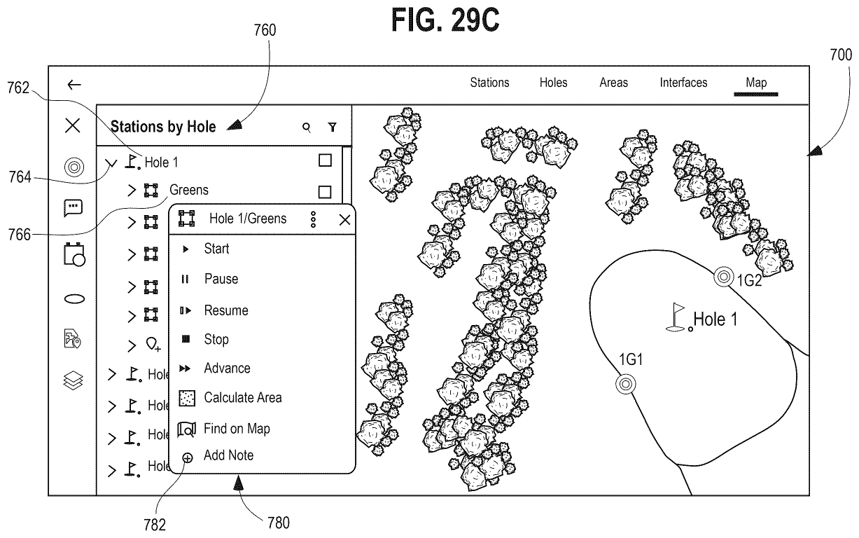

In some embodiments, the irrigation management application 114a permits the user to use a tree view selection menu 760 (instead of interacting with the icon 790 associated with Hole 1 as described above) to create a note 750 and to pin the note 750 to a user-selected hole of a golf course (or to one of the areas of a hole of the golf course) that is visible as a user-selectable feature on the map 705. For example, as shown in FIGS. 29A-29B, the user interface 700 permits the user to add a note to a hole (i.e., Hole 1 in FIG. 29B) of the golf course, which is a feature on the map 705 that is not a single station icon 710 corresponding to an irrigation station, but is instead a feature that is associated with multiple (e.g., two or more) irrigation stations. In addition, as shown in FIG. 29C, the user interface 700 permits the user to add a note to an area (i.e., a Green of Hole 1) which is also a feature on the map 705 that is not a single station icon 710 corresponding to an irrigation station, but is instead a feature that is associated with multiple (e.g., two or more) irrigation stations. Similarly, the user can select another area of the hole to add a note, e.g., greens, approaches, fairways, tees and/or bunkers.

In the embodiment illustrated in FIG. 29A, the user interface 700 includes an interactive tree view selection menu 760 (called “Stations by Hole” in this example), which is a hierarchical listing or tree of expandable/contractable main branches and sub-branches. In some aspects, a user can expand a main branch to reveal a sub-branch and may further expand the sub-branch to reveal another sub-branch, and so on. When viewing any main branch or sub-branch, the user can make a selection of one or more parameters of the branch or sub-branch. In the embodiment illustrated in FIG. 29A, the tree view selection menu 760 further includes various interactive control icons 761 (e.g., Start, Stop, Pause, Resume, Edit, Reselect, etc.) that permit the user to select a control action (e.g., Start) to the irrigation stations located in one of more of the areas of the golf course being controlled by the user via the user interface 700.

The exemplary tree view selection menu 760 of the user interface 700 shown in FIG. 29A is configured to individually list the holes of the golf course (in this example, a listing including holes 1-6 are shown). In the embodiment of FIG. 29A, the exemplary tree view selection menu 760 includes main branches 762 (which, in this example, are Hole 1, Hole 2, Hole 3, Hole 4, Hole 5, and Hole 6), each of which may be expanded by the user by clicking or tapping on branch expansion/contraction arrow 764 associated with each main branch 762 listed in the tree view selection menu 760 to reveal a selectable listing of sub-branch items. In the example illustrated in FIG. 29A, if a user interacts with a branch expansion/contraction arrow 764 associated with a main branch 762 called Hole 1, the tree view selection menu 760 of the user interface 700 expands to provide a view of the sub-branches 766 associated with each area of a hole (e.g., Greens, Approaches, Fairways, Tees, Bunkers, etc.). Notably, in the illustrated embodiment, each sub-branch 766 may also be expanded by the user by clicking or tapping on branch expansion/contraction arrow 768 associated with each sub-branch 766 listed in the tree view selection menu 760 to reveal a selectable listing of further sub-branches (not shown).

In the embodiment illustrated in FIG. 29A, each of the main branches 762 (in this example, Holes 1-6 of a golf course) of the tree view selection menu 760 of the user interface 700 are interactive such that, in response to an interaction (e.g., via a long tap or a right-click of a mouse) by a user with a given main branch 762 (in this example, the main Branch 762 called Hole 1), the user interface 700 generates and displays an interactive sub-menu 780 that overlays portions of the tree view selection menu 760 as shown in FIG. 29B to permit the user to make certain control action selections with respect to the respective main branch 762. In particular, the exemplary interactive sub-menu 780 shown FIG. 29B includes six interactive fields that represent six control action selections (i.e., Start, Pause, Resume, Stop, Find on Map, and Add Note) that the user can make with respect to Hole 1. In some aspects, after the user interacts with (e.g., clicks, taps, etc.) the interactive field 782 called Add Note of the exemplary interactive sub-menu 780, the irrigation management application 114a causes the user interface 700 to generate an add note feature as an overlay over the map 705 (not shown in FIG. 29B) that is akin to the add note feature 730 shown in FIG. 24 and would appear as in FIG. 28B once added.

In the embodiment illustrated in FIG. 29C, each of the sub-branches 766 (in this example, areas including Greens, Approaches, Fairways, Tees, and Bunkers) of the tree view selection menu 760 of the user interface 700 are interactive such that, in response to an interaction (e.g., via a long tap or a right-click of a mouse) by a user with a given sub-branch 766 (in this example, the sub-branch 766 called Greens of the main branch 762 called Hole 1), the user interface 700 generates and displays an interactive sub-menu 780 that overlays portions of the tree view selection menu 760 as shown in FIG. 29C to permit the user to make certain control action selections with respect to the respective sub-branch 766. In particular, the exemplary interactive sub-menu 780 shown FIG. 29C includes eight interactive fields that represent eight control action selections (i.e., Start, Pause, Resume, Stop, Advance, Calculate Area, Find on Map, and Add Note) that the user can make with respect to the Green of Hole 1. In some aspects, after the user interacts with (e.g., clicks, taps, etc.) the interactive field 782 called Add Note of the exemplary interactive sub-menu 780, the irrigation management application 114a causes the user interface 700 to generate an add note feature as an overlay over the map 705 (not shown in FIG. 29C) that is akin to the add note feature 730 shown in FIG. 24 and could be displayed similar to the note of FIG. 28B once added but would be added in the area defining the Greens of Hole 1.

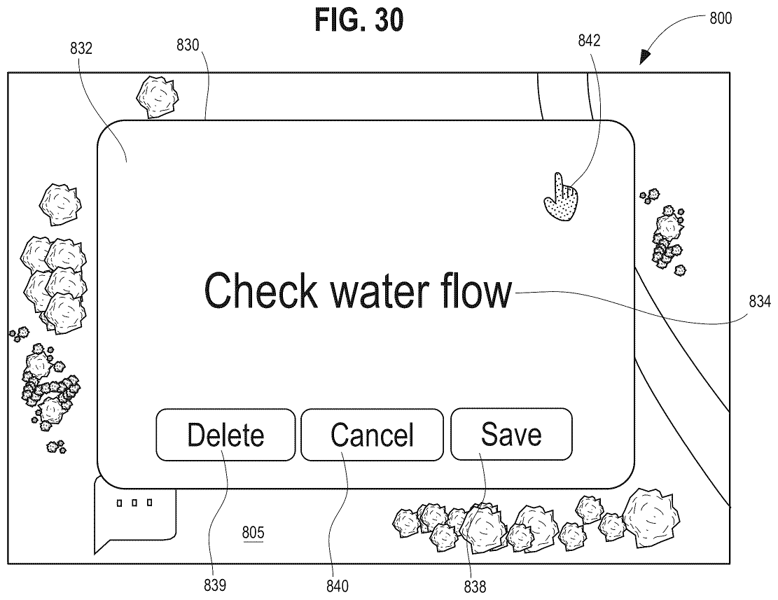

In the embodiment shown in FIG. 30, the irrigation management application 114a may cause the user interface 800 to generate an add note feature 830 overlaid over a portion of the map 705. In the illustrated embodiment, the add note feature 830 includes a free-form text entry field 832 that permits the user to enter (e.g., by typing text) the text 834 for the note. Also in the illustrated embodiment, the add note feature 830 includes a badge 842 that can indicate the specific user (e.g., by person, by category (admin, manager, groundskeeper, etc.)) who is creating the note by typing in the text 834 (which, in this example, is “Check water flow”), the status of the note, when the note indicates an action is needed, and so on. In the illustrated embodiment, the badge 842 is shown in a color (in FIG. 30, the exemplary badge 842 is illustrated as a hand having an extended index finger and having stippling to reflect that the badge 842 has is of a certain color) indicating who created the note (but the indication of who created the note may be shown in a way other than color (e.g., the name of the person may pop up when a cursor hovers over the badge 842)). In some embodiments, when the note created by this user is displayed on the map 805, the note would visibly reflect the badge 842 to associate the created note displayed on the map 805 with the user who created the note.

Also in FIG. 30, the add note feature 830 includes an interactive button or icon 838 called “Save” (but may be called, for example, “Save Note”) which permits the user to save the note created using the add note feature 830, an interactive button or icon 840 called “Cancel,” which permits the user to cancel the creation of the note, and an interactive button or icon 839 called “Delete,” which permits the user to delete the text 834 typed into the free-form text entry field 832.

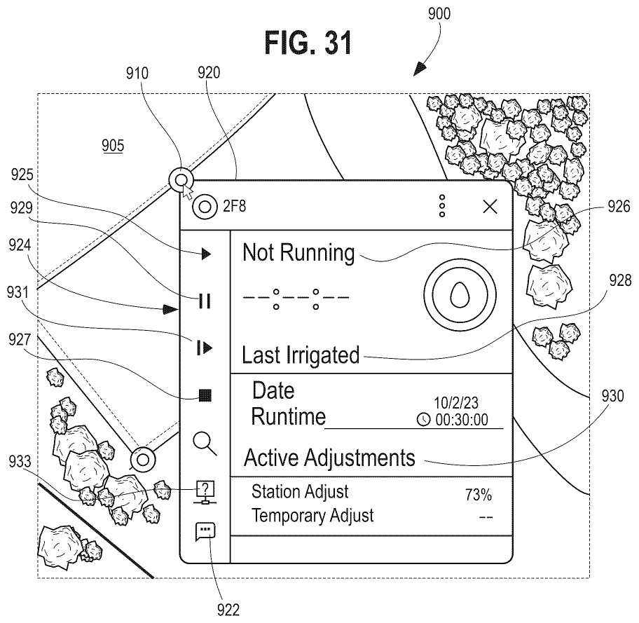

As discussed above, the interface 700 permits a user to create a note 750 and pin the note 750 to a station icon 710 that is visible as a feature on the map 705. Similarly, in FIG. 31, the user interface 900 permits the user to tap or click (this may be, for example, a longer than usual tap or a right-mouse click) a specific station icon 910 visible on the map 905 (in this example, the station icon 910 corresponding to irrigation station 2F8). In response to this interaction by the user with the station icon 910, the user interface 700 generates an interactive menu 920 overlaid over a portion of the map 905 that, unlike the interactive menu 720 shown in FIG. 26, includes a control panel 924 (that includes various control selections that permit the user to, for example, start irrigation by station 2F8 (icon 925), stop irrigation by station 2F8 (icon 927), pause irrigation by station 2F8 (icon 929), resume irrigation by station 2F8 (icon 931), run diagnostics on irrigation station 2F8 (icon 933), and create a note (icon 922) in association with irrigation station 2F8).

In the embodiment illustrated in FIG. 31, the exemplary interactive menu 920 further includes several informational fields that provide information relating to operation and/or operational parameters of the irrigation station 2F8. In this example, the interactive menu 920 includes an informational field 926 that provides the user with information regarding whether the irrigation station 2F8 is running or not (in this example, irrigation station 2F8 is not running); an informational field 928 that provides the user with information regarding the last time the irrigation station 2F8 last irrigated (in this example, irrigation station 2F8 irrigated on Oct. 23, 2023 for 30 minutes); and an informational field 930 that provides the user with information regarding the active runtime adjustments that have been preset for the irrigation station 2F8 (in this example, the runtime of the irrigation station 2F8 is adjusted to 73% of its normal irrigation runtime). In will be appreciated that the control selections and informational fields shown in FIG. 31 are shown by way of example only, and that the interactive menu 920 may include additional or alternative control selections and/or informational fields.

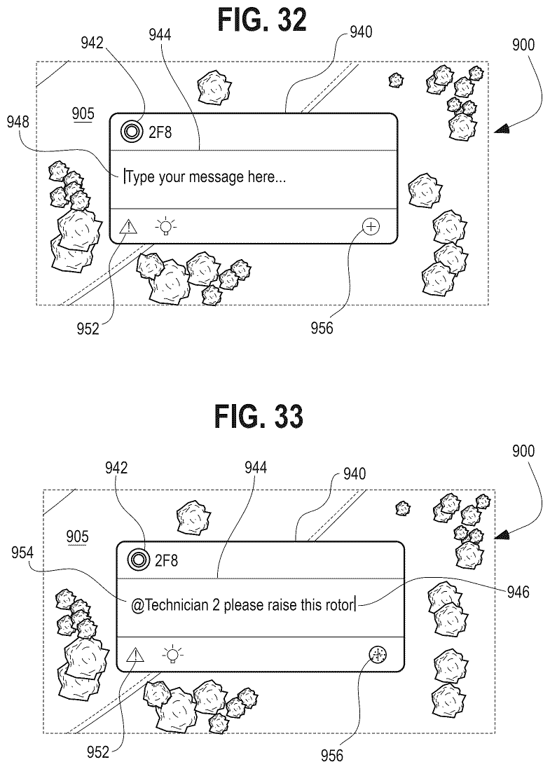

In some aspects, after the user interacts with (e.g., clicks, taps, etc.) the icon 922 representing the add note option of the control panel 924 of the interactive menu 920 shown in FIG. 31, the irrigation management application 114a causes the user interface 900 to generate an add note feature 940 overlaid over a portion of the map 905 and over the station icon 910 that the user interacted with. The exemplary add note feature 940 shown in FIG. 32 includes an informational field 942 that indicates the identifier (in this example, 2F8) of the irrigation station corresponding to the station icon 910 the user interacted with to bring up the interactive menu 920. In addition, the add note feature 940 includes a free-form text entry field 944 that permits the user to enter (e.g., by typing text) the text 946 for the note. In the example shown in FIG. 32, the free-form text entry field 944 provides an informational message 948 to the user (i.e., “Type your message here”) to notify the user that the user may enter text into the free-form text entry field 944. In some aspects, the free-form text entry field 944 of the user interface 900 permits the user to add a mention to specifically tag or reference another user (this mention is depicted by way of the “@” symbol 954 in the exemplary note text 946 shown in FIG. 33. Also, the exemplary add note feature 940 in FIG. 33 includes an interactive icon 952 that permits the user to mark the note as urgent (in this example, the interactive icon 952 is depicted as a triangle that encloses an exclamation sign).

In the embodiment illustrated in FIG. 33, after the user types in the text 946 of the note into the free-form text entry field 944 (in this example, the text being “@Technician 2 please raise this rotor”), the add note feature 940 displays the interactive icon 956 (which is the icon that the user would press to cause the note to be added/pinned to the map 905) in a way that is different (e.g., different color, highlighting, etc.) and more emphasized in comparison to the way the interactive icon 956 is displayed in FIG. 32 to bring the user's attention to the interactive icon 956. After the user saves the note by interacting with the interactive button or icon 956, the resulting note is added (e.g., pinned) to the station icon 910 associated with irrigation station 2F8 on the map 705 by being overlaid or projected at least partially over (or adjacent to) the station icon 910 that the user interacted with to bring up the interactive menu 920 shown in FIG. 31. While the map 905 is not shown with a note being pinned to the station icon 910 associated with irrigation station 2F8, the created note would be displayed within the user interface 900 akin to the way the note 750 is pinned to the station icon 710 associated with irrigation station 2T5 within the user interface 700 as shown in FIG. 27.

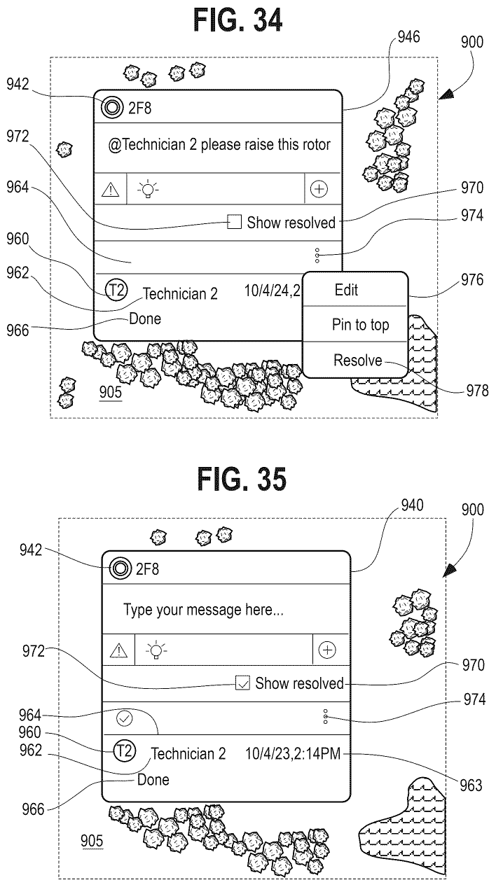

In some embodiments, the add note feature 940 overlaying the map 905 permits a second user, i.e., a user that did not create the note initially, to open a note created by a first user, and to respond to the note by entering another note. In the Example shown in FIG. 34, the add note feature 940 shows the identifier (in this example, 2F8) of the irrigation station corresponding to the station icon 910 with which the note shown in FIG. 33 was associated. In addition, the add note feature 940 includes a first free-form text entry field 944 that displays the text 946 of the note created by the first user (i.e., “@Technician 2 please raise this rotor”). The add note feature 940 in FIG. 34 also includes a second free-form text entry field 964 displaying the text 966 of the note created by the second user (i.e., “Done”) in response to the note created by the first user.

In this embodiment, the add note feature 940 overlaying the map 905 includes both an icon 960 showing an avatar (in this example, “T2”) and an informational field 962 indicating the name of the second user (in this example, “Technician 2”), but it will be appreciated that only the avatar or only the name of the second user may be displayed instead. In addition, the add note feature 940 includes an informational field 963 that indicates the date and time (in this example, “Oct. 4, 2024, 2:14 PM”) when the note was added by the second user. In the embodiment illustrated in FIG. 34, the add note feature 940 further includes an informational field 970 (called “Show resolved” in this example) that permits a user to indicate whether an issue raised by the note has been resolved.

In particular, when the exemplary box 972 of the informational field 970 includes a check mark, this indicates that the issue raised by the note has been resolved, but when the exemplary box 972 of the informational field 970 does not include a check mark, this indicates that the issue raised by the note has not been resolved. In some embodiments, after the second user (in this example, Technician 2) addresses the issue raised in the note created by the first user, i.e., by raising the rotor of irrigation station 2F8 and creates a responsive note “Done” using the add note feature 940, the add note feature 940 further permits the second user to mark the box 972 of the informational field 970 with a check mark as shown in FIG. 35 to indicate that the issue has been resolved. In the illustrated embodiment, the add note feature 940 includes an interactive icon 974 (represented in this example by three vertically aligned dots), which, when interacted with by the second user, generates an interactive sub-menu 976, which includes a user-selectable field 978 that, when selected (e.g., clicked, tapped, etc.) by the second user, causes the check mark to appear within the box 972 of the informational field 970.

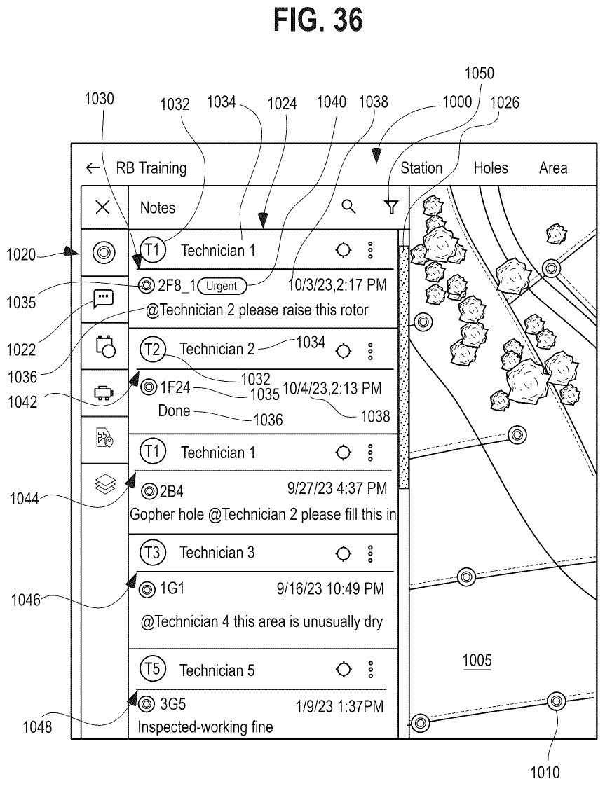

FIG. 36 illustrates an exemplary user interface 1000 that displays a map 1005 of an irrigation area including irrigation stations, which are represented on the map 1005 as station icons 1010. In the embodiment illustrated in FIG. 36, the user interface 1000 includes an interactive control panel 1020 (including various control and informational selections, one of which is an interactive icon 1022 that, when interacted with by a user, brings up a listing of notes previously created by users. In some aspects, after the user interacts with (e.g., clicks, taps, etc.) the interactive icon 1022 of the interactive control panel 1020, the irrigation management application 114a causes the user interface 900 to generate a menu 1024 that is overlaid over a portion of the map 1005 and that includes a listing of user-generated notes. The menu 1024 may include a scroll indicator 1026 that enables the user to scroll down to view additional notes that are not visible in the view depicted in FIG. 36.

In the view depicted in FIG. 36, the menu 1024 visibly lists 5 notes, four of which have been added by Technician 1 and one of which has been added by Technician 2. In particular, the first note 1030 listed in the menu 1024 includes an icon 1032 showing an avatar (in this example, “T1”) and an informational field 1034 indicating the name of the user who created the first note 1030 (in this example, “Technician 1”). In addition, the first note 1030 includes an informational field 1035 that indicates the identifier (in this example, 2F8) of the irrigation station with respect to which the first note 1030 was created, as well as an informational field 1038 that indicates the date and time (in this example, “Oct. 3, 2024, 2:17 PM”) when the first note 1030 was created. In addition, the first note 1030 includes an informational field 1040 (called “Urgent” in this example) that appears within the menu 1024 to indicate to users of the user interface 1000 that the text 1036 of the first note 1030 is urgent (i.e., present an issue that needs to be urgently addressed/remedied).

The second exemplary note 1042 listed in the menu 1024 also includes an icon 1032 showing an avatar (in this example, “T2”) and an informational field 1034 indicating the name of the user who created the second note 1042 (in this example, “Technician 2”). In addition, the second note 1042 also includes an informational field 1035 that indicates the identifier (in this example, 2F8) of the irrigation station with respect to which the second note 1042 was created, as well as an informational field 1038 that indicates the date and time (in this example, “Oct. 4, 2024, 2:13 PM”) when the second note 1042 was created. In addition, the text 1036 of the second note 1042 (i.e., “Done”) indicates that Technician 2 has addressed the urgent issue (regarding the rotor of irrigation station 2F8) raised by Technician 1 in the first note 1030.

In the example shown in FIG. 36, a user viewing the user interface 1000 would also see by observing the menu 1024 listing the user-created notes that: the third note 1044 listed in the menu 1024 has been made by Technician 1 at 4:37 PM on Sep. 27, 2023 with respect to irrigation station with an identifier 2B4 and states “Gopher hole @Technician 2 please fill this in;” the fourth note 1046 listed in the menu 1024 was made Technician 3 at 10:49 PM on Sep. 16, 2023 with respect to irrigation station with an identifier 1G1 and states “@Technician 4 this area is unusually dry;” and the fifth note 1048 listed in the menu 1024 was made Technician 5 at 1:37 PM on Jan. 9, 2023 with respect to irrigation station with an identifier 3G5 and states “inspected-working fine.” Of course, while only five user-created notes are visible in FIG. 36 within the menu 1024, it will be appreciated that the user interface 1000 may permit a user to use the scroll indicator 1026 to scroll through dozens, hundreds, or even thousands of user created notes.

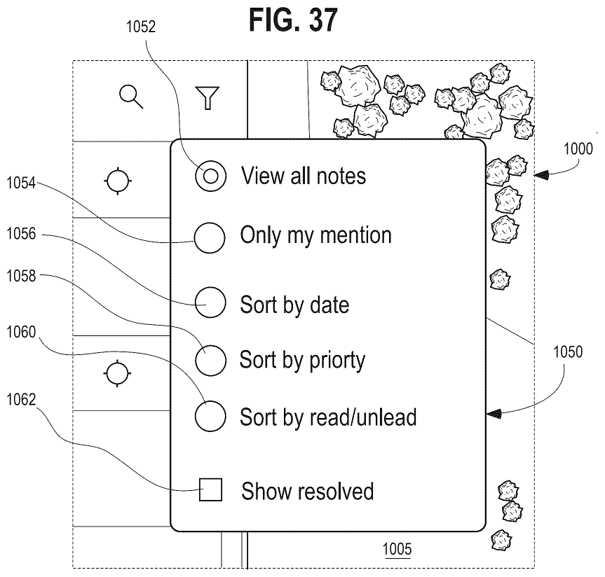

To that end, the user interface 1000 may include a filtering/sorting menu 1050 that overlays a portion of the map 1005 and that permits a user to select options with respect to which user-created notes should be listed within the menu 1024. The exemplary filtering/sorting menu 1050 depicted in FIG. 37 includes a first exemplary sorting option called “View all notes” associated with an interactive radial button 1052 that, when selected by the user (as shown in FIG. 37), would cause all user-created notes to be listed within the menu 1024. The filtering/sorting menu 1050 further includes a second exemplary sorting option called “Only my mention” (filter by mention) associated with an interactive radial button 1054 that, when selected by the user (not shown in FIG. 37), would cause only user-created notes that mention (by name) the user using the filtering/sorting menu 1050 to be listed within the menu 1024. The filtering/sorting menu 1050 further includes a third exemplary sorting option called “Sort by date” associated with an interactive radial button 1056 that, when selected by the user (not shown in FIG. 37), would cause the user-created notes to be listed within the menu 1024 by date (with the most recent notes being listed first or with the oldest notes being listed first). The filtering/sorting menu 1050 further includes a fourth exemplary sorting option called “Sort by priority” associated with an interactive radial button 1058 that, when selected by the user (not shown in FIG. 37), would cause the user-created notes to be listed within the menu 1024 by their priority status (with the notes having the highest priority being listed first or with the notes having the lowest priority being listed first).

The filtering/sorting menu 1050 further includes a fifth exemplary sorting option called “Sort by read/unread” associated with an interactive radial button 1060 that, when selected by the user (not shown in FIG. 37), would cause the user-created notes to be listed within the menu 1024 by whether they are read or unread (with the unread notes being listed first or with the read notes being listed first). Finally, the filtering/sorting menu 1050 further includes a sixth exemplary sorting option called “Show resolved” associated with an interactive radial button 1062 that, when selected by the user (not shown in FIG. 37), would cause only user-created notes that have been marked by users as “Resolved” to be listed within the menu 1024. It will be appreciated that the six sorting options are shown in FIG. 37 by way of example only, and that the menu 1050 may include additional or alternative sorting/filtering options.

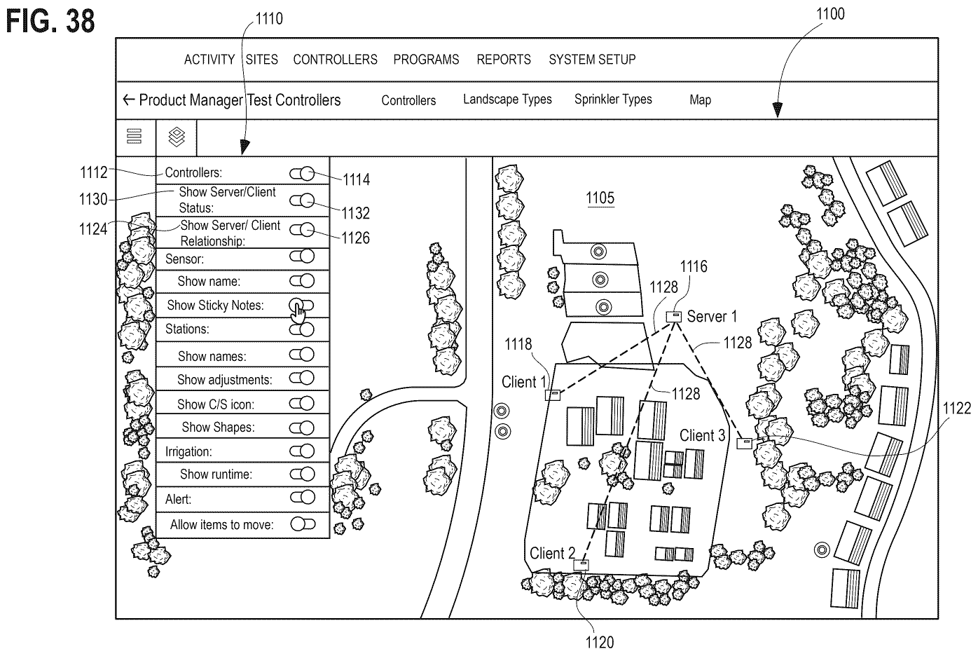

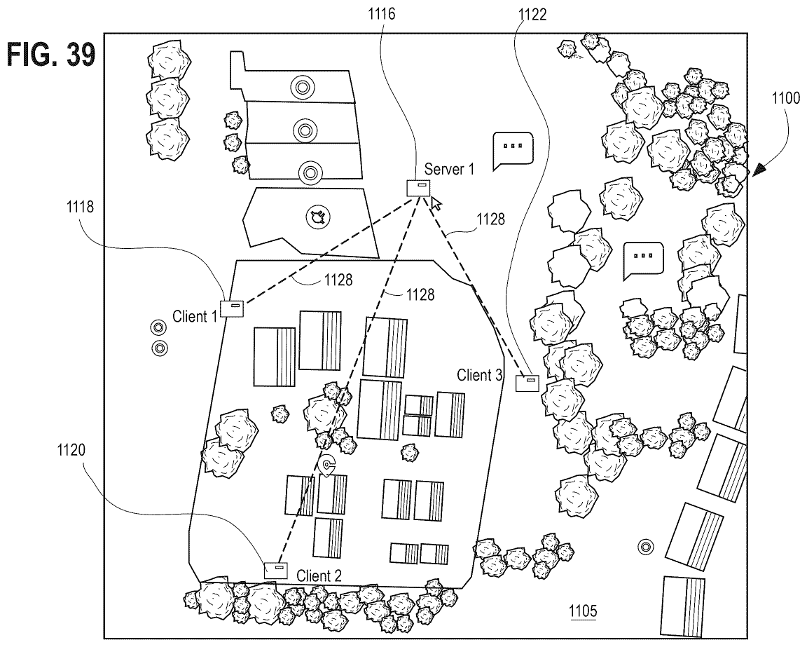

FIG. 38 illustrates a user interface 1100 in accordance with some embodiments that permits a user to view control and/or connection relationships between various components of the irrigation system 116 while viewing a map 1105 of the irrigation area. In the embodiment shown in FIG. 38, the user interface 1100 includes an exemplary layer menu 1110 that overlies a portion of the map 1105 and lists various interactive fields that control which layers may be made visible or not visible on the map 1105. In the illustrated embodiment, the layer menu 1110 includes an interactive field 1112 (called “Controllers” in this example), which enables the user to see irrigation control components of the irrigation system 116.

As illustrated, the interactive field 1112 includes an interactive icon/button 1114, which, when toggled to the right-most position (as shown in FIG. 38), causes the irrigation control components of the irrigation system 116 to be visible as being superimposed over the map layer that provides the map 1105, but when toggled to the left-most position (not shown in FIG. 38), causes the irrigation control components of the irrigation system 116 to be not visible as being superimposed over the map layer that provides the map 1105. In the illustrated example, with the interactive icon/button 1114 being set to the right-most position, the irrigation management application 114a causes the user interface 1100 to display a layer including four irrigation control components 1116, 1118, 1120, and 1122 as an overlay over the map 1105. In particular, the first irrigation control component 1116 is named Server 1, the second irrigation control component 1118 is named Client 1, the third irrigation control component 1120 is named Client 2, and the fourth irrigation control component 1122 is named Client 3.

Also in FIG. 38, the layer menu 1110 includes an interactive field 1124 (called “Show Server/Client Relationship”), which enables the user to visually see an operational control relationship between the servers and clients of the layer overlaid over the map 1105. As illustrated, the interactive field 1112 includes an interactive icon/button 1126, which, when toggled to the right-most position (as shown in FIG. 38), causes control connection indicators 1128 to be visible as being superimposed over the map layer that provides the map 1105, but when toggled to the left-most position (not shown in FIG. 38), causes the control connection indicators 1128 to not be visible as being superimposed over the map layer that provides the map 1105. The control connection indicators 1128 visible as an overlay over the map 1105 are illustrated in FIG. 38 as dashed lines (with one dashed line interconnecting Server 1 and Client 1, another dashed line interconnecting Server 1 and Client 2, and another dashed line interconnecting Server 1 and Client 3), but they may be depicted as solid lines, and may be lines of different colors instead of being black dashed lines as depicted in FIG. 38.

Notably, the interactive icon/button 1126 and any of the other interactive icons/buttons associated with interactive fields depicted by way of example in the layer menu 1110 (i.e., Sensor, Show Name, Show Sticky Notes, Stations, Show names, Show adjustments, Show C/S icon, Show Shapes, Irrigation, Show runtime, Alert, and Allow items to move) may be color coded such that a layer associated with such interactive fields, when enabled by their respective interactive icons to be visible as an overlay over the map 1105, maybe displayed in a preselected color to permit the user to easily distinguish between the layers displayed as an overlay over the map 1105, since each layer is depicted in a unique color.

FIG. 39 shows an enlarged view of the Server/Client connection relationship depicted by control connection indicators 1128 overlaid over the map 1105 and illustrating that the exemplary server satellite controller Server 1 (irrigation control component 1116) has a supervisory control relationship with each of satellite controllers Client 1 (irrigation control component 1118), Client 2 (irrigation control component 1120), and Client 3 (irrigation control component 1122). Generally speaking, while the relationship information between the irrigation control components 1116, 1118, 1120, and 1122 may be determined by the user by looking through other menus of the irrigation management application 114a, the exemplary user interface 1100 shown in FIGS. 38-39 permits the user to easily see this relationship information directly on the map 1105, which may advantageously decrease time needed for the user to understand the relationships between the irrigation control components of the irrigation system 116 and help with troubleshooting.

Also in FIG. 38, the layer menu 1110 includes an interactive field 1130 (called “Show Server/Client Status”), which enables the user to visually see the status of the connection between the servers and clients of the layer overlaid over the map 1105. As illustrated, the interactive field 1130 includes an interactive icon/button 1132, which, when toggled to the right-most position (as shown in FIG. 38), causes the control connection indicators 1128 to be visible as being superimposed over the map 1105 in a color that visually indicates the current connection status between a server and a client, but when toggled to the left-most position (not shown in FIG. 38), causes the control connection indicators 1128 to not be visible a color that visually indicates the current connection status between a server and a client.

With the Show Server/Client Status option enabled (i.e., the interactive icon/button 1132 is at its right-most position), all three control connection indicators 1128 visible in FIG. 38 are shown in an identical color (which, for purposes of this description, reflects that the connection between Server 1 and Client 1 and the connection between Server 1 and Client 2 and the connection between Server 1 and Client 3 are all active. In some aspects, if a connection between two (e.g., 1116 and 1118) of the irrigation control components 1116, 1118, 1120, and 1122 is down or is in an error state, a control connection indicator 1128 interconnecting such the irrigation control component 1116 and the irrigation control component 1118 may be shown in a color (e.g., red) that visually indicates a problem in the status of the connection between the irrigation control component 1116 and the irrigation control component 1118.

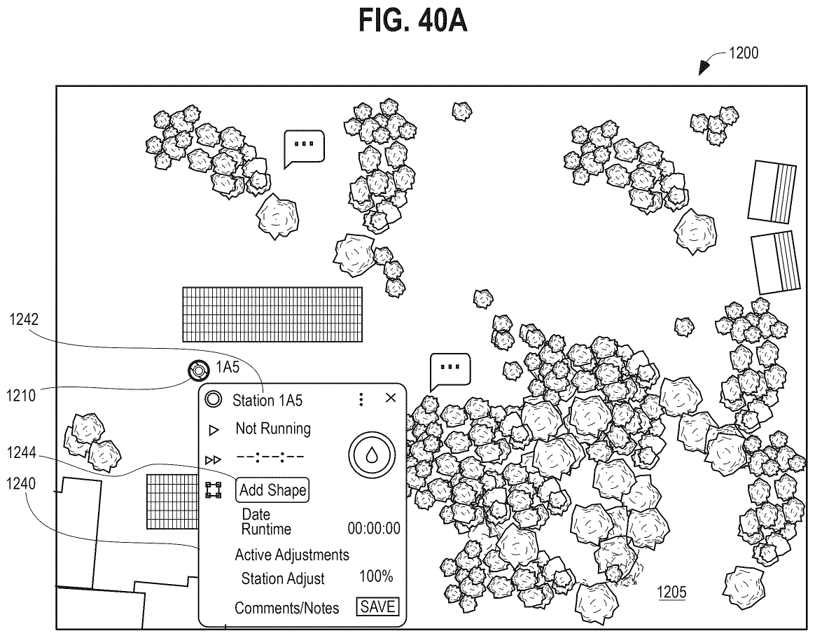

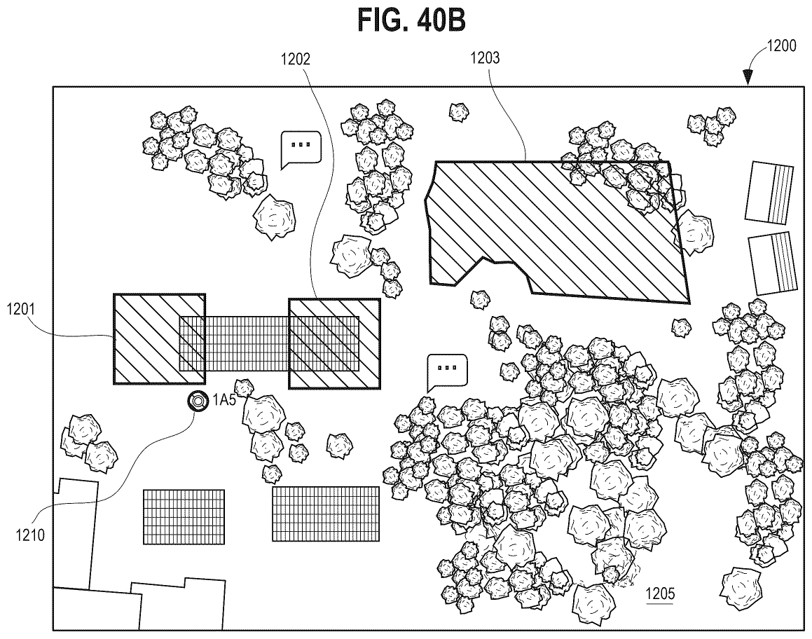

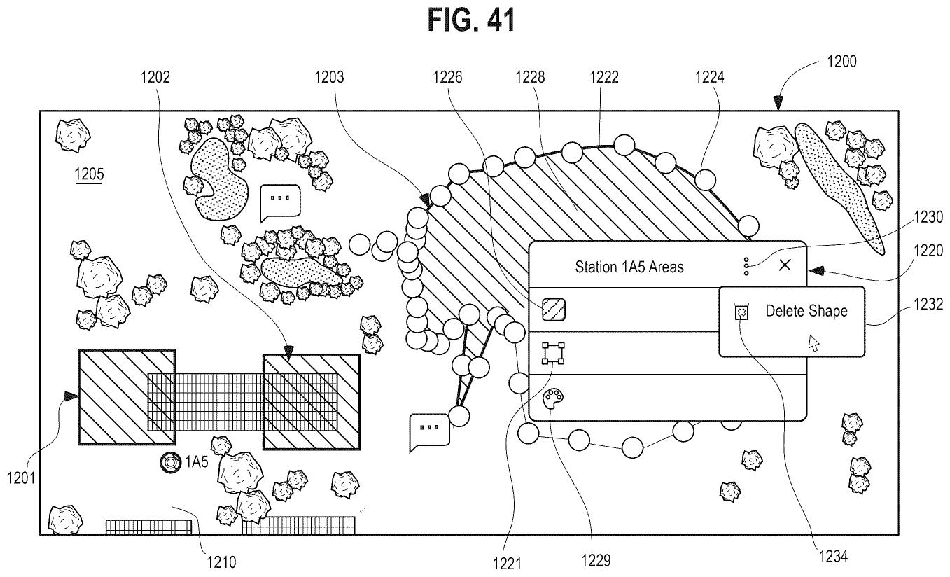

FIGS. 40A and 40B illustrate a user interface 1200 in accordance with some embodiments that permit the user to add a polygon shape (e.g., 1201, 1202, and 1203) to the map 1205, the polygon shapes being associated with one or more irrigation stations (e.g., station with an identifier 1A5) located in the irrigation area depicted on the map 1205. In some embodiments, in response to a user selecting (e.g., clicking on, tapping, etc.) the station icon 1210 (corresponding to the irrigation station 1A5) on the map 1205, the user interface 1200 generates an interactive menu 1240 overlaying a portion of the map 1205 as shown in FIG. 40A. The interactive menu 1240 includes an informational field 1242 indicating the name of the irrigation station (in this example, station 1A5) that is associated with this interactive menu 1240. In addition, in the illustrated embodiment, the interactive menu 1240 includes an interactive button or icon 1244 (called “Add Shape” in this example). In some aspects, in response to the user interacting with (e.g., clicking on, tapping, etc.) the interactive button or icon 1244 of the interactive menu 1240, the user interface 1200 is caused to generate a polygon as an overlay over a portion of the map 1205. Examples of polygons 1201, 1202, and 1203 overlaid over portions of the map 1205 are shown in FIGS. 40B and 41, which are discussed in more detail below.

FIG. 40B illustrates a user interface 1200 in accordance with some embodiments that permit the user to add a polygon shape (e.g., 1201, 1202, and 1203) to the map 1205, the polygon shapes being associated with one or more irrigation stations (e.g., station with an identifier 1A5) located in the irrigation area depicted on the map 1205. In some embodiments, polygons 1201, 1202, and 1203 may be dragged and dropped to the map 1205 from a menu of the user interface 1200, or may be generated as an overlay over the map 1205 in response to a user selecting an add polygon option in a menu of the user interface 1200. In the embodiment shown in FIG. 40B, polygon 1201 and polygon 1202 are initially generic square-shaped polygons, while the polygon 1203 as shown as a uniquely-shaped polygon that was created by the user by manipulating a generic square-shaped polygon that initially appeared as an overlay over the map 1205. In other words, the user interface 1200 permits the user, if the user so chooses, to edit the overall shape of any one of the polygons 1201, 1202, and 1203 to conform them to a particular area of the map 1205 that does not have a standard geometric shape.

FIG. 41 shows an example of how the user can edit the shape of the polygon 1203 using an exemplary a polygon add feature or polygon edit menu 1220. In the illustrated embodiment, the polygon add menu 1220 includes an interactive icon 1221, which, when interacted with by the user, causes the polygon 1203 to be displayed such that the perimeter of the polygon 1203 is defined by lines 1222 having a plurality of points 1224 (which may be circle-shaped as shown, square-shaped, etc.). In the illustrated embodiment, the user interface 1200 permits the user to individually select and move each of the points 1224 to move various segments of the perimeter of the polygon 1203 to change the overall size and/or shape of the polygon 1203. In certain aspects, some movements of certain points 1224 may cause the user interface 1200 to generate and display new points 1224 as overlays over the map 1205 between existing points 1224 overlaying the map 1205.

In the illustrated embodiment, the polygon add menu 1220 includes an interactive icon 1226, which, when interacted with by the user, permits the user to select and add a fill color 1228 to the polygon 1203 (in the example shown in FIG. 41, the polygons 1201, 1202, and 1203 are filled in with an identical color, but the polygons 1201, 1202, and 1203 may each have their own unique color). In the illustrated embodiment, the polygon add menu 1220 further includes an interactive icon 1229, which, when interacted with by the user, permits the user to create (e.g., draw) a custom-shape polygon using a free-form drawing tool. In the illustrated embodiment, the polygon add menu 1220 further includes an interactive icon 1230 (represented in this example by three vertically aligned dots), which, when interacted with by the user, generates an interactive sub-menu 1232, which includes a user-selectable field 1234 that, when selected (e.g., clicked, tapped, etc.) by the user (e.g., in case that the user decided to not add the polygon 1203 as an overlay over the map 1205), permits the user to delete the polygon 1203 from the map 1205.

FIG. 41 also shows that the polygons 1201, 1202, 1203 being associated with one or more irrigation stations in the irrigation area depicted on the map 1205. In the example illustrated in FIG. 41, the areas in the polygons are associated with station 1A5 (associated with the station icon 1210 shown in FIG. 41 as an overlay on the map 1205), and the areas on the map 1205 covered by polygons 1201, 1202, 1203 indicate the areas of the map 1205 that are irrigated when station 1A5 is on. As shown in the exemplary user interface 1200 depicted in FIG. 41, the station 1A5 can be annotated with a color (which may be in the form of a ring encircling the station 1A5) matching that of the fill color of the polygons 1201, 1202, 1203. In other words, in some embodiments, the user interface 1200 permits the user to visually see the polygons (in this example, all three of the polygons 1201, 1202, 1203) and thus the positions/areas of the map 1205 that are associated with a given station (in this example, 1A5).

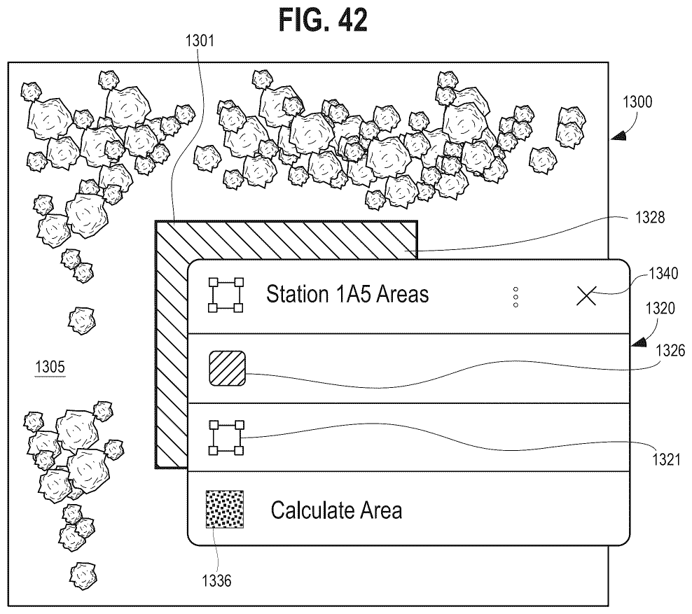

FIG. 42 illustrates a user interface 1300 in accordance with some embodiments that permits the user to select a polygon 1301 displayed on the map, and to calculate the interior area of the polygon 1301. In some aspects, the user interface 1300 permits the user to select the polygon by interacting (e.g., right clicking, long tapping, etc.) on the polygon 1301, in response to which the irrigation management application 114a causes the user interface 1300 to generate a menu 1320 as an overlay over a portion of the map 1205 and over a portion of the polygon 1301.

In the illustrated embodiment, the exemplary menu 1320 includes an interactive icon 1326, which, when interacted with by the user, permits the user to select and add a fill color 1328 to the polygon 1301. In the illustrated embodiment, the polygon add menu 1220 further includes an interactive icon 1321 (akin to the interactive icon 1221 of FIG. 41), which, when interacted with by the user, permits the user to adjust the overall shape of the polygon 1301. In the illustrated embodiment, the menu 1320 further includes an interactive icon 1340 (represented in this example by an X symbol), which, when interacted with by the user, closes the menu 1320.

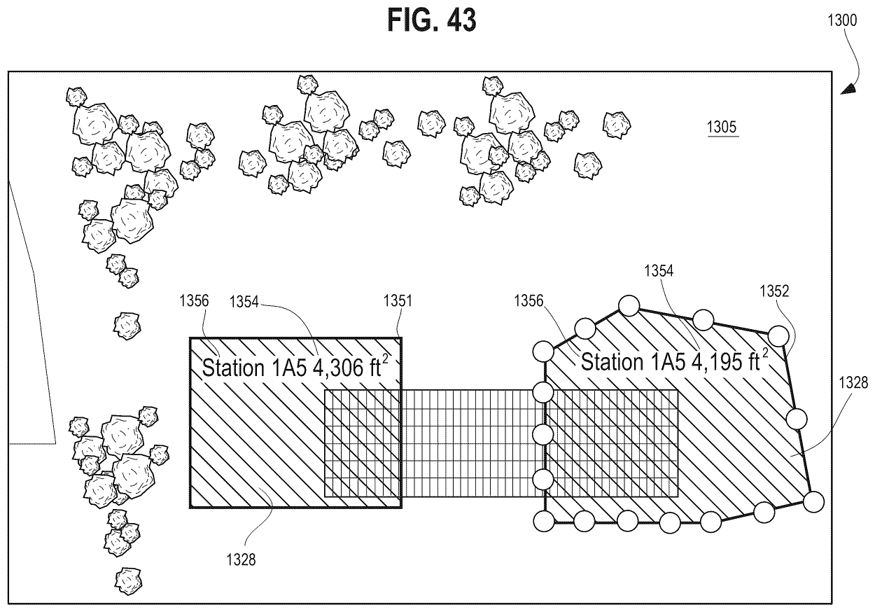

In addition, the exemplary menu 1320 includes an interactive icon 1336, which, when interacted with by the user, causes the irrigation management application 114a to calculate the area contained within the polygon 1301 and displays the calculated area within the polygon as a numerical value 1354, as shown in FIG. 43. For example, FIG. 43 shows two polygons 1351 and 1352, the areas of which have been previously calculated, with the area of polygon 1351 having been calculated to be 4,306 ft² and the area of polygon 1352 having been calculated to be 7,195 ft². Notably, while the numerical value 1354 representing the calculated area of each of the polygons 1351, 1352 is represented inside of the polygons 1351, 1352, it will be appreciated that this numerical value 1354 may be displayed within the user interface 1300 as an overlay over the map 1305 adjacent a respective one of the polygons 1351, 1352. In the illustrated embodiment, the station (in this example, 1A5) associated with each polygon 1351, 1352 is displayed for the user to see in the informational field 1356 located alongside the numerical value 1354 (but may be displayed in a different location relative to the numerical value 1354. In the example shown in FIG. 43, this tells the user that the area defined by this polygon (e.g., polygon 1351 or polygon 1352) is associated with station 1A5. In some embodiments, the numerical value 1354 representing the calculated area of each of the polygons 1351, 1352 appears inside of the polygons 1351, 1352 as shown in FIG. 43 for a predetermined time (e.g., 5 seconds, 10 seconds, etc.) after the area of a polygon 1351, 1352 is calculated, after which the numerical value 1354 disappears from view. In certain aspects, when a user positions a cursor or taps one of the polygons 1351, 1352 not having the numerical value 1354 representing the calculated area displayed, the user interface 1300 is caused to again display the numerical value 1354 inside of a respective one of the polygons 1351, 1352, or as an overlay over the map 1305 adjacent a respective one of the polygons 1351, 1352.

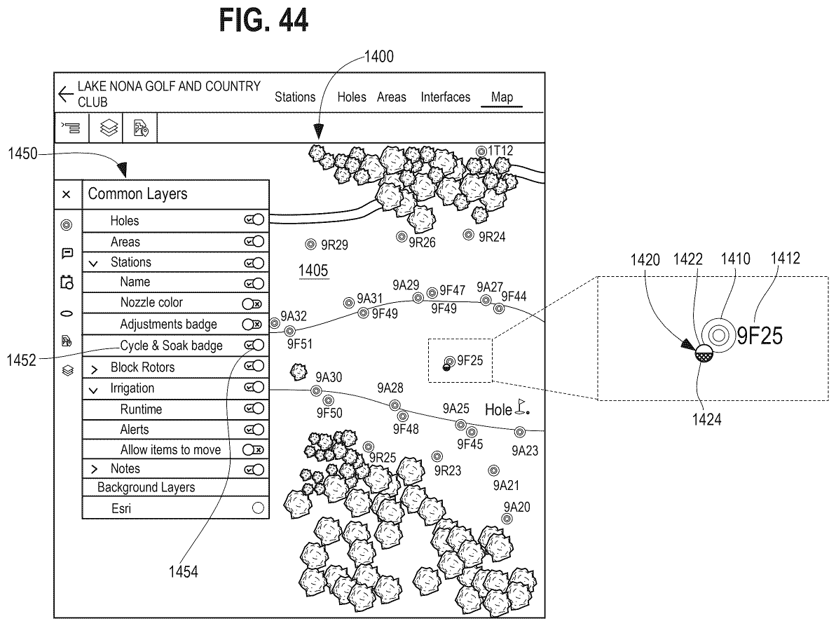

FIG. 44 illustrates a user interface 1400 in accordance with some embodiments that provides data indicators and/or operation mode indicators that are associated with irrigation stations. In the embodiment illustrated in FIG. 44, the user interface 1400 displays a map 1405 of an irrigation area with a station icon 1410 (corresponding to an irrigation station identifier 1412 that is labeled 9F25, which, in the context of an irrigation area including a golf course, may represent Hole 9, Fairway, Irrigation Station No. 25).

Also in FIG. 44, the user interface 1400 includes an operation mode indicator 1420 in association with the station icon 1410. In the illustrated embodiment, the exemplary operation mode indicator 1420 is a cycle and soak indicator associated with the exemplary irrigation station 9F25. The operation mode indicator 1420 is shown in FIG. 44 as circle-shaped icon that partly overlies the circle-shaped station icon 1410, but it will be appreciated that the operation mode indicator 1420 may be of another geometric shape, or may have an irregular shape, and that the operation mode indicator 1420 may be positioned adjacent the station icon 1410 such that the operation mode indicator 1420 does not overlie any portion of the station icon 1410.

In the example shown in FIG. 44, the operation mode indicator 1420 associated with the station icon 1410 associated with irrigation station 9F25 informs a user interacting with the user interface 1400 that irrigation station 9F25 will irrigate using a cycle and soak pattern, i.e., it will cycle on and off to allow watering to soak instead of running off (which may be a more efficient mode of operation, for example, when the landscape irrigated by the irrigation station 9F25 is on a slope). In the illustrated embodiment, the operation mode indicator 1420 has two distinct portions, namely a first portion 1422 (in this example, an upper half of the circle) and a second portion 1424 (in this example, a lower half of the circle). In some embodiments, to visually indicate to the user which of the two states of cycle and soak is active, the first portion 1422 of the operation mode indicator 1420 is visually emphasized (e.g., by being highlighted, by pulsating or blinking, by changing colors, etc.) when a watering cycle is active and the second portion 1424 of the operation mode indicator 1420 is highlighted when a soak cycle is active.

In the exemplary embodiment shown in FIG. 44, the user interface 1400 provides the user with an interactive menu 1450 (called “Common Layers” in this example) overlaid over a portion of the map 1405. This interactive menu 1450 includes various interactive fields 1452 that enable the user to visually see certain informational and/or operation mode indicators associated with the irrigation stations represented by the station icons 1410 as a layer overlaid over the map 1405. As illustrated in FIG. 44, each interactive fields 1452 of the interactive menu 1450 includes an interactive button or icon 1454, which, when toggled to the right-most position (as shown in FIG. 44), causes an operation mode parameter indicator 1420 (in this example, the cycle and soak indicator) to be visible as being superimposed over the map 1405 and/or over a portion of the station icon 1410 with which the operation mode parameter indicator 1420 is associated. In some aspects, the operation mode indicator 1420 (i.e., the cycle and soak indicator) is automatically added within the user interface 1400 to an icon 1410 associated with an irrigation station (e.g., station 9F25) that is programmed for cycle and soak operation.

In FIG. 44, some of the interactive icons 1454 associated with operational mode and/or informational indicators of some of the interactive fields 1452 (e.g., Nozzle Color, Adjustments Badge, etc.) are disabled by being toggled to their left-most position. However, it will be appreciated that if any of the interactive icons 1454 in the interactive menu 1450 were to be toggled to their right-most position like the interactive icon 1454 associated with interactive field 1452 called “Cycle & Soak Badge” in FIG. 44, the user interface 1400 would cause additional operational mode and/or informational indicators to visually appear as an additional layer that overlays portions of the map 1405 and either overlays or is adjacent to the station icon 1410.

Those of ordinary skill in the art would appreciate that a variety of operational mode indicators other than the cycle and soak indicator depicted in FIG. 44 may be applied to a given irrigation station. For example, operation mode indicators 1420 that may be associated with a station icon 1410 of an irrigation station may include, but are not limited to an indicator that visually informs the user whether the irrigation station is actively watering or not, an indicator that visually informs the user that the irrigation station is in an error state, and indicator that visually informs the user that an operational attribute/parameter of a given irrigation station has been adjusted relative to a normal/scheduled operational attribute parameter, etc.

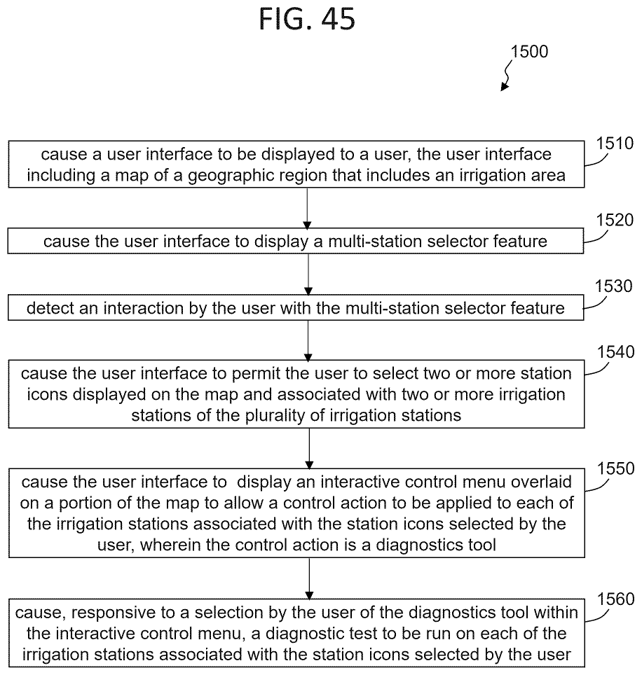

FIGS. 45-54 illustrate simplified flow diagram of exemplary methods 1500-2400 of managing irrigation in accordance with some embodiments. Each of the exemplary methods 1500-2400 described below with reference to FIGS. 45-54 includes monitoring and/or controlling irrigation of at least one irrigation area including a plurality of irrigation stations via an irrigation management application (e.g., irrigation management application 114a) configured to be executed by an electronic device (e.g., mobile device 120a) including a control circuit (e.g., control circuit 220) and a memory (e.g., memory 224) that stores the irrigation management application. In accordance with some embodiments, the exemplary methods may be accomplished by any one of, or a combination of two or more of the devices described hereinabove, for example, with references to FIGS. 1-6.

FIG. 45 illustrates a simplified flow diagram of an exemplary method 1500 of managing irrigation in accordance with some embodiments. In step 1510, the method 1500 includes causing a user interface (e.g., see reference numeral 300 in FIG. 7) to be displayed on a display to a user. The user interface includes a map of a geographic region that includes at least one irrigation area. In step 1520, the method 1500 includes causing the user interface to display a multi-station selector feature (e.g., see reference numeral 320 shown in FIG. 7). The method 1500 includes causing, responsive to an interaction by the user with the multi-station selector feature (step 1530), the user interface to: (1) permit the user to select one or more station icons (e.g., reference numeral 310 shown in FIG. 9) displayed on the map and associated with one or more irrigation stations of the plurality of irrigation stations (step 1540); and (2) display an interactive control menu (e.g., see reference numeral 322 shown in FIG. 9) overlaid on a portion of the map to allow a control action to be applied to each of the one or more irrigation stations associated with the one or more station icons selected by the user (step 1550). In the method 1500, the control action is a diagnostics tool (e.g., see reference numeral 328 in FIG. 9). In step 1560, the method 1500 further includes causing, responsive to a selection by the user of the diagnostics tool within the interactive control menu, a diagnostic test to be run on each of the one or more irrigation stations associated with the one or more station icons selected by the user.

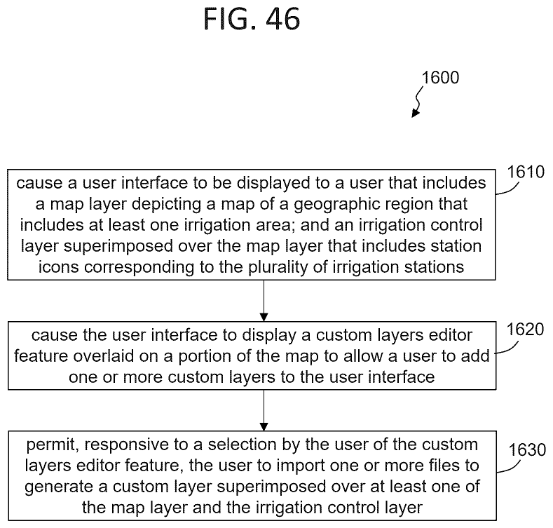

FIG. 46 illustrates a simplified flow diagram of an exemplary method 1600 of managing irrigation in accordance with some embodiments. In step 1610, the method 1600 includes causing a user interface (e.g., see reference numeral 500 in FIG. 12) to be displayed on a display to a user. According to the embodiment shown in FIG. 46, user interface includes a map layer (e.g., see reference numeral 503 in FIG. 12) depicting a map of a geographic region that includes the at least one irrigation area, as well as an irrigation control layer (e.g., see reference numeral 507 in FIG. 12) superimposed over the map layer, with the irrigation control layer including station icons corresponding to the plurality of irrigation stations. In step 1620, the user interface is caused to display a custom layers editor feature (e.g., see reference numeral 515 in FIG. 12) overlaid on a portion of the map to allow a user to add one or more custom layers to the user interface. In step 1630, responsive to a selection by the user of the custom layers editor feature, the user is permitted to import one or more files to generate a custom layer superimposed over at least one of the map layer and the irrigation control layer.

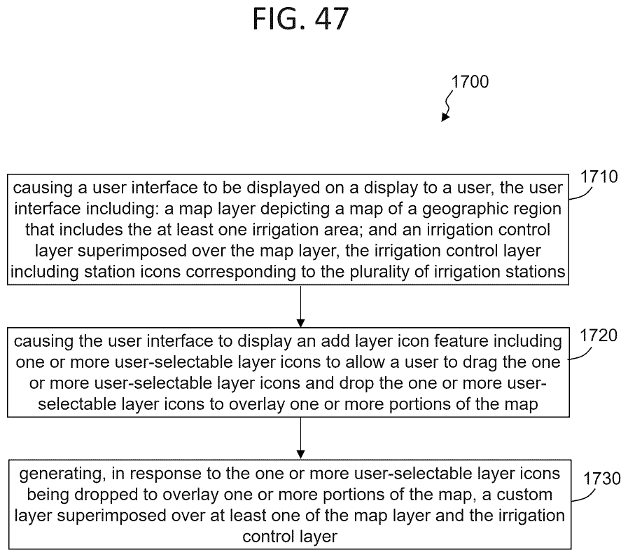

FIG. 47 illustrates a simplified flow diagram of an exemplary method 1700 of managing irrigation in accordance with some embodiments. In step 1710, the method 1700 includes causing a user interface (e.g., see reference numeral 600 in FIG. 22) to be displayed on a display to a user. According to the embodiment shown in FIG. 46, user interface includes a map layer depicting a map of a geographic region that includes the at least one irrigation area, as well as an irrigation control layer superimposed over the map layer, the irrigation control layer including station icons corresponding to the plurality of irrigation stations. In step 1720, the user interface is caused to display an add layer icon feature (e.g., see reference numeral 660 in FIG. 22) including one or more user-selectable layer icons (e.g., see reference numerals 661, 662, and 663 in FIG. 22) to allow a user to drag the one or more user-selectable layer icons and drop the one or more user-selectable layer icons to overlay one or more portions of the map. In step 1730, responsive to the one or more user-selectable layer icons being dropped to overlay one or more portions of the map, a custom layer is generated that is superimposed over at least one of the map layer and the irrigation control layer.

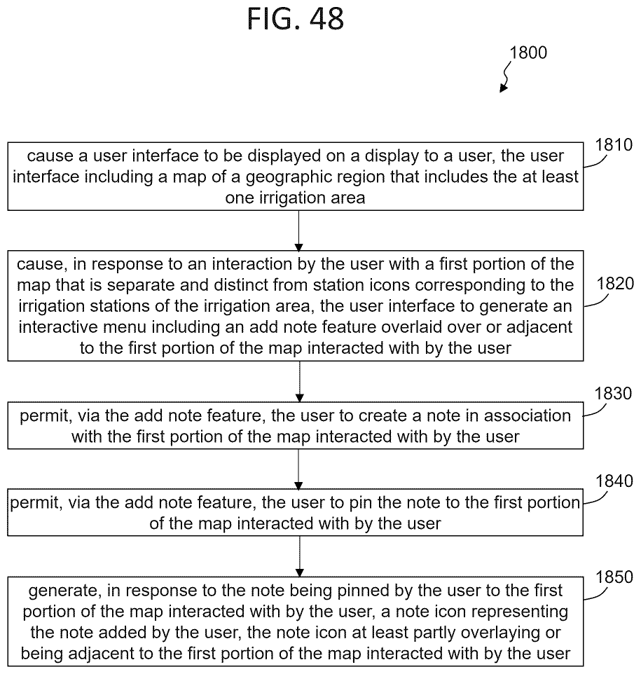

FIG. 48 illustrates a simplified flow diagram of an exemplary method 1800 of managing irrigation in accordance with some embodiments. In step 1810, the method 1800 includes causing a user interface (e.g., see reference numeral 700 in FIG. 23) to be displayed on a display to a user. In step 1820, in response to an interaction by the user with a first portion of the map that is separate and distinct from station icons corresponding to the irrigation stations of the at least one irrigation area, the user interface is caused to generate an interactive menu (e.g., see reference numeral 730 in FIG. 24) that includes an add note feature overlaid over or adjacent to the first portion of the map interacted with by the user. In step 1830, via the add note feature, the user is permitted to create a note in association with the first portion of the map interacted with by the user. In step 1840, via the add note feature, the user is permitted to pin the note to the first portion of the map interacted with by the user. In step 1850, in response to the note being pinned by the user to the first portion of the map interacted with by the user, a note icon (e.g., see reference numeral 750 in FIG. 25) representing the note added by the user is generated such that the note icon at least partly overlays or is adjacent to the first portion of the map interacted with by the user.

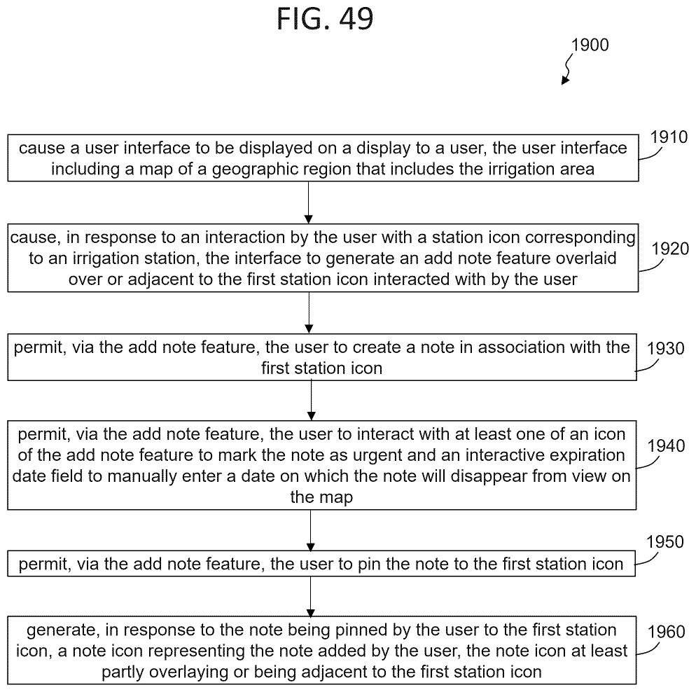

FIG. 49 illustrates a simplified flow diagram of an exemplary method 1900 of managing irrigation in accordance with some embodiments. In step 1910, the method 1900 includes causing a user interface (e.g., see reference numeral 700 in FIG. 26) to be displayed on a display to a user. In step 1920, in response to an interaction by the user with a station icon corresponding to an irrigation station of the plurality of irrigation station, the user interface to generate an add note feature (e.g., see reference numeral 722 in FIG. 26) overlaid over or adjacent to the first station icon interacted with by the user. In step 1930, the add note feature permits the user to create a note in association with the first station icon. In step 1940, the add note feature permits the user to interact with at least one of an icon of the add note feature to mark the note as urgent and an interactive expiration date field to manually enter a date on which the note will disappear from view on the map. In step 1950, the add note feature permits the user to pin the note to the first station icon. In step 1960, in response to the note being pinned by the user to the first station icon, a note icon representing the note added by the user is generated (e.g., see reference numeral 750 in FIG. 27) and at least partly overlaying or is adjacent to the first station icon.

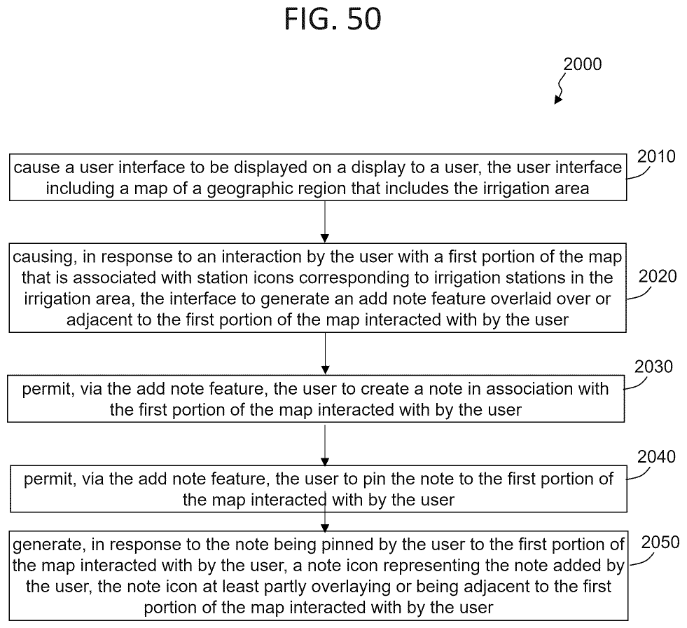

FIG. 50 illustrates a simplified flow diagram of an exemplary method 2000 of managing irrigation in accordance with some embodiments. In step 2010, the method 2000 includes causing a user interface (e.g., see reference numeral 700 in FIG. 28A) to be displayed on a display to a user. In step 2020, in response to an interaction by the user with a first portion of the map that is associated with two or more station icons corresponding to two or more irrigation stations of the plurality of irrigation stations in the at least one irrigation area, the user interface is caused to generate an add note feature (e.g., see reference numeral 722 in FIG. 28A) overlaid over or adjacent to the first portion of the map interacted with by the user. In step 2030, the add note feature permits the user to create a note in association with the first portion of the map interacted with by the user. In step 2040, the add note feature permits the user to pin the note to the first portion of the map interacted with by the user. In step 2050, in response to the note being pinned by the user to the first portion of the map interacted with by the user, a note icon representing the note added by the user is generated (e.g., see reference numeral 750 in FIG. 28B) and at least partly overlaying or being adjacent to the first portion of the map interacted with by the user.

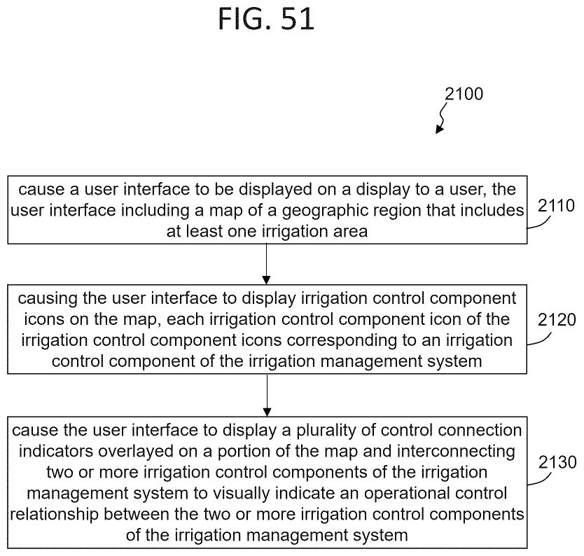

FIG. 51 illustrates a simplified flow diagram of an exemplary method 2100 of managing irrigation in accordance with some embodiments. In step 2110, the method 2100 includes causing a user interface (e.g., see reference numeral 1100 in FIG. 38) to be displayed on a display to a user, the user interface including a map of a geographic region that includes the at least one irrigation area. In step 2120, the user interface is caused to display irrigation control component icons (e.g., see reference numerals 1116, 1118, 1120, and 1122 in FIG. 38) on the map, each irrigation control component icon of the irrigation control component icons corresponding to an irrigation control component of the irrigation management system. In step 2130, the user interface is caused to display a plurality of control connection indicators (e.g., see reference numeral 1128 in FIG. 38) overlayed on a portion of the map and interconnecting two or more irrigation control components of the irrigation management system to visually indicate an operational control relationship between the two or more irrigation control components of the irrigation management system.

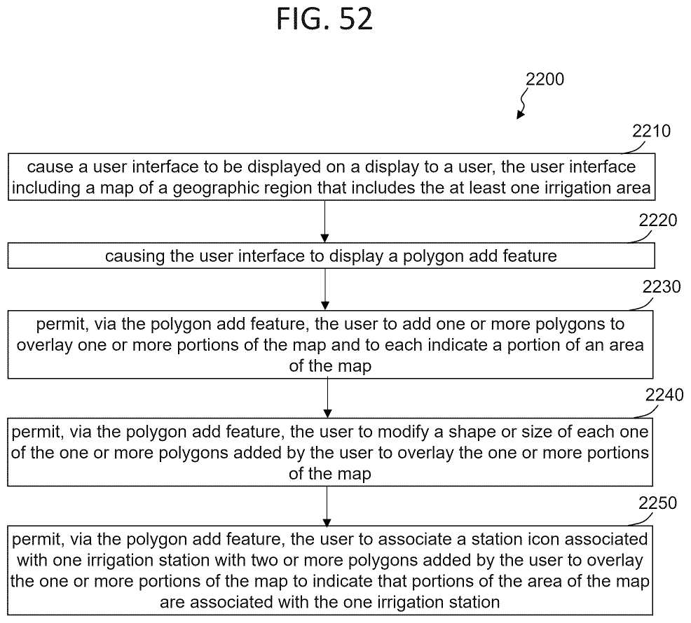

FIG. 52 illustrates a simplified flow diagram of an exemplary method 2200 of managing irrigation in accordance with some embodiments. In step 2210, the method 2200 includes causing a user interface (e.g., see reference numeral 1200 in FIG. 40B) to be displayed on a display to a user, the user interface including a map of a geographic region that includes the at least one irrigation area. In step 2220, the user interface is caused to display a polygon add feature (e.g., see reference numeral 1220 in FIG. 40B). In step 2230, the polygon add feature permits the user to add one or more polygons (e.g., reference numerals 1201, 1202, and 1203 in FIG. 41) to overlay one or more portions of the map and to each indicate a portion of an area of the map. In step 2240, the polygon add feature permits the user to modify a shape or size of each one of the one or more polygons added by the user to overlay the one or more portions of the map. In step 2250, the polygon add feature permits the user to associate a station icon (e.g., reference numeral 1210 in FIG. 41) associated with one irrigation station of the plurality of irrigation stations with two or more polygons added by the user to overlay the one or more portions of the map to indicate that portions of the area of the map are associated with the one irrigation station.

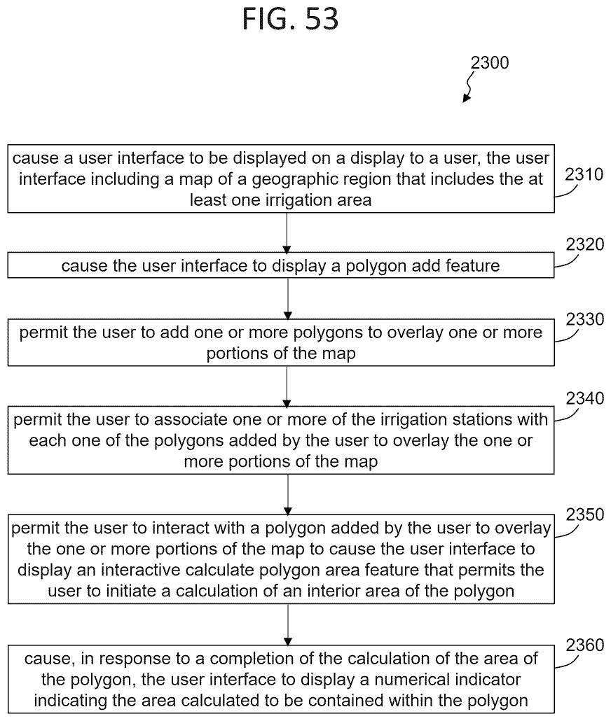

FIG. 53 illustrates a simplified flow diagram of an exemplary method 2300 of managing irrigation in accordance with some embodiments. In step 2310, the method 2300 includes causing a user interface (e.g., see reference numeral 1300 in FIG. 42) to be displayed on a display to a user, the user interface including a map of a geographic region that includes the at least one irrigation area. In step 2320, the user interface is caused to display a polygon add feature (e.g., see reference numeral 1320 in FIG. 42). In step 2330, the polygon add feature permits the user to add one or more polygons (e.g., reference numerals 1301 in FIG. 42) to overlay one or more portions of the map and to each indicate a portion of an area of the map. In step 2340, the polygon add feature permits the user to associate one or more of the plurality of irrigation stations with each one of the one or more polygons added by the user to overlay the one or more portions of the map. In step 2350, the polygon add feature permits the user to interact with a polygon of the one or more polygons added by the user to overlay the one or more portions of the map to cause the user interface to display an interactive calculate polygon area feature (e.g., reference numeral 1336 in FIG. 42) that permits the user to initiate a calculation of an interior area of the polygon. In step 2360, in response to a completion of the calculation of the interior area of the polygon, the user interface is caused to display a numerical indicator (e.g., reference numeral 1354 in FIG. 43) that visibly indicates the area calculated to be contained within the polygon.

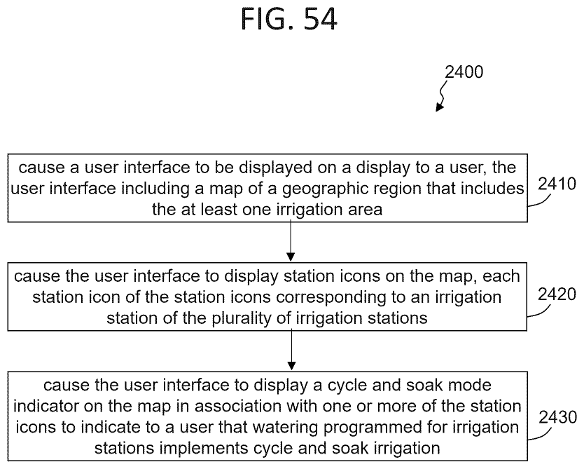

FIG. 54 illustrates a simplified flow diagram of an exemplary method 2400 of managing irrigation in accordance with some embodiments. In step 2410, the method 2400 includes causing a user interface (e.g., see reference numeral 1400 in FIG. 44) to be displayed on a display to a user, the user interface including a map of a geographic region that includes the at least one irrigation area. In step 2420 the user interface is caused to display station icons (e.g., reference numeral 1410 in FIG. 44) on the map, each station icon of the station icons corresponding to an irrigation station of the plurality of irrigation stations. In step 2430, the user interface is caused to display a cycle and soak mode indicator (e.g., reference numeral 1420) on the map in association with one or more of the station icons to visually indicate to a user that watering programmed for irrigation stations corresponding to the one or more of the station icons implements cycle and soak irrigation.

It is understood that embodiments of the systems/methods of managing an irrigation system, as well as embodiments of the irrigation management application and related features described herein may be implemented (via a computer-implemented application such as a web browser, mobile application, or the like) in one or more of a central control irrigation system, a cloud based irrigation control system, a stand-alone irrigation controller, a mobile device such as a mobile computer tablet, phone, or wearable device, or the like. It is understood that the irrigation management system hardware and software components and related features described in reference to various embodiments of systems and methods herein may be implemented for managing (e.g., monitoring and/or controlling) irrigation systems installed in various environments, including but not limited to golf, landscape, agricultural, residential, etc. It is understood that in some embodiments, the irrigation management application to implement one or more features described herein may be implemented across multiple devices and components in wired and/or wireless communications with each. In some embodiments, the irrigation management application is installed on a user's computer equipment or mobile computing device and may use other functionalities native to the host computer device to display to the user a user interface that provides the user with the irrigation system managing functionality as described herein.

It is noted that many of the features described herein entail the display of information to users via various user interfaces. In some embodiments, whether certain data and features are displayed on the user interfaces and/or allow for users to enter/adjust information or data via the user interfaces, displayed/entered/adjusted data can be coupled to and part of the irrigation control system such that an irrigation management application can output various control signals that will cause or change the irrigation of portions of a landscape and/or cause or change other actions in the irrigation system. For example, entered data may result in irrigation schedules or on/off/pause/resume commands to be sent to various field devices to open and close valves of irrigation stations resulting in water emission from sprinkler devices. Similarly, data retrieved from the irrigation system is retrieved in some embodiments from irrigation field components under command and control by the irrigation management application.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application, causes a user interface to be displayed on a display to a user. The user interface includes a map of a geographic region that includes the at least one irrigation area. The addition, the irrigation management application: causes the user interface to display a multi-station selector feature; causes, responsive to an interaction by the user with the multi-station selector feature, the user interface to: permit the user to select one or more station icons displayed on the map and associated with one or more irrigation stations of the plurality of irrigation stations; and display an interactive control menu overlaid on a portion of the map to allow a control action to be applied to each of the one or more irrigation stations associated with the one or more station icons selected by the user, wherein the control action is a diagnostics tool; and causes, responsive to a selection by the user of the diagnostics tool within the interactive control menu, a diagnostic test to be run on each of the one or more irrigation stations associated with the one or more station icons selected by the user.

In some implementations, during the diagnostic test, at least one of a measured or sensed voltage data and pressure data is obtained at each of the one or more irrigation stations associated with the one or more station icons selected by the user. In some aspects, the irrigation management application, after completion of the diagnostic test, causes the user interface to display a diagnostic test window to indicate at least one of: that one or more of the one or more irrigation stations associated with the one or more station icons selected by the user passed the diagnostic test, that one or more of the one or more irrigation stations associated with the one or more station icons selected by the user did not pass the diagnostic test, and that the diagnostic test was not successful with respect to one or more of the one or more irrigation stations associated with the one or more station icons selected by the user. The diagnostic test window may overlay a portion of the map separate from the portion of the map overlaid by the interactive control menu. In some embodiments, the diagnostic test window may include one or more of: a listing of identifiers of each of the one or more irrigation stations associated with the one or more station icons selected by the user on which the diagnostic test was run; a total number of the one or more irrigation stations associated with the one or more station icons selected by the user on which the diagnostic test was run; a total number of the one or more irrigation stations associated with the one or more station icons selected by the user on which the diagnostic test was run that passed the diagnostic test; a total number of the one or more irrigation stations associated with the one or more station icons selected by the user on which the diagnostic test was run that did not pass the diagnostic test; a total number of the one or more irrigation stations associated with the one or more station icons selected by the user on which the diagnostic test was run that did not provide feedback responsive to the diagnostic test; and a date on which the diagnostic test was run.

Some embodiments provide a method of managing irrigation that includes, by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; causing the user interface to display a multi-station selector feature; causing, responsive to an interaction by the user with the multi-station selector feature, the user interface to: permit the user to select one or more station icons displayed on the map and associated with one or more irrigation stations of the plurality of irrigation stations; and display an interactive control menu overlaid on a portion of the map to allow a control action to be applied to each of the one or more irrigation stations associated with the one or more station icons selected by the user, wherein the control action is a diagnostics tool; and causing, responsive to a selection by the user of the diagnostics tool within the interactive control menu, a diagnostic test to be run on each of the one or more irrigation stations associated with the one or more station icons selected by the user.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application causes a user interface to be displayed on a display to a user. The interface includes: a map layer depicting a map of a geographic region that includes the at least one irrigation area; and an irrigation control layer superimposed over the map layer, the irrigation control layer including station icons corresponding to the plurality of irrigation stations. Further, the irrigation management application: causes the user interface to display a custom layers editor feature overlaid on a portion of the map to allow a user to add one or more custom layers to the user interface; and permits, responsive to a selection by the user of the custom layers editor feature, the user to import one or more files to generate a custom layer superimposed over at least one of the map layer and the irrigation control layer.

In some aspects, the custom layers editor feature includes a menu that lists each vector file and each image file successfully imported by the user into the user interface. In certain implementations, the custom layers editor feature includes an interactive import layer file icon that permits the user to import a user-selected layer file. In addition, the user interface, in response to an interaction by the user with the interactive import layer file icon, displays a layer import tool to permit the user to import at least one of a vector file and an image file to create one or more new layers in the user interface. In some aspects, the layer import tool includes an interactive import file field that permits the user to select a vector file or an image file to import, or to drag and drop the vector file or the image file to import. In some aspects, the layer import tool permits the user to import one or more .kmz, .shp, or other map layer format files into the user interface. In some implementations, the layer import tool includes a menu that lists each vector file and each image file selected by the user for import into the user interface. In addition, the user interface generates, responsive to a detection of an error in association with a map layer format file being imported via the layer import tool, an alert indicator within the layer import tool to provide a notification that the map layer format file is associated with the error. In certain aspects, the irrigation management application causes, responsive to an interaction by the user with the layer import tool to import a vector file or an image file into the user interface, the user interface to generate a file preview window. In addition, the file preview window displays the map layer as it would look if the vector file or the image file were imported and superimposed over the map layer. In some aspects, the irrigation management application causes, responsive to an interaction by the user with the layer import tool to import a vector file or an image file into the user interface, the user interface to generate a file attributes window that permits the user to define, change, and adjust one or more attributes of the vector file or the image file, wherein the attributes include at least one of name, label visibility, color, opacity, and size. The file attributes window may permit the user to select a coordinate system in association with the map layer. In some embodiments, the file preview window includes an attribute editor tool to permit the user to edit an image associated with the image file being imported, and the attribute editor tool includes user-selectable image edit controls with respect to the image, the user-selectable image edit controls including at least one of: a size adjust control, a rotation control, a move vertices control, an opacity control, a save control, and a close attribute editor tool control. The move vertices control may permit the user to interact with and move any one of the vertices of the image over the map layer to modify a size, a shape, or a location of the image with respect to the map layer. In certain aspects, the irrigation management application causes, responsive to a successful import of a vector file into the user interface, the user interface to superimpose one or more map layer indicators associated with the successfully imported vector file with the map layer.

Some embodiments provide a method of managing irrigation that includes, by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including: a map layer depicting a map of a geographic region that includes the at least one irrigation area; and an irrigation control layer superimposed over the map layer, the irrigation control layer including station icons corresponding to the plurality of irrigation stations; causing the user interface to display a custom layers editor feature overlaid on a portion of the map to allow a user to add one or more custom layers to the user interface; and permitting, responsive to a selection by the user of the custom layers editor feature, the user to import one or more files to generate a custom layer superimposed over at least one of the map layer and the irrigation control layer.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application causes a user interface to be displayed on a display to a user. The user interface includes: a map layer depicting a map of a geographic region that includes the at least one irrigation area; and an irrigation control layer superimposed over the map layer, the irrigation control layer including station icons corresponding to the plurality of irrigation stations. Further, the irrigation management application: causes the user interface to display an add layer icon feature including one or more user-selectable layer icons to allow a user to drag the one or more user-selectable layer icons and drop the one or more user-selectable layer icons to overlay one or more portions of the map; and generates, in response to the one or more user-selectable layer icons being dropped to overlay one or more portions of the map, a custom layer superimposed over at least one of the map layer and the irrigation control layer.

In certain embodiments, the irrigation management application causes, in response to the one or more user-selectable layer icons being dropped to overlay one or more portions of the map to generate the custom layer, the user interface to display a custom layers editor feature overlaid on a portion of the map to allow a user to add one or more custom layers to the user interface. The custom layers editor feature may include a menu with a listing that lists one or more custom layers associated with the one or more user-selectable layer icons dropped by the user to overlay one or more portions of the map. The menu of the custom layers editor feature may include an interactive icon that permits the user to toggle between making a custom layer listed in the listing of the menu of the custom layers editor visible over the map layer and not visible over the map layer. In certain aspects, the one or more user-selectable layer icons in the add layer icon feature may include at least one of a settings layer icon, a watering location layer icon, and a valve box layer icon. In some aspects, the user interface includes a tree view menu listing of expandable categories, at least one of the categories including the irrigation stations in the at least one irrigation area. The user-selectable layer icons may be listed within the tree view menu and may be configured to be dragged by the user from the tree view menu onto the map layer.

Some embodiments provide a method of managing irrigation that includes, by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including: a map layer depicting a map of a geographic region that includes the at least one irrigation area; and an irrigation control layer superimposed over the map layer, the irrigation control layer including station icons corresponding to the plurality of irrigation stations; causing the user interface to display an add layer icon feature including one or more user-selectable layer icons to allow a user to drag the one or more user-selectable layer icons and drop the one or more user-selectable layer icons to overlay one or more portions of the map; and generating, in response to the one or more user-selectable layer icons being dropped to overlay one or more portions of the map, a custom layer superimposed over at least one of the map layer and the irrigation control layer.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application: causes a user interface to be displayed on a display to a user, the user interface including a map of a geographic region that includes the at least one irrigation area; and causes, in response to an interaction by the user with a first portion of the map that is separate and distinct from station icons corresponding to the irrigation stations of the at least one irrigation area, the user interface to generate an interactive menu including an add note feature overlaid over or adjacent to the first portion of the map interacted with by the user. The add note feature permits the user to create a note in association with the first portion of the map interacted with by the user, and permits the user to pin the note to the first portion of the map interacted with by the user. In addition, the irrigation management application generates, in response to the note being pinned by the user to the first portion of the map interacted with by the user, a note icon representing the note added by the user, the note icon at least partly overlaying or being adjacent to the first portion of the map interacted with by the user.

In some aspects, the irrigation management application causes, in response to the note being pinned by the user to the first portion of the map, the user interface to display the note as an animated image that overlays the first portion of the map and that changes appearance by appearing as at least one of: in motion, pulsing, changing sizes, and changing colors. In certain implementations, the user interface includes a menu including a plurality of informational fields, and each informational field of the plurality of informational fields is associated with an interactive icon that permits the user to toggle between making information associated with the informational field visible or not visible as a layer overlaying the map, wherein one of the informational fields is a display notes field and another of the informational fields is an animate notes field. The irrigation management application may cause, in response to the interactive icon associated with the display notes field being toggled to making the layer including the notes visible, the user interface to display, as an overlay over the first portion of the map, the note icon associated with the note pinned by the user to the first portion of the map. In addition, the irrigation management application may cause, in response to the interactive icon associated with the animate notes field being toggled to making the notes animated, the user interface to animate the note icon displayed as an overlay over the first portion of the map and associated with the note pinned by the user to the first portion of the map. In some aspects, the add note feature includes at least one of: a free-form text entry field that permits the user to manually enter text for the note, wherein the free-form text entry field permits the user to add a mention to specifically tag or reference another user; an interactive expiration date field that permits the user to manually enter a date on which the note will disappear from view over the first portion of the map; an interactive save icon that permits the user to save the note and an interactive cancel icon that permits the user to cancel addition of the note to the first portion of the map; an interactive icon that permits the user to mark the note as urgent; and an interactive field that indicates whether an issue raised by the note has been resolved and that permits the user to indicate, by adding a mark to the interactive field, that the issue has been resolved by the user.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application: causes a user interface to be displayed on a display to a user, the user interface including a map of a geographic region that includes the at least one irrigation area; and causes, in response to an interaction by the user with a first station icon corresponding to an irrigation station of the plurality of irrigation station, the user interface to generate an add note feature overlaid over or adjacent to the first station icon interacted with by the user. The add note feature permits the user to create a note in association with the first station icon; includes at least one of an interactive icon that permits the user to mark the note as urgent and an interactive expiration date field that permits the user to manually enter a date on which the note will disappear from view on the map, and permits the user to pin the note to the first station icon. Further, the irrigation management application generates, in response to the note being pinned by the user to the first station icon, a note icon representing the note added by the user, the note icon at least partly overlaying or being adjacent to the first station icon.

In some aspects, the irrigation management application causes, in response to an interaction with the note icon representing the note added by the user, the user interface to display an informational field that includes at least one of: the note and text included in the note; an interactive icon that permits the user or another user to generate a free-form text entry field that permits the user or another user to edit or update the note, wherein the free-form text entry field permits the user or another user to add a mention that tags or references a name of a specific user in the note; a badge icon indicating an identity of the user who added the note; an interactive icon that permits the user or another user to delete the note; an interactive icon that permits the user or another user to save an update to the note; an interactive icon that permits the user or another user to cancel the update to the note; and an interactive field that indicates whether an issue raised in the note is resolved or not, wherein the interactive field permits the user or another user to add a symbol into the interactive field when the issue raised in the note is resolved. In certain implementations, the informational field further includes an interactive note sorting menu that permits the user to at least one of: view all notes; view only the notes that include the mention of the user; sort the notes by date; sort the notes by priority; sort the notes by read or unread; and show all notes that indicate the issue raised in the note has been resolved.

Some embodiments provide a method of managing irrigation that includes: by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; causing, in response to an interaction by the user with a first station icon corresponding to an irrigation station of the plurality of irrigation stations, the user interface to generate an add note feature overlaid over or adjacent to the first station icon interacted with by the user; permitting, via the add note feature, the user to: create a note in association with the first station icon; interact with at least one of an icon of the add note feature to mark the note as urgent and an interactive expiration date field to manually enter a date on which the note will disappear from view on the map; and pin the note to the first station icon; and generating, in response to the note being pinned by the user to the first station icon, a note icon representing the note added by the user, the note icon at least partly overlaying or being adjacent to the first station icon.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application causes a user interface to be displayed on a display to a user, the user interface including a map of a geographic region that includes the at least one irrigation area; and causes, in response to an interaction by the user with a first portion of the map that is associated with two or more station icons corresponding to two or more irrigation stations of the plurality of irrigation stations in the at least one irrigation area, the user interface to generate an add note feature overlaid over or adjacent to the first portion of the map interacted with by the user. The add note feature permits the user to create a note in association with the first portion of the map interacted with by the user, and permits the user to pin the note to the first portion of the map interacted with by the user. Further, the irrigation management application generates, in response to the note being pinned by the user to the first portion of the map interacted with by the user, a note icon representing the note added by the user, the note icon at least partly overlaying or being adjacent to the first portion of the map interacted with by the user.

In some aspects, the irrigation management application causes, in response to an interaction with the note icon representing the note added by the user, the user interface to display an informational field that includes at least one of: the note and text included in the note; an interactive icon that permits the user or another user to generate a free-form text entry field that permits the user or another user to edit or update the note, wherein the free-form text entry field permits the user or another user to add a mention that tags or references a name of a specific user in the note; a badge icon indicating an identity of the user who added the note; an interactive icon that permits the user or another user to delete the note; an interactive icon that permits the user or another user to save an update to the note; an interactive icon that permits the user or another user to cancel the update to the note; an icon that indicates that the note is marked by the user as urgent; and an interactive field that indicates whether an issue raised in the note is resolved or not, wherein the interactive field permits the user or another user to add a symbol into the interactive field when the issue raised in the note is resolved. In some embodiments, the informational field further includes an interactive note sorting menu that permits the user to at least one of: view all notes; view only the notes that include the mention of the user; sort the notes by date; sort the notes by priority; sort the notes by read or unread; and show all notes that indicate the issue raised in the note has been resolved.

Some embodiments provide a method of managing irrigation that includes: by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; causing, in response to an interaction by the user with a first portion of the map that is associated with two or more station icons corresponding to two or more irrigation stations of the plurality of irrigation stations in the at least one irrigation area, the user interface to generate an add note feature overlaid over or adjacent to the first portion of the map interacted with by the user; permitting, via the add note feature, the user to: create a note in association with the first portion of the map interacted with by the user; and pin the note to the first portion of the map interacted with by the user; and generating, in response to the note being pinned by the user to the first portion of the map interacted with by the user, a note icon representing the note added by the user, the note icon at least partly overlaying or being adjacent to the first portion of the map interacted with by the user.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application: causes a user interface to be displayed on a display to a user, the user interface including a map of a geographic region that includes the at least one irrigation area; causes the user interface to display irrigation control component icons on the map, each irrigation control component icon of the irrigation control component icons corresponding to an irrigation control component of the irrigation management system; and causes the user interface to display a plurality of control connection indicators overlayed on a portion of the map and interconnecting two or more irrigation control components of the irrigation management system to visually indicate an operational control relationship between the two or more irrigation control components of the irrigation management system.

In some aspects, the control connection indicators are lines. In some embodiments, one of the two or more irrigation control components interconnected by a control connection indicator is a server and another of the two or more irrigation control components interconnected by the control connection indicator is a client operatively coupled to the server. In certain aspects, the user interface includes a menu including a plurality of informational fields, each informational field of the plurality of informational fields is associated with an interactive icon that permits the user to toggle between making information associated with the informational field visible or not visible as a layer overlaying the map, and the plurality of informational fields include at least one of: controllers, show server/client status, show server/client relationship, sensors, show sensor name, show sticky notes, stations, show station name, show station adjustments, show C/S icon, show shapes, irrigation, show runtime, alerts, and allow items to move.

Some embodiments provide a method of managing irrigation that includes: by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; causing the user interface to display irrigation control component icons on the map, each irrigation control component icon of the irrigation control component icons corresponding to an irrigation control component; and causing the user interface to display a plurality of control connection indicators overlayed on a portion of the map and interconnecting two or more irrigation control components to visually indicate an operational control relationship between the two or more irrigation control components.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application: causes a user interface to be displayed on a display to a user, the user interface including a map of a geographic region that includes the at least one irrigation area; and causes the user interface to display a polygon add feature to allow a user to: add one or more polygons to overlay one or more portions of the map and to each indicate a portion of an area of the map; modify a shape or size of each one of the one or more polygons added by the user to overlay the one or more portions of the map; and associate a station icon associated with one irrigation station of the plurality of irrigation stations with two or more polygons added by the user to overlay the one or more portions of the map to indicate that portions of the area of the map are associated with the one irrigation station.

In some aspects, the irrigation management application causes, responsive to a selection by the user of an irrigation station of the irrigation stations on the map, the user interface to visibly highlight an interior area of each of the polygons associated with the irrigation station selected by the user to visually indicate an association between the irrigation station selected by the user with one or more of the polygons having the interior area thereof highlighted. In certain embodiments, a visible highlight of the interior area of each of the polygons associated with the irrigation station selected by the user is a color fill; and the user interface permits the user to select or edit the fill color of the interior area of each of the polygons associated with the irrigation station selected by the user. In certain implementations, the user interface causes, in response to an interaction by the user with a polygon added by the user to overlay the one or more portions of the map, the user interface to generate a polygon edit control menu including a plurality of polygon edit control selections that permit the user to edit the polygon interacted with by the user. In some embodiments, the user interface displays, in response to an interaction by the user with the polygon edit control selection, a plurality of points defining a perimeter of the polygon interacted with by the user; the user interface permits the user to modify an overall size or shape of the polygon interacted with by the user by interacting with, and moving one or more of the plurality of points in one or more directions; and the shape of the polygon interacted with by the user has one of a square shape, a rectangle shape, a circle shape, an oval shape, a triangle shape, and a trapezoid shape. In some aspects, the user interface generates, in response to an interaction movement by the user of the one or more of the plurality of points in the one or more directions, new points defining the perimeter of the polygon interacted with by the user between existing ones of the points defining the perimeter of the polygon interacted with by the user.

Some embodiments provide a method of managing irrigation that includes: by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; and causing the user interface to display a polygon add feature to allow a user to: add one or more polygons to overlay one or more portions of the map and to each indicate a portion of an area of the map; modify a shape or size of each one of the one or more polygons added by the user to overlay the one or more portions of the map; and associate a station icon associated with one irrigation station of the plurality of irrigation stations with two or more polygons added by the user to overlay the one or more portions of the map to indicate that portions of the area of the map are associated with the one irrigation station.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application causes a user interface to be displayed on a display to a user, the user interface including a map of a geographic region that includes the at least one irrigation area and causes the user interface to display a polygon add feature to allow a user to: add one or more polygons to overlay one or more portions of the map; associate one or more of the plurality of irrigation stations with each one of the one or more polygons added by the user to overlay the one or more portions of the map; and interact with a polygon of the one or more polygons added by the user to overlay the one or more portions of the map to cause the user interface to display an interactive calculate polygon area feature that permits the user to initiate a calculation of an interior area of the polygon. The irrigation management application, in response to a completion of the calculation of the interior area of the polygon, also causes the user interface to display a numerical indicator that visibly indicates the area calculated to be contained within the polygon.

In some aspects, the numerical indicator overlays a portion of the interior area of the polygon or overlays a portion of the map adjacent to the polygon. In some aspects, the numerical indicator overlays a portion of the interior area of the polygon or overlays a portion of the map adjacent to the polygon for a predetermined time after which the numerical indicator disappears from view on the map until the polygon is interacted with by the user.

Some embodiments provide a method of managing irrigation that includes: by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; causing the user interface to display a polygon add feature to allow a user to: add one or more polygons to overlay one or more portions of the map; associate one or more of the plurality of irrigation stations with each one of the one or more polygons added by the user to overlay the one or more portions of the map; and interact with a polygon of the one or more polygons added by the user to overlay the one or more portions of the map to cause the user interface to display an interactive calculate polygon area feature that permits the user to initiate a calculation of an interior area of the polygon; and causing, in response to a completion of the calculation of the interior area of the polygon, the user interface to display a numerical indicator that visibly indicates the area calculated to be contained within the polygon.

Some embodiments provide an irrigation management system that includes an irrigation management application for use in monitoring and/or controlling irrigation of at least one irrigation area including a plurality of irrigation stations. The irrigation management application is configured to be executed by an electronic device including a control circuit, and a memory. The irrigation management application is stored in the memory, and, when executed by the control circuit, the irrigation management application: causes a user interface to be displayed on a display to a user, the user interface including a map of a geographic region that includes the at least one irrigation area; causes the user interface to display station icons on the map, each station icon of the station icons corresponding to an irrigation station of the plurality of irrigation stations; and causes the user interface to display a cycle and soak mode indicator on the map in association with one or more of the station icons, wherein the cycle and soak mode indicator visually indicates to a user that watering programmed for irrigation stations corresponding to the one or more of the station icons implements cycle and soak irrigation.

In some embodiments, the cycle and soak mode indicator includes a first portion and a second portion to visually indicate a cycle and soak mode operation. In certain aspects, the cycle and soak indicator is located adjacent the station icon with which the cycle and soak indicator is associated or overlies a portion of the station icon with which the cycle and soak indicator is associated.

Some embodiments provide a method of managing irrigation that includes: by an irrigation management application stored in a memory of an electronic device and in response to being executed by a control circuit of the electronic device, wherein the irrigation management application is for use in monitoring and/or controlling irrigation of at least one irrigation area including a plurality of irrigation stations: causing a user interface to be displayed on a display to a user, the user interface including a map of a geographic region that includes the at least one irrigation area; causing the user interface to display a multi-station selector feature; causing, responsive to an interaction by the user with the multi-station selector feature, the user interface to: permit the user to select two or more station icons displayed on the map and associated with two or more irrigation stations of the plurality of irrigation stations; and display an interactive control menu overlaid on a portion of the map to allow a control action to be applied to each of the two or more irrigation stations associated with the two or more station icons selected by the user, wherein the control action is a diagnostics tool; and causing, responsive to a selection by the user of the diagnostics tool within the interactive control menu, a diagnostic test to be run on each of the two or more irrigation stations associated with the two or more station icons selected by the user.

The following patent documents are incorporated in their entirety herein by reference:
U.S. Pat. No. 10,609,878, granted Apr. 7, 2020, titled WIRELESS REMOTE IRRIGATION CONTROL (Docket No. 8473-141359-US);
U.S. Pat. No. 11,089,746, granted Aug. 17, 2021, titled WIRELESS REMOTE IRRIGATION CONTROL (Docket No. 8473-148484-US);
U.S. Pat. No. 9,258,952, granted Feb. 16, 2016, titled VOLUMETRIC BUDGET-BASED IRRIGATION CONTROL (Docket No. 8473-92397-US);
U.S. Pat. No. 8,849,461, granted Sep. 30, 2014, titled METHODS AND SYSTEMS FOR IRRIGATION CONTROL (Docket No. 8473-130720-US);
U.S. Pat. No. 9,703,275, granted Jul. 11, 2017, titled METHODS AND SYSTEMS FOR IRRIGATION AND CLIMATE CONTROL (Docket No. 8473-130721-US);
U.S. Publication No. 2021/0229124, published Jul. 29, 2021, titled IRRIGATION CONTROL BASED ON A USER ENTERED NUMBER OF WATERING PASSES (Docket No. 8473-148724-US);
U.S. Publication No. 2009/0099701, published Apr. 16, 2009, titled REMOTE ACCESS TO IRRIGATION CONTROL SYSTEMS (Docket No. 8473-86455-US);
U.S. Provisional No. 63/188,997, filed May 14, 2021, titled AUTO-DETECTION OF DEVICES ON A MULTI-WIRE IRRIGATION CONTROL SYSTEM AND AUTO-ASSIGNMENT OF RECEIVERS TO IRRIGATION ZONES, (Docket No. 8473-152222-US);
U.S. Non-Provisional Ser. No. 18/123,976, filed Mar. 20, 2023, titled IRRIGATION CONTROL SYSTEMS AND USER INTERFACES, (Docket No. 8473-156623-US);
U.S. Non-Provisional Ser. No. 18/123,979, filed Mar. 20, 2023, titled IRRIGATION CONTROL SYSTEMS AND USER INTERFACES, (Docket No. 8473-157196-US);
U.S. Non-Provisional Ser. No. 18/123,981, filed Mar. 20, 2023, titled IRRIGATION CONTROL SYSTEMS AND USER INTERFACES, (Docket No. 8473-157197-US);
U.S. Non-Provisional Ser. No. 18/123,975, filed Mar. 20, 2023, titled IRRIGATION CONTROL SYSTEMS AND USER INTERFACES, (Docket No. 8473-157198-US);
U.S. Non-Provisional Ser. No. 18/123,980, filed Mar. 20, 2023, titled IRRIGATION CONTROL SYSTEMS AND USER INTERFACES, (Docket No. 8473-157199-US); and
U.S. Non-Provisional Ser. No. 18/513,371, filed Nov. 17, 2023, titled IRRIGATION CONTROL SYSTEMS AND USER INTERFACES, (Docket No. 8473-157877-US).

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1-25. (canceled)

26. An irrigation management system comprising:
an irrigation management application for use in monitoring and/or controlling irrigation of at least one irrigation area including a plurality of irrigation stations, wherein the irrigation management application is configured to be executed by an electronic device including a control circuit, and a memory, wherein the irrigation management application is stored in the memory, and wherein when executed by the control circuit, the irrigation management application:
causes a user interface to be displayed on a display to a user, the user interface including a map of a geographic region that includes the at least one irrigation area;
causes, in response to an interaction by the user with a first portion of the map that is separate and distinct from station icons corresponding to the irrigation stations of the at least one irrigation area, the user interface to generate an interactive menu including an add note feature overlaid over or adjacent to the first portion of the map interacted with by the user, wherein the add note feature:
permits the user to create a note in association with the first portion of the map interacted with by the user; and
permits the user to pin the note to the first portion of the map interacted with by the user; and
generates, in response to the note being pinned by the user to the first portion of the map interacted with by the user, a note icon representing the note added by the user, the note icon at least partly overlaying or being adjacent to the first portion of the map interacted with by the user.

27. The irrigation management system of claim 26, wherein the irrigation management application causes, in response to the note being pinned by the user to the first portion of the map, the user interface to display the note as an animated image that overlays the first portion of the map and that changes appearance by appearing as at least one of: in motion, pulsing, changing sizes, and changing colors.

28. The irrigation management system of claim 26, wherein:
the user interface includes a menu including a plurality of informational fields; and
each informational field of the plurality of informational fields is associated with an interactive icon that permits the user to toggle between making information associated with the informational field visible or not visible as a layer overlaying the map, wherein one of the informational fields is a display notes field and another of the informational fields is an animate notes field.

29. The irrigation system of claim 28, wherein:
the irrigation management application causes, in response to the interactive icon associated with the display notes field being toggled to making the layer including the notes visible, the user interface to display, as an overlay over the first portion of the map, the note icon associated with the note pinned by the user to the first portion of the map; and
the irrigation management application causes, in response to the interactive icon associated with the animate notes field being toggled to making the notes animated, the user interface to animate the note icon displayed as an overlay over the first portion of the map and associated with the note pinned by the user to the first portion of the map.

30. The irrigation management system of claim 26, wherein the add note feature includes at least one of:
a free-form text entry field that permits the user to manually enter text for the note, wherein the free-form text entry field permits the user to add a mention to specifically tag or reference another user;
an interactive expiration date field that permits the user to manually enter a date on which the note will disappear from view over the first portion of the map;
an interactive save icon that permits the user to save the note and an interactive cancel icon that permits the user to cancel addition of the note to the first portion of the map;
an interactive icon that permits the user to mark the note as urgent; and
an interactive field that indicates whether an issue raised by the note has been resolved and that permits the user to indicate, by adding a mark to the interactive field, that the issue has been resolved by the user.

31. (canceled)

32. An irrigation management system comprising:
an irrigation management application for use in monitoring and/or controlling irrigation of at least one irrigation area including a plurality of irrigation stations, wherein the irrigation management application is configured to be executed by an electronic device including a control circuit, and a memory, wherein the irrigation management application is stored in the memory, and wherein when executed by the control circuit, the irrigation management application:
causes a user interface to be displayed on a display to a user, the user interface including a map of a geographic region that includes the at least one irrigation area;
causes, in response to an interaction by the user with a first station icon corresponding to an irrigation station of the plurality of irrigation station, the user interface to generate an add note feature overlaid over or adjacent to the first station icon interacted with by the user, wherein the add note feature:
permits the user to create a note in association with the first station icon;
includes at least one of an interactive icon that permits the user to mark the note as urgent and an interactive expiration date field that permits the user to manually enter a date on which the note will disappear from view on the map; and
permits the user to pin the note to the first station icon; and
generates, in response to the note being pinned by the user to the first station icon, a note icon representing the note added by the user, the note icon at least partly overlaying or being adjacent to the first station icon.

33. The irrigation management system of claim 32, wherein the irrigation management application causes, in response to an interaction with the note icon representing the note added by the user, the user interface to display an informational field that includes at least one of:
the note and text included in the note;
an interactive icon that permits the user or another user to generate a free-form text entry field that permits the user or another user to edit or update the note, wherein the free-form text entry field permits the user or another user to add a mention that tags or references a name of a specific user in the note;
a badge icon indicating an identity of the user who added the note;
an interactive icon that permits the user or another user to delete the note;
an interactive icon that permits the user or another user to save an update to the note;
an interactive icon that permits the user or another user to cancel the update to the note; and
an interactive field that indicates whether an issue raised in the note is resolved or not, wherein the interactive field permits the user or another user to add a symbol into the interactive field when the issue raised in the note is resolved.

34. The irrigation management system of claim 33, wherein the informational field further includes an interactive note sorting menu that permits the user to at least one of: view all notes; view only the notes that include the mention of the user; sort the notes by date; sort the notes by priority; sort the notes by read or unread; and show all notes that indicate the issue raised in the note has been resolved.

35. (canceled)

36. An irrigation management system comprising:
an irrigation management application for use in monitoring and/or controlling irrigation of at least one irrigation area including a plurality of irrigation stations, wherein the irrigation management application is configured to be executed by an electronic device including a control circuit, and a memory, wherein the irrigation management application is stored in the memory, and wherein when executed by the control circuit, the irrigation management application:
causes a user interface to be displayed on a display to a user, the user interface including a map of a geographic region that includes the at least one irrigation area;
causes, in response to an interaction by the user with a first portion of the map that is associated with two or more station icons corresponding to two or more irrigation stations of the plurality of irrigation stations in the at least one irrigation area, the user interface to generate an add note feature overlaid over or adjacent to the first portion of the map interacted with by the user, wherein the add note feature:
permits the user to create a note in association with the first portion of the map interacted with by the user; and
permits the user to pin the note to the first portion of the map interacted with by the user; and
generates, in response to the note being pinned by the user to the first portion of the map interacted with by the user, a note icon representing the note added by the user, the note icon at least partly overlaying or being adjacent to the first portion of the map interacted with by the user.

37. The irrigation management system of claim 36, wherein the irrigation management application causes, in response to an interaction with the note icon representing the note added by the user, the user interface to display an informational field that includes at least one of:
the note and text included in the note;
an interactive icon that permits the user or another user to generate a free-form text entry field that permits the user or another user to edit or update the note, wherein the free-form text entry field permits the user or another user to add a mention that tags or references a name of a specific user in the note;
a badge icon indicating an identity of the user who added the note;
an interactive icon that permits the user or another user to delete the note;
an interactive icon that permits the user or another user to save an update to the note;
an interactive icon that permits the user or another user to cancel the update to the note;
an icon that indicates that the note is marked by the user as urgent; and
an interactive field that indicates whether an issue raised in the note is resolved or not, wherein the interactive field permits the user or another user to add a symbol into the interactive field when the issue raised in the note is resolved.

38. The irrigation management system of claim 37, wherein the informational field further includes an interactive note sorting menu that permits the user to at least one of: view all notes; view only the notes that include the mention of the user; sort the notes by date; sort the notes by priority; sort the notes by read or unread; and show all notes that indicate the issue raised in the note has been resolved.

39-57. (canceled)

58. The irrigation management system of claim 26, wherein the interaction by the user with the first portion of the map is a tap on the first portion of the map that is held for a predetermined period of time or a right-mouse button click on the first portion of the map.

59. The irrigation management system of claim 26, wherein:
the interactive menu obstructs from view the first portion of the map interacted with by the user; and
the add note feature obstructs from view the first portion of the map interacted with by the user.

60. the irrigation management system of claim 26, wherein the irrigation management application generates, in response to an interaction by the user with the note icon representing the note added by the user, a text of the note added by the user in association with the first portion of the map interacted with by the user.

61. The irrigation management system of claim 32, wherein the informational field further includes a time and date in association with the note and indicating the time and date when the note was created.

62. The irrigation management system of claim 34, wherein the interactive note sorting menu further includes a listing of the notes and an icon that, when associated with a note in the listing of the notes, indicates that the note was marked by the user as urgent.

63. The irrigation management system of claim 62, wherein the listing of the notes is displayed within the user interface such that textual content of each of the notes in the listing of the notes is visible to the user when the user is scrolling through the listing of the notes.

64. The irrigation management system of claim 36, wherein the irrigation management application generates a tree view selection menu that includes an interactive field that, when interacted with by the user, causes the user interface to generate the add note feature in association with the first portion of the map.

65. The irrigation management system of claim 36, wherein the first portion of the map is associated with an interactive icon, and wherein the note icon representing the note added by the user at least partly overlays the interactive icon associated with the first portion of the map.

66. The irrigation management system of claim 36, wherein the ad note feature generated by the user interface is part of an interactive menu including a control panel that includes various control selections that permit the user to control the two or more irrigation stations corresponding to the two or more station icons on the first portion of the map.
